(19) United States
(12) Patent Application Publication
(10) Pub. No.: US 2008/0231067 A1
(43) Pub. Date: Sep. 25, 2008

(54) Retractable Tailgate Barrier and Accessory Systems

(76) Inventor: Rick A. Nagle, Phoenix, AZ (US)

Correspondence Address: Stoneman Volk Patent Group, 3770 NORTH 7TH STREET, Suite 100, PHOENIX, AZ, 85014, US

(21) Appl. No.: 12/129,601

(22) Filed: May 29, 2008

Related U.S. Application Data
(63) Continuation-in-part of application No. 11/626,338, filed on Jan. 23, 2007.
Application No. 11/626,338 is a continuation-in-part of application No. 11/361,219, filed on Feb. 23, 2006, now Pat. No. 7,182,380.
(60) Provisional application No. 60/940,562, filed on May 29, 2007.
(60) Provisional application No. 60/762,166, filed on Jan. 24, 2006.
(60) Provisional application No. 60/855,008, filed on Oct. 27, 2006.
(60) Provisional application No. 60/656,314, filed on Feb. 24, 2005.
(60) Provisional application No. 60/713,950, filed on Sep. 1, 2005.

(51) Int. Cl. B62D 33/023

(52) U.S. Cl. 296/50

(57) ABSTRACT

A tailgate barrier system designed to maintain cargo within the cargo bed of a transport vehicle when the tailgate of the vehicle's cargo bed is lowered. The barrier stores within a storage compartment in or on the tailgate of a vehicle, and extends linearly upward from the storage compartment for use. An arrangement of extendable supports, pivotally coupled to the tailgate and top rail of the barrier system, enable the preferred upward movement. The system further comprises electrical connections. Groups of accessories mountable to the tailgate barrier system are also disclosed.

### CROSS-REFERENCE TO RELATED APPLICATIONS

The present application is related to and claims priority from provisional application Ser. No. 60/940,562, filed May 29, 2007, entitled “RETRACTABLE TAILGATE BARRIER AND ACCESSORY SYSTEMS, and is a continuation-in-part of related application Ser. No. 11/626,338, filed Jan. 23, 2007, entitled “RETRACTABLE TAILGATE BARRIER AND ACCESSORY SYSTEMS”, which is related to and claims priority from prior provisional application Ser. No. 60/762,166, filed Jan. 24, 2006, entitled “TAILGATE EXTENDER & ACCESSORY SYSTEMS”, and is related to and claims priority from prior provisional application Ser. No. 60/855,008, filed Oct. 27, 2006, entitled “RETRACTABLE TAILGATE BARRIER AND ACCESSORY SYSTEMS”, and is a continuation-in-part of related application Ser. No. 11/361,219, filed Feb. 23, 2006, entitled “TAILGATE EXTENDER SYSTEMS”, now U.S. Pat. No. 7,182,380 issued Feb. 27, 2007, which is related to and claims priority from prior provisional application Ser. No. 60/656,314, filed Feb. 24, 2005, entitled “TAILGATE EXTENDER SYSTEMS”, and is related to and claims priority from prior provisional application Ser. No. 60/713,950, filed Sep. 1, 2005, entitled “TAILGATE EXTENDER SYSTEMS”, the contents of each of which are incorporated herein by this reference and are not admitted to be prior art with respect to the present invention by the mention in this cross-reference section.

### BACKGROUND

This invention relates to providing improved tailgate barrier systems. More particularly, this invention relates to providing improved tailgate barrier systems which are stored on or within the tailgate, and which rise along a plane not more than about 30 degrees to form a load-bearing bar adapted to stop rearward and side movement of cargo from within a truck bed.

Typically, persons needing to temporarily extend the length of their truck bed lower their tailgate and install a tailgate barrier to keep the cargo from sliding past the end of the tailgate. Such temporary tailgate extenders are typically attached to the existing tailgate, requiring multiple set-up steps. Further, such tailgate extenders take up truck bed space when they are not in use.

Therefore, a need exists for a tailgate barrier that does not take up truck bed space when the tailgate barrier is not in use. Further, a need exists for a tailgate barrier that is quick and easy to set up and store. In addition, a system of rear-mounted accessories supporting user activities would of great value to many truck operators.

### OBJECTS AND FEATURES OF THE INVENTION

A primary object and feature of the present invention is to solve the above-mentioned problems and meet the above-listed needs. A further primary object and feature of the present invention is to provide tailgate extender systems.

It is a further object and feature of the present invention to provide such a system that is stored within a tailgate. It is another object and feature of the present invention to provide such a system that rises substantially perpendicularly to the inside surface of a tailgate.

It is yet another object and feature of the present invention to provide such a system having multiple telescoping supports. It is a further object and feature of the present invention to provide such a system having retractable cargo netting. In addition, it is an object and feature of the present invention to provide such a system that is mountable to exterior surface of a tailgate.

It is a further object and feature of the present invention to provide such a system that comprises a range of accessories mountable to such tailgate extender system.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a truck tailgate barrier system comprising: at least one extendable barrier to assist barring movement of cargo from a truck bed having a tailgate, when the tailgate is in lowered position, the tailgate having, when in raised position and connected to the at least one truck bed, a cab-facing external surface; wherein such at least one extendable barrier comprises at least one load-bearing bar structured and arranged to provide, when extended from at least one stowed position to at least one extended position, at least one load-bearing restraint of the cargo, and at least one conveyor to convey such at least one load-bearing bar from the at least one stowed position to the at least one extended position; wherein such at least one load-bearing bar, when unextended in the at least one stowed position, lies substantially in a first plane along the cab-facing external surface of the tailgate and, when extended in the at least one extended position, lies in a second plane spaced from and substantially parallel to the first plane; wherein the motion of such at least one load-bearing bar to the at least one extended position falls substantially within a third plane no more than about 30 degrees from a fourth plane oriented substantially perpendicular to the first plane.

Moreover, it provides such a truck tailgate barrier system further comprising at least one torsion bar structured and arranged to support a portion of the weight of the tailgate during rotation between the lowered position and the raised position. Additionally, it provides such a truck tailgate barrier system further comprising a rotation-rate limiter structured and arranged to limit the rate of rotation of the tailgate during rotation between the raised position and the lowered position. Also, it provides such a truck tailgate barrier system further comprising: at least one flexible barrier to assist in barring the cargo from moving past such at least one load-bearing bar; wherein such at least one flexible barrier comprises at least one retractor to retract such at least one flexible barrier for storage. In addition, it provides such a truck tailgate barrier system wherein such at least one load-bearing bar comprises at least one U-shaped member. And, it provides such a truck tailgate barrier system further comprising at least one first storage section to store such at least one U-shaped member in the at least one stowed position; and at least one second storage section structured and arranged to provide secondary storage; wherein such at least one conveyer comprises at least one extendable support to extendably support such at least one U-shaped member between such extension from the at least one stowed position and such at least one extended position; and wherein such at least one extendable support comprises at least one first connector to pivotally connect such at least one extendable support to such at least one first storage section, and at least one second connector to pivotally connect such at least one extendable support to such at least one U-shaped member. Further, it provides such a truck tailgate barrier system wherein such at least one U-shaped member comprises: at least one extruded rear channel structured and arranged to assist barring cargo from moving in at least one rearward direction relative to the tailgate; at least one extruded side channel structured and arranged to assist barring cargo from crossing at least one side perimeter of at least one tailgate; and at least one channel coupler structured and arranged to rigidly couple such at least one extruded rear channel with such at least one extruded side channel; wherein such at least one channel coupler maintains such at least one extruded side channel at about a 90-degree orientation relative to such at least one extruded rear channel. Even further, it provides such a truck tailgate barrier system, wherein such at least one extendable support comprises: at least one support arm structured and arranged to pivotally couple to such at least one first storage section; at least one second support arm structured and arranged to pivotally couple to such at least one U-shaped member; and at least one articulated joint structured and arranged provide at least one degree of movement between such at least one first support arm and such at least one second support arm.

Moreover, it provides such a truck tailgate barrier system wherein: such at least one extendable support comprises at least one telescoping leg to telescopically adjust at least one linear distance between such at least one first connector and such at least one second connector, at least one telescopic assister to assist telescopic deployment of such at least one telescoping leg; and such at least one telescoping leg comprises at least one releasable lock structured and arranged to releasably lock such at least one telescoping bar in at least one telescopic position. Additionally, it provides such a truck tailgate barrier system wherein such at least one extendable support comprises: at least one power-assisted actuator structured and arranged to provide power-assisted movement of such at least one U-shaped member during extension from the at least one stowed position; and at least one actuator control to provide user control of such at least one power-assisted actuator; whereby user locating of such at least one U-shaped member, between the at least one stowed position and the at least one extended position, is assisted. Also, it provides such a truck tailgate barrier system, wherein such at least one actuator control comprises at least one remote wireless interface. In addition, it provides such a truck tailgate barrier system, further comprising: at least one bar-stabilization assembly structured and arranged to stabilize such at least one U-shaped member when in such at least one extended position; wherein such at least one bar-stabilization assembly comprises at least one bed-mounted anchor structured and arranged to provide at least one anchor point within the truck bed, and coupled with such at least one U-shaped member, at least one anchor engager structured and arranged to engage such at least one bed-mounted anchor; wherein such at least one anchor engager comprises at least one rail coupler structured and arranged to couple such at least one anchor engager to such at least one load-bearing bar; wherein when such at least one U-shaped member is in the at least one stowed position, such at least one anchor engager is retracted to a position substantially within such at least one extruded side channel; and wherein such at least one anchor engager is deployed from such at least one extruded side channel by movement of such at least one load-bearing bar between the at least one stowed position and the at least one extended position. And, it provides such a truck tailgate barrier system wherein such at least one U-shaped member comprises at least one bar aperture to supportively receive at least one aperture-insertable portion of at least one mountable accessory.

Further, it provides such a truck tailgate barrier system, further comprising: such at least one mountable accessory comprising such aperture-insertable portion; wherein such at least one mountable accessory comprises at least one stanchion structured and arranged to support such at least one mountable accessory in an operable position. Even further, it provides such a truck tailgate barrier system, wherein such at least one mountable accessory comprises at least one member selected from the group consisting essentially of: at least one umbrella structured and arranged to provide environmental protection, at least one foldable canopy structured and arranged to provide foldable weather protection wherein such at least one foldable canopy comprises a fabric panel having at least one peripheral fabric edge. Moreover, it provides such a truck tailgate barrier system wherein such at least one foldable canopy further comprises: at least one light permeable sleeve positioned along at least one portion of such at least one peripheral fabric edge; and at least one illuminated cable structured and arranged to provide at least one substantially continuous line of illumination; wherein such at least one light permeable sleeve is structured and arranged to internally support such at least one illuminated cable; and wherein such at least one light permeable sleeve comprises a net-like structure. Additionally, it provides such a truck tailgate barrier system wherein such at least one foldable canopy further comprises: At least one adjustable support post structured and arranged to adjustably support at least one portion of such at least one foldable canopy over a ground surface adjacent the truck bed; wherein such at least one stanchion comprises at least one length adjuster to adjust the overall length of such at least one stanchion; and wherein such at least one stanchion comprises at least three telescoping sections.

Also, it provides such a truck tailgate barrier system wherein each such at least one load-bearing bar comprises: at least one longitudinal axis; and at least one T-shaped-cross-section slot portion forming at least one continuous slot opening portion within such at least one load-bearing bar; wherein such at least one T-shaped-cross-section slot portion is oriented substantially parallel to such at least one longitudinal axis. In addition, it provides such a truck tailgate barrier system further comprising: at least one interlocking engager structured and arranged to interlockably engage such at least one T-shaped-cross-section slot portion; wherein such at least one interlocking engager comprises at least one first position of engagement within such at least one T-shaped-cross-section slot portion preventing removal of such at least one interlocking engager; wherein such at least one interlocking engager comprises at least one second position of engagement within such at least one T-shaped-cross-section slot portion allowing removal of such at least one interlocking engager. And, it provides such a system wherein: such at least one interlocking engager comprises at least one lashing anchor to provide at least one lashing anchor to assisting lashing of the cargo supported within the truck bed; each such at least one lashing anchor comprises at least one T-shaped slide structured and arranged to allow engaged sliding of such at least one lashing anchor within such at least one T-shaped-cross-section slot portion of such at least one load-bearing bar, and at least one slide-resister structured and arranged to resist sliding of such at least one lashing anchor within such at least one T-shaped-cross-section slot portion of such at least one load-bearing bar; and such at least one slide-resister operates substantially by friction.

Further, it provides such a truck tailgate barrier system wherein such at least one interlocking engager comprises at least one mountable accessory structured and arranged to be substantially supported from such at least one load-bearing bar by such at least one interlocking engager. Even further, it provides such a truck tailgate barrier system wherein such at least one mountable accessory comprises at least one member selected from the group consisting essentially of: at least one cup holder structured and arranged to hold a beverage container, at least one barbecue grilling device structured and arranged to provided open flame preparation of food, at least one table surface structured and arranged to provide surface support; at least one storage compartment, at least one document holder structured to hold one or more set of rolled documents, at least one insulated storage container structured and arranged to store one or more temperature sensitive items, and at least one water-cooler support structured and arranged to support at least one water cooler. Moreover, it provides such a truck tailgate barrier system wherein: a portion of such at least one mountable accessory is supported directly from the tailgate; and such at least one mountable accessory comprises at least one support leg structured and arranged to be supported directly from a ground surface adjacent the truck bed, and at least one pivoting coupler to pivotally couple such at least one support leg with such at least one mountable accessory; wherein such at least one support leg comprises at least one leg-length adjuster to adjust the length of such at least one support leg.

Additionally, it provides such a truck tailgate barrier system wherein when in the at least one stowed position, such at least one first storage section is structured and arranged to fully store such at least one U-shaped member and such at least one extendable support. Also, it provides such a truck tailgate barrier system wherein such at least one first storage section and such at least one second storage section are each located substantially within an inner cavity of the tailgate. In addition, it provides such a truck tailgate barrier system wherein such at least one first storage section and such at least one second storage section are each located substantially external of an inner cavity of the tailgate.

And, it provides such a truck tailgate barrier system wherein: such at least one second storage section comprises at least one deployable accessory; wherein such at least one deployable accessory is deployed from at least one stowed position within such at least one second storage section to at least one deployed position; and wherein such at least one deployable accessory comprises at least one substantially permanent connection to such at least one second storage section. Further, it provides such a truck tailgate barrier system wherein such at least one deployable accessory comprises at least one member selected from the group consisting essentially of: at least one foldable ladder structured and arranged to assist user access to the truck bed, at least one foldable ramp structured and arranged to assist user access to the truck bed, at least one extendable electrical light, and at least one video display screen. Even further, it provides such a truck tailgate barrier system wherein: such at least one second storage section comprises at least one non-deployable accessory; such non-deployable accessory comprises at least one member selected from the group consisting essentially of: at least one electrical light coupled to at electrical circuit of the truck bed, at least one electrical coupler coupled to at electrical circuit of the truck bed; at least one audio coupler coupled to at audio circuit of the truck bed; at least one video coupler coupled to at least one video circuit of the truck bed; and at least one data coupler coupled to at least one data circuit of the truck bed. Even further, it provides such a truck tailgate barrier system wherein such at least one electrical coupler comprises at least one proprietary adapter structured and arranged to adapt such at least one electrical coupler to at least one first proprietary coupler.

Even further, it provides such a truck tailgate barrier system wherein such at least one second storage section comprises at least one controller structured and arranged to remotely control the functioning of at least one of such at least one audio coupler, such at least one video coupler, and such at least one data coupler. Even further, it provides such a truck tailgate barrier system further comprising: at least one cover to substantially cover such at least one second storage section; wherein such at least one cover comprises at least one extendable cover portion to cover at least one portion of such first storage section; and wherein such at least one extendable cover portion is extendably positionable relative to such at least one cover. Even further, it provides such a truck tailgate barrier system further comprising: at least one jumper cable structured and arranged to assist the jump-starting of a vehicle; wherein such at least one jumper cable comprises such at least one first proprietary coupler structured and arranged to connect such at least one jumper cable to such at least one proprietary adapter. Even further, it provides such a truck tailgate barrier system further comprising: at least one ladder rack structured and arranged to provide elevated support of the cargo; wherein such at least one ladder rack comprises at least one first stanchion structured and arranged to engage such at least one bar aperture, and at least one second stanchion structured and arranged to be mountable to the truck bed; wherein at least one portion of such at least one ladder rack is substantially foldable adjacent at least one other portion of such at least one ladder rack for compact storage. Even further, it provides such a truck tailgate barrier system wherein such at least one second storage section comprises at least two divided compartments each enclosed by at least one hinged cover.

In accordance with another preferred embodiment hereof, this invention provides a system related to providing electrical power within a tailgate of a truck bed comprising at least one electrical circuit, such system comprising: at least one electrical coupler structured and arranged to supply electrical power from the at least one electrical circuit of the at least one truck bed. In accordance with another preferred embodiment hereof, this invention provides at least one jumper cable structured and arranged to transfer the electrical power from such at least one electrical coupler to assist jump-starting operations; wherein such at least one electrical coupler is located substantially within the tailgate wherein such at least one jumper cable comprises at least one proprietary connector structured and arranged to connect such at least one jumper cable to such at least one electrical coupler.

In accordance with another preferred embodiment hereof, this invention provides a system related to providing electrical connections within a tailgate of a truck bed, such system comprising: at least one audio coupler coupled to at least one audio circuit of the at least one truck bed; at least one video coupler coupled to at least one video circuit of the at least one truck bed; at least one data coupler coupled to at least one data circuit of the at least one truck bed; and at least one electrical coupler coupled to at least one electrical circuit of the at least one truck bed; wherein each one of such at least one audio coupler, such at least one video coupler, at least one data coupler, and such at least one electrical coupler are located substantially within the tailgate.

In accordance with a preferred embodiment hereof, this invention provides a truck tailgate barrier system comprising: at least one tailgate having, when in raised position, at least one cab-facing external surface, such at least one tailgate connected to at least one truck bed; and at least one barrier to assist barring cargo from crossing at least one rear perimeter of such at least one tailgate when such at least one tailgate is in lowered position; wherein such at least one barrier, when unextended in a stowed position, lies in a first plane along such cab-facing external surface of such at least one tailgate and, when extended in an extended position, lies in a second plane parallel to, and spaced perpendicularly from, the first plane; and at least one extender to extend such at least one barrier substantially perpendicularly from the stowed position in the first plane to the extended position in the second plane; wherein, when such at least one tailgate is in the lowered position, movement of such at least one extender provides vertical motion to such barrier between the stowed position and the extended position.

Moreover, it provides such a truck tailgate barrier system further comprising: at least one gap closer to close at least one gap between such at least one barrier in the extended position and the at least one truck bed; wherein such at least one gap closer is retractably extendable from such at least one barrier. Additionally, it provides such a truck tailgate barrier system wherein such at least one gap closer comprises: at least one rail stabilization assembly structured and arranged to stabilize such at least one barrier in such extended position; wherein such at least one rail stabilization comprises at least one anchor structured and arranged to anchor such at least one barrier to the at least one truck bed; at least one bed-mounted coupler structured and arranged to couple such at least one anchor to at least one load-bearing portion of the at least one truck bed; wherein such at least one anchor comprises at least one barrier coupler structured and arranged to couple such at least one anchor to such at least one barrier; wherein when such at least one barrier is in the at least one stowed position, such at least one anchor is retracted to a position substantially within such at least one barrier; and wherein such at least one anchor is deployed from such at least one barrier by vertical motion of such at least one barrier between the stowed position and the extended position.

Also, it provides such a truck tailgate barrier system further comprising at least one storage compartment structured and arranged to store such at least one barrier in the stowed position. In addition, it provides such a truck tailgate barrier system further comprising at least one cover structured and arranged to cover such at least one storage compartment. And, it provides such a truck tailgate barrier system further comprising at least one flexible barrier to assist barring the cargo from passing across such at least one barrier. Further, it provides such a truck tailgate barrier system wherein such at least one flexible barrier is structured and arranged to be stored within such at least one barrier. Even further, it provides such a truck tailgate barrier system wherein such at least one flexible barrier is structured and arranged to be stored within such at least one storage compartment.

Moreover, it provides such a truck tailgate barrier system wherein such at least one barrier comprises: at least one rail to substantially horizontally rail the at least one rear perimeter of such at least one tailgate when such at least one tailgate is connected to the at least one truck bed and lowered; and at least one extendable support to extendably vertically support such at least one rail; at least one first connector to connect such at least one extendable support to such at least one tailgate; and at least one second connector to connect such at least one extendable support to such at least one rail; wherein such at least one first connector comprises at least one hinge. Additionally, it provides such a truck tailgate barrier system wherein such at least one extendable support comprises at least one telescoping bar.

In accordance with another preferred embodiment hereof, this invention provides a truck tailgate barrier system related to retention of cargo within at least one truck bed having at least one tailgate, the at least one tailgate having at least one cab-facing external surface, such system comprising: at least one substantially rigid barrier structured and arranged to assist in rigidly barring cargo from crossing at least one perimeter of such at least one tailgate when such at least one tailgate is connected to the at least one truck bed and lowered; and at least one flexible restraint structured and arranged to assist in restraining cargo from crossing the at least one perimeter of such at least one tailgate when such at least one tailgate is connected to the at least one truck bed and lowered; wherein such at least one substantially rigid barrier comprises at least one retainer structured and arranged to removably retain such at least one flexible restraint in an operable position assisting the restraint of the cargo; and wherein such at least one flexible restraint comprises at least one retractor structured and arranged to retract such at least one flexible restraint to at least one retracted position.

In accordance with another preferred embodiment hereof, this invention provides a truck tailgate barrier system enabling a method for barring cargo from crossing at least one rear perimeter of at least one tailgate when such at least one tailgate is in lowered position, the at least one tailgate having, when in raised position, at least one cab-facing external surface, the at least one tailgate connected to at least one truck bed, such method comprising the steps of: lowering the at least one tailgate; and extending at least one substantially rigid cargo barrier from a stowed position, the stowed position lying substantially within a first plane located along the cab-facing external surface of such at least one tailgate, to an extended position, lying substantially in a second plane parallel to, and spaced perpendicularly from, the first plane. Also, it provides such a truck tailgate barrier system further comprising the step of installing at least one substantially flexible secondary cargo barrier to such at least one substantially rigid cargo barrier. In addition, it provides such a truck tailgate barrier system further comprising the step of removably mounting at least one mountable accessory to such at least one substantially rigid cargo barrier. And, it provides such a truck tailgate barrier system further comprising the step of lowering such at least one substantially rigid cargo barrier from the second plane of the extended position to the first plane of the stowed position.

In accordance with another preferred embodiment hereof, this invention provides a truck tailgate barrier system comprising: at least one barrier to assist barring cargo from crossing at least one rear perimeter of at least one tailgate when the at least one tailgate is in lowered position, the at least one tailgate having, when in raised position and connected to at least one truck bed, at least one cab-facing external surface; wherein such at least one barrier, when unextended in at least one stowed position, lies in a first plane along the at least one cab-facing external surface of the at least one tailgate and, when extended in an extended position, lies in a second plane parallel to, and spaced perpendicularly from, the first plane; and at least one conveyor to convey such at least one barrier substantially perpendicularly from the at least one stowed position in the first plane to the extended position in the second plane; and wherein, when such at least tailgate is in the at least one lowered position, movement of such at least one conveyor provides vertical motion to such at least one barrier between the stowed position and the extended position.

Further, it provides such a truck tailgate barrier system further comprising: at least one first storage section to store such barrier in the stowed position; and at least one second storage section structured and arranged to provide secondary storage. Even further, it provides such a truck tailgate barrier system further comprising: at least one cover to substantially cover such at least one second storage section; wherein such at least one cover comprises at least one extendable cover portion to cover at least one portion of such at least one first storage section; and wherein such at least one extendable cover portion is extendably positionable relative to such at least one cover. Moreover, it provides such a truck tailgate barrier system further comprising: at least one flexible barrier to assist in barring cargo from moving past such at least one barrier; wherein such at least one flexible barrier comprises at least one retractor to retract such at least one flexible barrier for storage; and wherein such at least one flexible barrier is storable within such at least one first storage section.

Additionally, it provides such a truck tailgate barrier system wherein: such at least one barrier comprises at least one boundary rail to bound the at least one rear perimeter of the at least one tailgate; such at least one boundary rail comprises at least one substantially linear interior channel; such at least one conveyer comprises at least one extendable support to extendably support such at least one boundary rail; such at least one extendable support comprises at least one first connector to pivotally connect such at least one extendable support to such at least one first storage section; and such at least one extendable support further comprises at least one second connector to pivotally connect such at least one extendable support to such at least one boundary rail. Also, it provides such a system wherein: such at least one boundary rail comprises at least one extruded channel member comprising a longitudinal axis; and such least one extruded channel comprise a substantially uniform cross section along such longitudinal axis.

In addition, it provides such a truck tailgate barrier system wherein such at least one boundary rail comprises at least one U-shaped member. And, it provides such a truck tailgate barrier system wherein such at least one U-shaped member comprises: at least one rear extruded channel structured and arranged to assist barring cargo from crossing the at least one rear perimeter of at least one tailgate; at least one side extruded channel structured and arranged to assist barring cargo from crossing the at least one side perimeter of at least one tailgate; and at least one channel coupler structured and arranged to rigidly couple such at least one rear extruded channel with such at least one side extruded channel; wherein such at least one channel coupler maintains such at least one side extruded channel at about a 90-degree orientation relative to such at least one rear extruded channel. Further, it provides such a truck tailgate barrier system wherein: such at least one first connector comprises at least one rotator to rotate such at least one extendable support about such at least one first connector; such at least one rotator comprises at least one torque generator to generate at least one torque force; such at least one rotator is structured and arranged to apply the at least one torque force to such at least one extendable support; and application of the at least one torque force biases such at least one extendable support toward at least one rotation about such at least one first connector.

Even further, it provides such a truck tailgate barrier system wherein: such at least one second connector comprises at least one internal slider to slide within such at least one substantially linear interior channel of such at least one boundary rail; and such at least one internal slider is captured within such at least one substantially linear interior channel during such sliding. Moreover, it provides such a truck tailgate barrier system wherein: such at least one slider comprises at least one friction reducer structured and arranged to assist in reducing friction between such at least one substantially linear interior channel; such at least one friction reducer comprises at least one spring-biased wheel structured and arranged to roll in contact with such at least one substantially linear interior channel; such at least one spring-biased wheel comprises at least one positional fixer structured and arranged to fix the position of such at least one internal slider relative to such at least one boundary rail; such at least one positional fixer comprises within such at least one substantially linear interior channel, at least one receiver structured and arranged to receive and retain such at least one spring-biased wheel, and at least one release structured and arranged to release such at least one spring biased wheel from such retention by such at least one receiver; and such at least one positional fixer is user releasable. Additionally, it provides such a truck tailgate barrier system wherein such at least one extendable support comprises at least one telescoping bar to telescopically adjust a linear distance between such at least one first connector and such at least one second connector.

Also, it provides such a truck tailgate barrier system, wherein such at least one telescoping bar comprises at least one releasable lock structured and arranged to releasably lock such at least one telescoping bar in at least one telescopic position. In addition, it provides such a truck tailgate barrier system wherein: such at least one extendable support further comprises at least one telescopic assister to assist telescopic deployment of such at least one telescoping bar. And, it provides such a truck tailgate barrier system wherein: such at least one telescopic assister comprises at least one gas-charged spring; and such at least one gas-charged spring is disposed substantially within such at least one telescoping bar. Further, it provides such a truck tailgate barrier system wherein: such at least one telescopic assister comprises at least one power-assisted actuator; and such at least one power-assisted actuator comprises at least one actuator control structured and arranged to provide user control of such at least one power-assisted actuator to assist user locating of such at least one boundary rail between the at least one stowed position and the extended position.

Even further, it provides such a truck tailgate barrier system wherein such at least one actuator control comprises at least one remote wireless interface. Moreover, it provides such a truck tailgate barrier system further comprising: at least one cargo management bar structured and arranged to assist in maintaining the extended position of such at least one barrier; wherein such at least one cargo management bar comprises at least one first bar coupler to couple such at least one cargo management bar to at least one first such at least one extendable support, at least one second bar coupler to couple such at least one cargo management bar to at least one second such at least one extendable support, and at least one link to link such at least one first bar coupler and such at least one second bar coupler; wherein such at least one link assists in maintaining the relative positions of such at least one first such at least one extendable support and such at least one second such at least one extendable support; and wherein such at least one link is structured and arranged to assist in maintaining a position of the cargo within the at least one truck bed.

Additionally, it provides such a truck tailgate barrier system further comprising: at least one gap closer to close at least one gap between such at least one boundary rail and the at least one truck bed; wherein such at least one gap closer is retractably extendable from such at least one boundary rail. Also, it provides such a truck tailgate barrier system wherein such at least one gap closer comprises: at least one rail stabilization assembly structured and arranged to stabilize such at least one boundary rail when in such extended position; wherein such at least one rail stabilization comprises at least one anchor structured and arranged to anchor such at least one boundary rail to the at least one truck bed; at least one bed-mounted coupler structured and arranged to couple such at least one anchor to at least one load-bearing portion of the at least one truck bed; wherein such at least one anchor comprises at least one rail coupler structured and arranged to couple such at least one anchor to such at least one boundary rail wherein when such at least one boundary rail is in the at least one stowed position, such at least one anchor is retracted to a position substantially within such at least one boundary rail; and wherein such at least one anchor is deployed from such at least one boundary rail by vertical translation of such at least one boundary rail between the stowed position and the extended position.

In addition, it provides such a truck tailgate barrier system wherein: such at least one anchor comprises at least one substantially linear bar; such at least one substantially linear bar is structured and arranged to slide within such at least one substantially linear interior channel of such at least one boundary rail; such at least one substantially linear bar comprises at least one hook; and such at least one bed-mounted coupler comprises at least one capture notch structured and arranged to releasably capture such at least one hook, and at least one guide structured and arranged to guide such at least one hook to such at least one capture notch.

And, it provides such a truck tailgate barrier system wherein: such at least one bed-mounted coupler comprises at least one post structured and arrange to couple to the at least one load-bearing portion of the at least one truck bed; such at least one guide comprises at least one ramp-shaped member, and at least one socket structured and arranged to engage such at least one post; and at least one structural connection is formed by engagement of such at least one socket with such at least one post while such at least one post is coupled to the at least one load-bearing portion of the at least one truck bed.

Further, it provides such a truck tailgate barrier system wherein such at least one first storage section and such at least one second storage section are each located substantially within at least one inner cavity of the at least one tailgate. Even further, it provides such a truck tailgate barrier system wherein such at least one first storage section and such at least one second storage section are each located substantially external of at least one inner cavity of the at least one tailgate. Moreover, it provides such a truck tailgate barrier system further comprising at least one torsion bar structured and arranged to support at least one portion of the weight of the at least one tailgate during rotation between the lowered position and the raised position. Additionally, it provides such a truck tailgate barrier system further comprising at least one rotation-rate limiter structured and arranged to limit the rate of rotation of the at least one tailgate during rotation between the raised position and the lowered position. Truck tailgate barrier system, wherein such at least one extendable support comprises at least one scissor assembly structured and arranged to assist translation of such at least one barrier between such at least one stowed position and at least one deployed position.

Also, it provides such a truck tailgate barrier system, wherein such at least one extendable support comprises: at least one first support arm structured and arranged to pivotally couple to such at least one first storage section; at least one second support arm structured and arranged to pivotally couple to such at least one boundary rail; and at least one articulated joint structured and arranged provide at least one degree of movement between such at least one first support arm and such at least one second support arm. In addition, it provides such a truck tailgate barrier system, wherein such at least one first connector comprises: at least one hinge structured and arranged to assist rotational movement of such at least one extendable support about such at least one first connector; wherein such at least one hinge comprises at least two pivot points, and at least one spring structured and arranged to urge such rotational movement. And, it provides such a truck tailgate barrier system wherein: such at least one boundary rail comprises at least one illuminator to provide visually discernable illumination; and such at least one illuminator is operatively coupled to at least one electrical circuit of the at least one truck bed. Further, it provides such a truck tailgate barrier system, wherein such at least one boundary rail comprises at least one aperture to supportively receive at least one aperture-insertable portion of at least one mountable accessory.

Even further, it provides such a truck tailgate barrier system wherein: such at least one mountable accessory comprises at least one umbrella structured and arranged to provide environmental protection; and such at least one aperture-insertable portion of such at least one at least one umbrella comprises at least one stanchion structured and arranged to support such at least one umbrella in at least one operable position. Moreover, it provides such a truck tailgate barrier system wherein: such at least one mountable accessory comprises at least one foldable canopy structured and arranged to provide foldable weather protection; such at least one foldable canopy comprises at least one fabric panel having at least one peripheral fabric edge; and such at least one aperture insertable portion of such at least one foldable canopy comprises at least one stanchion structured and arranged to support such at least one umbrella in at least one operable position. Additionally, it provides such a truck tailgate barrier system wherein such at least one foldable canopy further comprises: at least one light permeable sleeve positioned along at least one portion of such at least one peripheral edge; and at least one illuminated cable structured and arranged to provide at least one substantially continuous line of illumination; wherein such at least one light permeable sleeve is structured and arranged to internally support such at least one illuminated cable.

Also, it provides such a truck tailgate barrier system wherein such at least one light permeable sleeve comprises at least one fabric having at least one net-like weave. In addition, it provides such a truck tailgate barrier system wherein such at least one foldable canopy further comprises: at least one integral antenna apparatus structured and arranged to receive and transmit electromagnetic waves; and at least one electric coupler structured and arranged to couple such at least one antenna apparatus to at least one antenna-using device. And, it provides such a truck tailgate barrier system wherein such at least one foldable canopy further comprises: at least one adjustable support post structured and arranged to adjustably support at least one portion of such at least one foldable canopy over at least one ground surface adjacent the at least one truck bed; wherein such at least one stanchion comprises at least one length adjuster to adjust the overall length of such at least one stanchion; and wherein such at least one stanchion comprises at least three telescoping sections. Further, it provides such a truck tailgate barrier system wherein such at least one barrier rail comprises: at least one longitudinal axis; and at least one T-shaped-cross-section slot portion forming at least one continuous slot opening portion within such at least one barrier rail; wherein such at least one T-shaped-cross-section slot portion is oriented substantially parallel to such at least one longitudinal axis.

Even further, it provides such a system further comprising: at least one interlocking engager structured and arranged to interlockably engage such at least one T-shaped-cross-section slot portion; wherein such at least one engager comprises at least one first position within such T-shaped-cross-section slot portion preventing removal of such at least one engager; wherein such at least one slideable engager comprises at least one second position within such T-shaped-cross-section slot portion allowing removal of such at least one engager. Moreover, it provides such a system wherein: such at least one interlocking engager comprises at least one lashing anchor to provide at least one lashing anchor point; such at least one lashing anchor comprises at least one T-shaped slide structured and arranged to allow engaged sliding of such at least at least one lashing anchor within such at least one T-shaped-cross-section slot portion of such at least one barrier rail, and at least one slide-resister structured and arranged to resist sliding of such at least one lashing anchor within such at least one T-shaped-cross-section slot portion of such at least one barrier rail; and such at least one slide-resister operates substantially by friction.

Additionally, it provides such a truck tailgate barrier system wherein such at least one interlocking engager comprises at least one mountable accessory structured and arranged to be substantially supported from such at least one boundary rail by such at least one engager. Also, it provides such a truck tailgate barrier system wherein such at least one mountable accessory comprises at least one cup holder structured and arranged to hold at least one beverage container. In addition, it provides such a truck tailgate barrier system wherein such at least one mountable accessory comprises at least one barbecue grilling device structured and arranged to provided open flame preparation of food. And, it provides such a truck tailgate barrier system wherein at least one portion of such at least one barbecue grilling device is supported directly from the at least one tailgate. Further, it provides such a truck tailgate barrier system wherein such at least one mountable accessory comprises at least one table surface structured and arranged to provide surface support. Even further, it provides such a truck tailgate barrier system wherein such at least one table surface comprises at least one support leg structured and arranged to be supported directly from the at least one tailgate.

Moreover, it provides such a truck tailgate barrier system wherein such at least one table surface comprises: at least one support leg structured and arranged to be supported directly from at least one ground surface adjacent the at least one truck bed; and at least one pivoting coupler to pivotally couple such at least one support leg with such at least one table surface; wherein such at least one support leg comprises at least one leg-length adjuster to adjust the length of such at least one support leg. Additionally, it provides such a truck tailgate barrier system wherein such at least one table surface further comprises at least one storage compartment. Also, it provides such a truck tailgate barrier system wherein such at least one mountable accessory comprises: at least one document holder structured to hold at least one set of rolled documents; wherein such at least one document holder comprises at least one hollow cylindrical member comprising at least one open upper end and at least one substantially closed lower end. In addition, it provides such a truck tailgate barrier system wherein: such at least one mountable accessory comprises at least one insulated storage container structured and arranged to store at least one temperature sensitive item; and such at least one insulated storage container comprises at least one support leg structured and arranged to be supported directly from the at least one tailgate. And, it provides such a truck tailgate barrier system wherein: such at least one insulated storage container comprises at least one electrical cooler structured and arranged to cool the at least one temperature sensitive item; and such at least one electrical cooler comprises at least one electrical connector operatively connectable to at least one electrical circuit of the at least one truck bed.

Further, it provides such a truck tailgate barrier system wherein: such at least one mountable accessory comprises at least one water-cooler support structured and arranged to support at least one water cooler; and such at least one water-cooler support comprises at least one support leg structured and arranged to be supported directly from the at least one tailgate. Even further, it provides such a truck tailgate barrier system wherein such at least one second storage section comprises at least one electrical light coupled to at least one electrical circuit of the at least one truck bed. Moreover, it provides such a truck tailgate barrier system wherein: such at least one second storage section comprises at least one foldable ladder structured and arranged to assist user access to the at least one truck bed; and such at least one foldable ladder is stowable substantially within such at least one second storage section. Additionally, it provides such a truck tailgate barrier system wherein: such at least one second storage section comprises at least one foldable ramp structured and arranged to assist user access to the at least one truck bed; and such at least one foldable ramp is stowable substantially within such at least one second storage section. Also, it provides such a truck tailgate barrier system wherein such at least one foldable ramp comprises: at least one first foldable-ramp assembly comprising a plurality of foldable-ramp segments; at least one second foldable-ramp assembly comprising a plurality of foldable-ramp segments; and at least one distance adjuster to provide user-controllable adjustment of the distance between such at least one first foldable-ramp assembly and at least one second foldable-ramp assembly. In addition, it provides such a truck tailgate barrier system wherein such at least one distance adjuster comprises: within such at least one second storage section, at least one linear guide structured and arranged to guide such at least one first foldable-ramp assembly and at least one second foldable-ramp assembly along at least one linear path; wherein such at least one first foldable-ramp assembly and at least one second foldable-ramp assembly each comprise at least one pivotal coupler structured and arranged to pivotally couple such at least one first foldable-ramp assembly and at least one second foldable-ramp assembly to such at least one linear guide.

And, it provides such a truck tailgate barrier system wherein: such at least one first foldable-ramp assembly and at least one second foldable-ramp assembly each comprise: a plurality of ramp segments; wherein each ramp segment of such plurality is coupled by at least one articulating pivot joint. Further, it provides such a truck tailgate barrier system further comprising: at least one extendable coupler structured and arranged to couple at least one first ramp segment with at least one second ramp segment; wherein coupling of such at least one first ramp segment with such at least one second ramp segment fixes the position of such at least one first ramp segment relative to such at least one second ramp segment. Even further, it provides such a truck tailgate barrier system wherein: such at least one second storage section comprises at least one extendable electrical light structured and arranged to extend from such at least one second storage section; and such at least one extendable electrical light is coupled to at least one electrical circuit of the at least one truck bed. Moreover, it provides such a truck tailgate barrier system wherein such at least one second storage section comprises at least one electrical coupler coupled to at least one electrical circuit of the at least one truck bed. Additionally, it provides such a truck tailgate barrier system wherein such at least one electrical coupler comprises at least one proprietary adapter structured and arranged to couple at least one first proprietary coupler to at least one second proprietary coupler.

Also, it provides such a truck tailgate barrier system wherein such at least one second storage section comprises at least one audio coupler coupled to at least one audio circuit of the at least one truck bed. In addition, it provides such a truck tailgate barrier system wherein such at least one second storage section comprises at least one video coupler coupled to at least one video circuit of the at least one truck bed. And, it provides such a truck tailgate barrier system wherein such at least one second storage section comprises at least one data coupler coupled to at least one data circuit of the at least one truck bed. Further, it provides such a truck tailgate barrier system wherein such at least one second storage section comprises in combination: at least one audio coupler coupled to at least one audio circuit of the at least one truck bed; at least one video coupler coupled to at least one video circuit of the at least one truck bed; and at least one data coupler coupled to at least one data circuit of the at least one truck bed. Even further, it provides such a truck tailgate barrier system wherein such at least one second storage section comprises at least one controller structured and arranged to remotely control at least one of such at least one audio coupler, such at least one video coupler, and such at least one data coupler. Even further, it provides such a truck tailgate barrier system further comprising: at least one jumper cable structured and arranged to assist in transferring power from at least one vehicle to at least one other vehicle; wherein such at least one jumper cable comprises at least one proprietary connector structured and arranged to connect to such at least one jumper cable to such at least one electrical coupler. Even further, it provides such a truck tailgate barrier system further comprising: at least one ladder rack structured and arranged to the elevated support of cargo; wherein such at least one ladder rack comprises at least one first stanchion structured and arranged to pass within such at least one aperture to engage such at least one socket, and at least one second stanchion structured and arranged to be mountable to the at least one truck bed; wherein at least one portion of such at least one ladder rack is substantially foldable adjacent at least one other portion of such at least one ladder rack for compact storage. Even further, it provides such a truck tailgate barrier system wherein such at least one second storage section comprises at least two divided compartments each enclosed by at least one hinged cover.

In accordance with another preferred embodiment hereof, this invention provides a system related to providing electrical power within at least one tailgate, structured and arranged to be hingedly connected to at least one truck bed, having at least one inner cavity, such system comprising: at least one electrical coupler coupled to at least one electrical circuit of the at least one truck bed.

In accordance with another preferred embodiment hereof, this invention provides at least one jumper cable structured and arranged to assist in transferring power from at least one vehicle to at least one other vehicle; wherein such at least one electrical coupler is located substantially within the at least one inner cavity wherein such at least one jumper cable comprises at least one proprietary connector structured and arranged to connect to such at least one jumper cable to such at least one electrical coupler.

In accordance with another preferred embodiment hereof, this invention provides a system related to providing electrical connections within at least one tailgate, structured and arranged to be hingedly connected to at least one truck bed, having at least one inner cavity, such system comprising: at least one audio coupler coupled to at least one audio circuit of the at least one truck bed; at least one video coupler coupled to at least one video circuit of the at least one truck bed; and at least one data coupler coupled to at least one data circuit of the at least one truck bed.

In accordance with another preferred embodiment hereof, this invention provides at least one electrical coupler coupled to at least one electrical circuit of the at least one truck bed; wherein each one of such at least one audio coupler, such at least one video coupler, at least one data coupler, and such at least one electrical coupler are located substantially within the at least one inner cavity.

In accordance with another preferred embodiment hereof, this invention provides a system related to providing adjustable mounting points within the bed area of an truck-type automotive vehicle comprising, in combination: at least one barrier rail structured and arranged to assist barring cargo from crossing at least one rear perimeter of at least one tailgate of the bed area when the at least one tailgate is in lowered position, such at least one barrier rail comprising at least one longitudinal axis; at least one T-shaped-cross-section slot portion forming at least one continuous slot-opening portion within such at least one barrier rail; at least one interlocking engager structured and arranged to interlockably engage such at least one T-shaped-cross-section slot portion; wherein such at least one engager comprises at least one first position within such T-shaped-cross-section slot portion preventing removal; wherein such at least one slideable engager comprises at least one second position within such T-shaped-cross-section slot portion allowing removal; and wherein such at least one T-shaped-cross-section slot portion is oriented substantially parallel to such at least one longitudinal axis. Even further, it provides such a system wherein: such at least one engager comprises at least one lashing anchor to provide at least one lashing anchor point; such at least one lashing anchor comprises at least one T-shaped slide structured and arranged to allow engaged sliding of such at least at least one lashing anchor within such at least one T-shaped-cross-section slot portion of such at least one barrier rail, and at least one slide-resister structured and arranged to resist sliding of such at least one lashing anchor within such at least one T-shaped-cross-section slot portion of such at least one barrier rail; wherein such at least one slide-resister operates substantially by friction.

In accordance with another preferred embodiment hereof, this invention provides a system related to preventing theft of at least one tailgate, the at least one tailgate pivotally mounted to at least one truck bed, such system comprising: at least one link assembly structured and arranged to link the at least one tailgate to the at least one truck bed; wherein such at least one link assembly comprises at least one link member comprising at least one first link end and at least one second link end, at least one link coupler to removably couple such at least one first link end to the at least one tailgate, at least one blocker structured and arranged to block the removal of such at least one link member from the at least one truck bed when such at least one link member is coupled to the at least one tailgate; wherein such at least one link coupler comprises at least one user operable lock to removably lock such at least one link coupler to such at least one first link end. And it provides each and every novel feature, element, combination, step and/or method disclosed or suggested by this provisional patent application.

### BRIEF DESCRIPTION OF THE DRAWINGS

FIG. 1A shows a side view illustrating a tailgate barrier system according to a preferred embodiment of the present invention.

FIG. 1B shows an exploded perspective view illustrating the tailgate barrier system, according to the preferred embodiment of FIG. 1A.

FIG. 1C shows a side view, in partial section, illustrating the tailgate barrier system mounted within a truck according to a preferred embodiment of the present invention.

FIG. 1D shows a side view of the tailgate barrier, illustrating a preferred translational motion of a barrier bar moving between a stowed and a deployed (extended) configuration, according to the preferred embodiment of FIG. 1A.

FIG. 2 shows a top view of the tailgate barrier, according to the preferred embodiment of FIG. 1A, in a deployed position.

FIG. 3 shows a front view of the tailgate barrier, according to the preferred embodiment of FIG. 1A, in a deployed position.

FIG. 4 shows a side view of the tailgate barrier, according to the preferred embodiment of FIG. 1A, in a deployed position.

FIG. 5 shows a side view of the tailgate barrier, illustrating an alternate preferred translational motion of a barrier bar moving between a stowed and a deployed configuration, according to the preferred embodiment of FIG. 1A.

FIG. 6 shows a top view of the barrier rail, isolated from the overall barrier assembly, according to the preferred embodiment of FIG. 1A.

FIG. 7 shows the sectional view 7-7 of FIG. 6 illustrating a preferred cross-sectional profile of the barrier rail.

FIG. 8 shows an exploded perspective view illustrating a rail coupler according to the preferred embodiment of FIG. 1A.

FIG. 9 shows a partial front view of a rear extendable support of the tailgate barrier, according to the preferred embodiment of FIG. 1A, in an extended position.

FIG. 10 shows a partial front view of the rear extendable support, according to the preferred embodiment of FIG. 1A, in a partially extended position.

FIG. 11 shows a partial front view of the rear extendable support, according to the preferred embodiment of FIG. 1A, in a stowed position.

FIG. 12 shows a cross-sectional view, through the section 12-12 of FIG. 11, illustrating the stored tailgate barrier, with a cargo net retractor in a first storage section, according to a preferred embodiment of the present invention.

FIG. 13 shows a cut-away perspective view illustrating the main operable components of the tailgate barrier in a stowed position.

FIG. 14 shows the detailed cut-away view 14 of FIG. 9.

FIG. 15 shows the detailed cut-away view 15 of FIG. 9.

FIG. 16 shows a perspective view illustrating a side extendable support, isolated from the tailgate barrier, according to the preferred embodiment of FIG. 1A.

FIG. 17 shows a side cut-away view of the side extendable support of the tailgate barrier, according to the preferred embodiment of FIG. 1A, in an extended position.

FIG. 18 shows a side cut-away view of the side extendable support, according to the preferred embodiment of FIG. 1A, in a partially extended position.

FIG. 19 shows a side cut-away view of the side extendable support, according to the preferred embodiment of FIG. 1A, in a stowed position.

FIG. 20 shows a perspective view of the detailed view 20 of FIG. 1B, illustrating a rail stabilization assembly according to the preferred embodiment of FIG. 1A.

FIG. 21 shows an exploded illustrating the rail stabilization assembly of FIG. 20.

FIG. 22 shows a side view of the rail stabilization assembly, positioned to receive a rail anchor of the tailgate barrier, according to a preferred embodiment of the present invention.

FIG. 23 shows a side view of the rail stabilization assembly, interlocked with the rail anchor of FIG. 22.

FIG. 24 shows an exploded perspective view of the rail stabilization assembly of FIG. 20.

FIG. 25 shows an exploded side view of the rail stabilization assembly of FIG. 20.

FIG. 26 shows an exploded perspective view of the rail stabilization assembly of FIG. 20.

FIG. 27 shows a perspective view of a ramp-shaped member of the rail stabilization assembly of FIG. 20.

FIG. 28 shows a front view of the ramp-shaped member of the rail stabilization assembly of FIG. 20.

FIG. 29 shows a front view of the rail stabilization assembly of FIG. 20.

FIG. 30 shows a first side view of the rail stabilization assembly of FIG. 20.

FIG. 31 shows a rear view of the rail stabilization assembly of FIG. 20.

FIG. 32 shows a second side view of the rail stabilization assembly of FIG. 20.

FIG. 33 shows an exploded perspective view of a storage housing assembly of the tailgate barrier of FIG. 1A.

FIG. 34 shows an exploded perspective view further illustrating the storage housing assembly of the tailgate barrier of FIG. 1A.

FIG. 35 shows a top view of the storage housing assembly of FIG. 34.

FIG. 36 shows a plan view illustrating layouts of individual sheet panels used to form components of the storage housing assembly.

FIG. 37 shows a plan view of a sheet layout used to assemble a preferred embodiment of a second storage section of the tailgate barrier system of FIG. 1A.

FIG. 38 shows a plan view of a sheet layout used to assemble a preferred embodiment of a latch box of the second storage section of the tailgate barrier system of FIG. 1A.

FIG. 39 shows a plan view of a sheet layout used to assemble a preferred embodiment of a power box of the second storage section of the tailgate barrier system of FIG. 1A.

FIG. 40 shows a plan view of a sheet layout used to assemble a preferred embodiment of a port-side first storage section of the tailgate barrier system of FIG. 1A.

FIG. 41 shows a plan view of a sheet layout used to assemble a preferred embodiment of a starboard-side first storage section of the tailgate barrier system of FIG. 1A.

FIG. 42 shows a perspective view of a net-retractor support bracket of the first storage sections, of the tailgate barrier system of FIG. 1A.

FIG. 43 shows a plan view of a sheet layout used to assemble a preferred embodiment of the first net-retractor support bracket according to a preferred embodiment of the present invention.

FIG. 44 shows a plan view of a sheet layout used to assemble a preferred embodiment of a second net-retractor support bracket according to a preferred embodiment of the present invention.

FIG. 45 shows a perspective view of a base connector bracket used to pivotally connect a conveyor assembly of the tailgate barrier to the first storage section, according to the preferred embodiment of FIG. 1A.

FIG. 46 through FIG. 48 show plan views of sheet layouts used to assemble preferred embodiments of the base connector brackets of preferred embodiments of the present invention.

FIG. 49 shows a rear view of a flexible barrier assembly according to the preferred embodiment of FIG. 1A.

FIG. 50 shows a plan view of the flexible barrier of FIG. 49.

FIG. 51 shows a sectional view through the section 51-51 of FIG. 49.

FIG. 52 shows a perspective view, in partial section, of the barrier bar with preferred mountable accessories.

FIG. 53 shows a sectional view through the section 53-53 of FIG. 52.

FIG. 54 shows a front view of a cargo anchor of the tailgate barrier system.

FIG. 55 shows a side view of the cargo anchor of FIG. 54.

FIG. 56 shows a sectional view through the section 56-56 of FIG. 52.

FIG. 57 shows a perspective view illustrating a folding ramp assembly according to a preferred embodiment of the present invention.

FIG. 58 shows a perspective view of the folding ramp of the folding ramp assembly of FIG. 57.

FIG. 59 shows a side view illustrating an articulating pivot joint of the folding ramp.

FIG. 60 shows a sectional view through the first storage section, illustrating a preferred deployed arrangement of the folding ramp assembly of FIG. 57.

FIG. 61 shows a perspective view of the articulating pivot joint.

FIG. 62 shows a partial exploded perspective view illustrating preferred components of the folding ramp assembly of FIG. 57.

FIG. 63 shows a top view of a joint section of the articulating pivot joint.

FIG. 64 shows a side view of a joint section of the articulating pivot joint.

FIG. 65 shows an end view of a joint section of the articulating pivot joint.

FIG. 66 shows a side view of the folding ramp assembly in a deployed configuration.

FIG. 67 shows a plan view of a ramp segment of the folding ramp assembly.

FIG. 68 shows a bottom view of a ramp segment of the folding ramp assembly comprising an extendable coupler used to couple a first ramp segment to an adjacent second ramp segment.

FIG. 69 shows a plan view of a telescoping ramp according to another preferred embodiment of the present invention.

FIG. 70 shows a perspective view of a foldaway ladder system of the tailgate barrier system according to preferred embodiments of the present invention.

FIG. 71 shows a perspective view of the foldaway ladder system of FIG. 5670 in a partial deployed configuration.

FIG. 72 shows a perspective view of the foldaway ladder system of FIG. 56 in full deployment.

FIG. 73 shows a perspective view of an accessory group of the tailgate barrier system according to preferred embodiments of the present invention.

FIG. 74A shows a sectional view through the barrier bar illustrating a preferred first interlocking engager according to a preferred mounting embodiment of the present invention.

FIG. 74B shows a sectional view through the barrier bar illustrating the first interlocking engager lifted to a removable position.

FIG. 75A shows a sectional view through the barrier bar illustrating a preferred second interlocking engager according to another preferred mounting embodiment of the present invention. FIG. 75B shows a sectional view through the barrier bar illustrating the second interlocking engager rotated to a removable orientation.

FIG. 76 shows a perspective view illustrating a preferred mountable accessory utilizing the interlocking engager of FIG. 74.

FIG. 77 shows a perspective view of individual accessories of the accessory group attached to a deployed tailgate barrier according to a preferred embodiment of the present invention.

FIG. 78 shows a side view of an example accessory of the accessory group, comprising a water cooler holder, mounted to a deployed tailgate barrier according to a preferred embodiment of the present invention.

FIG. 79 shows a side view of the water cooler holder of FIG. 78.

FIG. 80 shows a perspective view of the umbrella of FIG. 76 adjacent the deployed tailgate barrier according to a preferred embodiment of the present invention.

FIG. 81 shows a side view of a shade canopy mounted to a truck comprising a deployed tailgate barrier according to a preferred embodiment of the present invention.

FIG. 82 shows a top view of the shade canopy of FIG. 81.

FIG. 83 shows a perspective view of an alternate shade canopy mounted to a truck comprising a deployed tailgate barrier according to a preferred embodiment of the present invention.

FIG. 84 shows a top view of the alternate shade canopy of FIG. 83.

FIG. 85 shows a side view in partial section of an adjustable support strut of the alternate shade canopy of FIG. 83.

FIG. 86 shows a side view of a collapsible ladder rack mounted to a truck comprising a deployed tailgate barrier according to a preferred embodiment of the present invention.

FIG. 87 shows a perspective view of the collapsible ladder rack of FIG. 86.

FIG. 88 shows a perspective view of a multi-compartment storage box of the tailgate barrier system according to preferred embodiments of the present invention.

FIG. 89 shows a perspective view of the multi-compartment storage box of FIG. 88.

FIG. 90 shows a perspective view of an accessory connector panel located within the multi-compartment storage box according to preferred embodiments of the present invention.

FIG. 91 shows a diagram illustrating a range of accessories connectable with the accessory connector panel of FIG. 90.

FIG. 92 shows a front view of a video screen mounted to the interior face of the cover according to a preferred embodiment of the present invention.

FIG. 93 shows a front view of the power box of the second storage section of the tailgate barrier system of FIG. 1A.

FIG. 94 shows a front detail view of the accessory connector panel of FIG. 90.

FIG. 95 shows a front view of a multi-connector jumper-cable device according to a preferred embodiment of the present invention.

FIG. 96 and FIG. 97 show side views in partial section illustrating a tailgate security system according to a preferred embodiment of the present invention.

FIG. 98 shows a perspective view of a contractor's table, mountable to the tailgate barrier system, according to a preferred embodiment of the present invention.

FIG. 99 shows a sectional view through the section 99-99 of FIG. 98.

FIG. 100A shows a side view in partial section illustrating a preferred surface-mounted embodiment of the tailgate barrier system.

FIG. 100B shows a front view of an accessory cross bar, according to the preferred embodiment of FIG. 49. FIG. 100C shows the sectional view 100C-100C of FIG. 100B.

FIG. 101A shows a perspective view illustrating a tailgate barrier system according to another preferred embodiment of the present invention.

FIG. 101B shows a perspective view illustrating a tailgate barrier system, according to the preferred embodiment of FIG. 101A, with hidden areas illustrated.

FIG. 102 shows a top view of the tailgate extender, according to the preferred embodiment of FIG. 101A, in a stowed position.

FIG. 103 shows a front view of the tailgate extender, according to the preferred embodiment of FIG. 101A, in a stowed position.

FIG. 104 shows a front view of the tailgate extender, according to the preferred embodiment of FIG. 101A, in a partially extended position.

FIG. 105 shows a front view of the tailgate extender, according to the preferred embodiment of FIG. 101A, in a fully extended position.

FIG. 106 shows the sectional view 106-106 of FIG. 2.

FIG. 107 shows the sectional view 107-107 of FIG. 2.

FIG. 108 shows the sectional view 108-108 of FIG. 2.

FIG. 109 shows a front view of the tailgate extender, according to the preferred embodiment of FIG. 101A, in a fully extended position, with cargo netting.

FIG. 110 shows the sectional view 110-110 of FIG. 109.

FIG. 111 shows a cross-sectional view of a stored tailgate extender, with a cargo net retractor in the top rail, according to a preferred embodiment of the present invention.

FIG. 112 shows a cross-sectional view of a stored tailgate extender, with a cargo net retractor in the storage compartment, according to a preferred embodiment of the present invention.

FIG. 113 shows a cross-sectional view of a stored tailgate extender, similar to FIG. 107, with a retractable storage compartment cover, according to a preferred embodiment of the present invention.

FIG. 114 shows a cross-sectional view of a stored tailgate extender with an integral storage compartment cover, according to a preferred embodiment of the present invention.

FIG. 115 shows a cross-sectional view of a stored tailgate extender, with a small rail, with a hinged storage compartment cover, according to a preferred embodiment of the present invention.

FIG. 116 shows a top view of a tailgate extender, according to a preferred embodiment of the present invention, in a stowed position.

FIG. 117 shows a front view of the tailgate extender, according to the preferred embodiment of FIG. 116, in a fully extended position.

FIG. 118 shows a side view illustrating a tailgate extender of the tailgate barrier system according to another preferred embodiment of the present invention.

FIG. 119 shows a front view of the tailgate extender, according to the preferred embodiment of FIG. 118, in a partially extended position.

FIG. 120 shows a top view of the tailgate extender, according to the preferred embodiment of FIG. 118.

FIG. 121 shows the sectional view 121-121 of FIG. 120 illustrating the tailgate extender in a partially extended (deployed) position.

FIG. 122 shows the sectional view 122-122 of FIG. 120 illustrating the tailgate extender in a stowed position.

FIG. 123 shows the detailed sectional view 123 of FIG. 121.

FIG. 124 shows the detailed sectional view 124 of FIG. 123.

FIG. 125 shows the detailed sectional view 125 of FIG. 123.

FIG. 126 shows an exploded detail of operable components of the tailgate extender.

FIG. 127 shows the sectional view 127-127 of FIG. 120, illustrating the tailgate extender in a partially extended position.

FIG. 128 shows the sectional view 127-127 of FIG. 120 illustrating the tailgate extender in a stowed position.

FIG. 129 shows an enlarged sectional view of the sectional view 127-127 of FIG. 120 illustrating the tailgate extender in a stowed position.

FIG. 130 shows the sectional view 130-130 of FIG. 120 illustrating the tailgate extender in a stowed position.

FIG. 131A shows a front view of an accessory cross bar, according to the preferred embodiment of FIG. 119.

FIG. 131B shows the sectional view 131B-131B of FIG. 131A.

FIG. 132 shows a front sectional view illustrating a tailgate extender of the tailgate barrier system according to another preferred embodiment of the present invention.

FIG. 133 shows a front view illustrating a tailgate extender of the tailgate barrier system according to an alternate preferred embodiment of the present invention.

FIG. 134 shows a top view of the tailgate extender, according to the preferred embodiment of FIG. 133.

FIG. 135 shows the sectional view 135-135 of FIG. 134 illustrating the tailgate extender in a raised (deployed) position.

FIG. 136 shows the sectional view 135-135 of FIG. 134 illustrating the tailgate extender in a lowered (stowed) position.

FIG. 137 shows the detailed sectional view 137 of FIG. 135.

FIG. 138 shows the detailed sectional view 138 of FIG. 137.

FIG. 139 shows the detailed sectional view 139 of FIG. 136.

FIG. 140 shows the sectional view 140-140 of FIG. 134, illustrating the tailgate extender in an extended position.

FIG. 141 shows the sectional view 141-141 of FIG. 134, illustrating the tailgate extender in a stowed position.

FIG. 142 shows an enlarged view of the sectional view 142-142 of FIG. 141, illustrating the tailgate extender in a stowed position.

FIG. 143 shows an enlarged view of the sectional view 143-143 of FIG. 141, illustrating the tailgate extender in a stowed position.

FIG. 144 shows a partial sectional view illustrating a tailgate extender of the tailgate barrier system according to another preferred embodiment of the present invention.

FIG. 145 shows a partial sectional view illustrating a tailgate extender of the tailgate barrier system according to another preferred embodiment of the present invention.

FIG. 146 shows a partial sectional view illustrating a tailgate extender of the tailgate barrier system according to another preferred embodiment of the present invention.

FIG. 147 shows a partial perspective view illustrating illumination components of the tailgate barrier system according to another preferred embodiment of the present invention.

FIG. 148 shows an enlarged view of the sectional view 148-148 of FIG. 147.

FIG. 149 shows a partial front view of a rear extendable support of an alternate tailgate barrier according to the preferred embodiment of FIG. 1C, in an extended position.

FIG. 150 shows a sectional view through the section 150-150 of FIG. 149 illustrating the alternate tailgate barrier according to the preferred embodiment of FIG. 1C.

### DETAILED DESCRIPTION OF THE BEST MODES AND PREFERRED EMBODIMENTS OF THE INVENTION

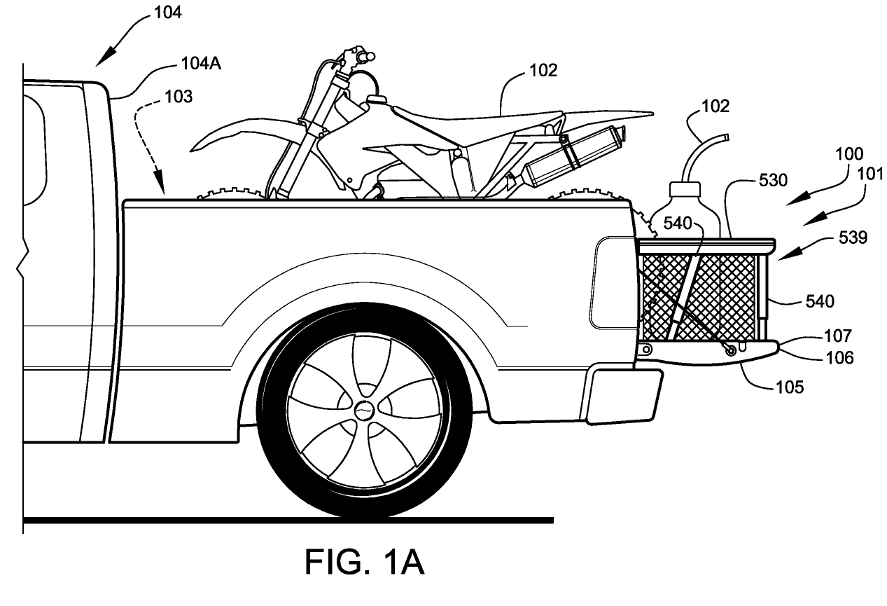

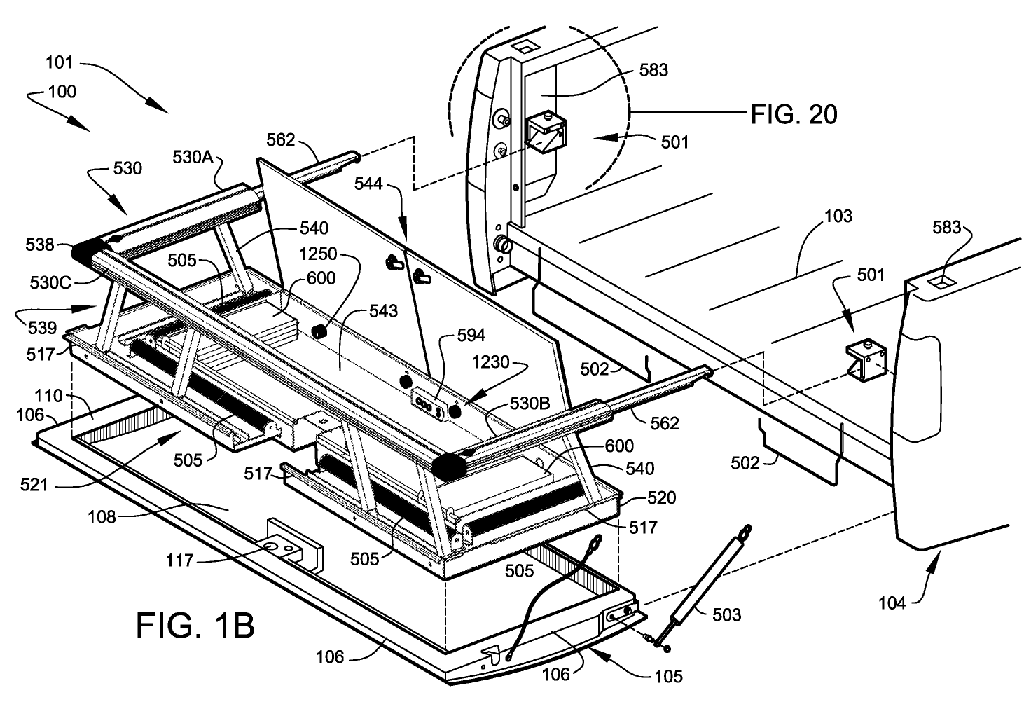

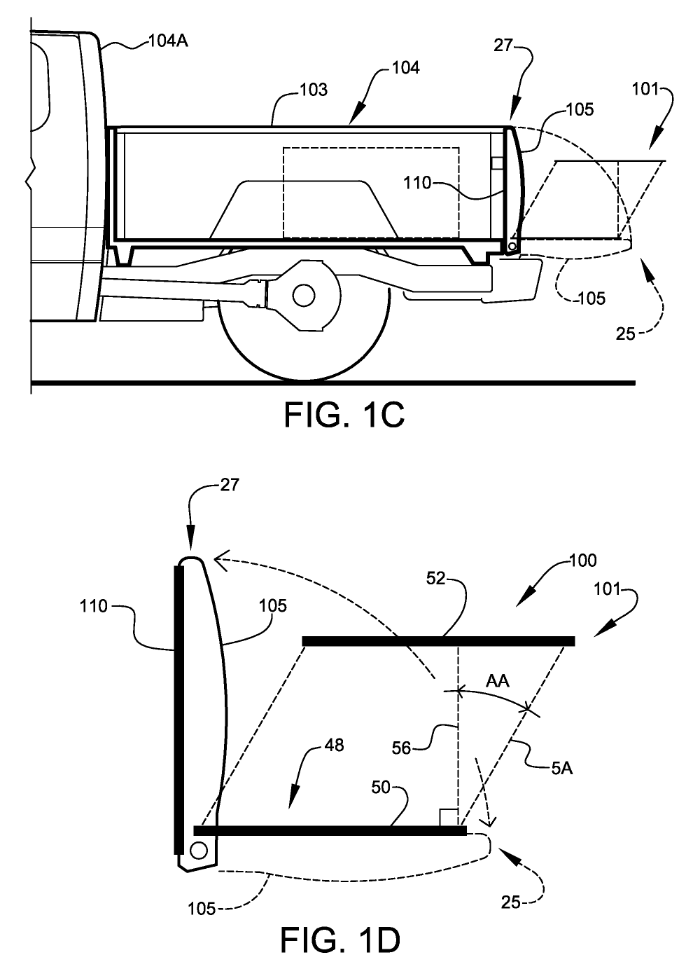

FIG. 1A shows a perspective view illustrating a tailgate barrier system 100 according to a preferred embodiment of the present invention. FIG. 1B shows an exploded perspective view illustrating the tailgate barrier system 100, according to the preferred embodiment of FIG. 1A. FIG. 1C shows a side view, in partial section, illustrating the tailgate barrier system 100 mounted within truck 104 according to a preferred embodiment of the present invention.

FIG. 1D shows a side view of the tailgate barrier, illustrating a preferred translational motion of a barrier bar moving between a stowed and a deployed configuration, according to the preferred embodiment of FIG. 1A.

Preferably, tailgate barrier system 100 provides a cargo barrier adapted to retain cargo 102 stored within cargo bed 103 of truck 104, as shown. Preferably, truck 104 comprises a motorized vehicle, adapted for the hauling and transport of materials, having an occupant cab 104A located generally foreword of cargo bed 103, as shown.

Preferably, tailgate 105 is pivotally mounted to cargo bed 103, as shown. Preferably, tailgate 105 comprises a generally horizontal “open” position 25 and a generally vertical “closed” position 27, as shown. Preferably, tailgate 105 is adapted to pivot between the raised closed position and the lowered (open) position. Tailgate 105 preferably comprises cab-facing external surface 110 that faces cab 104A (and the interior of the truck 104 bed) when tailgate 105 is upright and closed, and that faces upwards then tailgate 105 is open and lowered, as shown. Preferably, tailgate barrier assembly 101 of tailgate barrier system 100 is mounted adjacent cab-facing external surface 110, as shown.

Preferably, tailgate barrier assembly 101 functions as the above-described deployable barrier to bar cargo from falling out of truck 104 bed when tailgate 105 is in the lowered position, as generally depicted in FIG. 1A. When not in use, barrier system 100 retracts to a conveniently compact “stowed” configuration that, in the most preferred embodiments, uses essentially no additional cargo space within cargo bed 103.

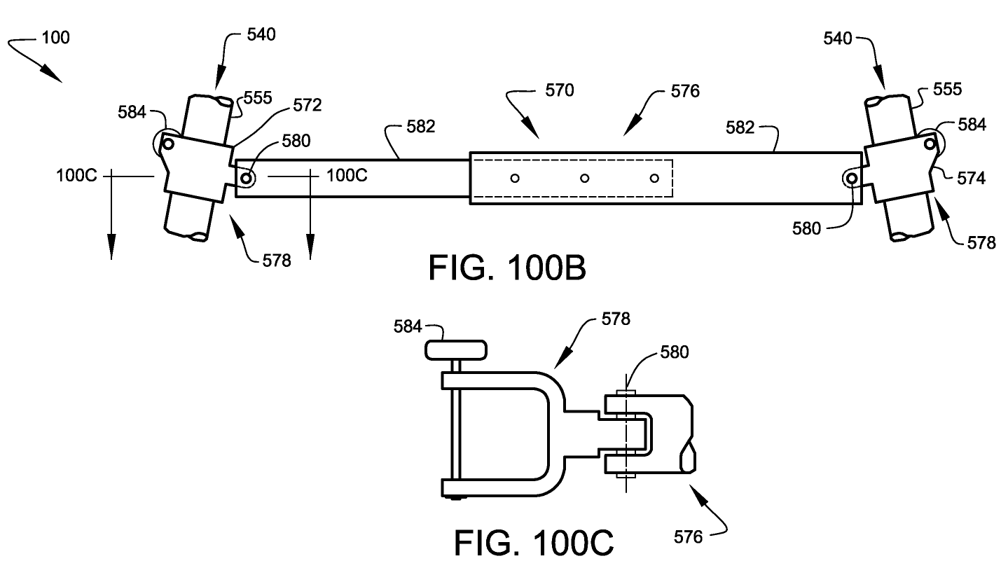

Tailgate barrier system 100 comprises at least two preferred mounting positions adjacent cab-facing external surface 110. The first preferred mounting arrangement (depicted in FIG. 1A and FIG. 1B) places tailgate barrier assembly 101 substantially within interior cavity 108 of tailgate 105, as shown. A second preferred mounting arrangement comprises a surface mounted embodiment adapted to externally mount to cab-facing external surface 110 (see FIG. 100). Highly preferred embodiments of tailgate barrier assembly 101 are supplied as “aftermarket” systems. More specifically, tailgate barrier assembly 101 is added to truck 104 after delivery from the vehicle manufacturer. As an aftermarket component, tailgate barrier assembly 101 is preferably adapted to be mountable to tailgate 105 without substantial vehicle modifications. Upon reading the teachings of this specification, those with ordinary skill in the art will now understand that, under appropriate circumstances, considering issues such as vehicle manufacturer, make, model, etc., other mounting arrangements, such as, for example, providing application specific mounting accessories, such as, additional reinforcing members, filler plates, face panels, gate actuators, fasteners, etc., may suffice. Alternate preferred embodiments of tailgate barrier assembly 101 further include tailgate 105, within the over all system assembly, and are preferably installed by the original manufacturer of truck 104 during vehicle assembly.

The following teachings focus on preferred embodiments that locate tailgate barrier assembly 101 substantially within interior cavity 108 of tailgate 105. It should be noted that a majority of the following illustrations and descriptions are also applicable to the preferred embodiments of the present invention that are externally mounted to tailgate 105.

Preferably, tailgate barrier assembly 101 comprises a substantially self-contained unit comprising a plurality of pre-assembled system components, as shown. Tailgate barrier assembly 101 preferably comprises barrier bar 530, extendable support assembly 539, storage-housing assembly 521 (comprising first storage section 520 and second storage section 543), flexible-restraint assembly 200, rail stabilization assembly 501, storage cover assembly 544, torsion bars 502, and pivot-rate limiter 503. In addition, preferred embodiments of the present invention comprise access-assisting devices such as folding ramp assembly 600, as shown.

Preferably, barrier bar 530 is movably supported by support assembly 539, as shown. Preferably, both barrier bar 530 and extendable support assembly 539 are adapted to be retractably stored within first storage section 520, of storage-housing assembly 521 (see FIG. 5). Preferably, storage-housing assembly 521 is mountable substantially within interior cavity 108 of tailgate 105, as shown. For the example vehicle illustrated in FIG. 1A and FIG. 1B, tailgate barrier assembly 101 comprises a stowed size of about a 60-inch length, about a 20-inch width, and about a 3½ inch depth. Preferably, barrier bar 530 is adapted to lower fully into first storage section 520 without interfering with the existing tailgate assemblies, such as, for example, factory gate-release mechanism 117.

Torsion bar 502 and pivot-rate limiter 503 are preferably used to control the force and rate of rotation of tailgate 105 (to manage the additional weight of tailgate barrier assembly 101 within tailgate 105). Preferably, both torsion bar 502 and pivot-rate limiter 503 comprise commercially available products. Torsion bars suitable for use as torsion bar 502 include products marketed under the Tailgate EasyLift Tailgate Lifter brand by Hoppy Mfg. Pivot-rate limiters suitable for use as pivot-rate limiter 503 include hydro-pneumatic adjustment elements (gas springs) produced under the brand name EZDown by STABILUS International.

Preferably, barrier bar 530 comprises a substantially rigid, U-shaped member, adapted to retain cargo 102 within cargo bed 103, as shown. Preferably, barrier bar 530 is a load-bearing bar of sufficient size and strength to withstand impact from cargo shifting in the cargo bed of truck 104 during transport (at least embodying herein at least one load-bearing bar structured and arranged to provide, when extended from at least one stowed position to at least one extended position, at least one load-bearing restraint of the cargo).

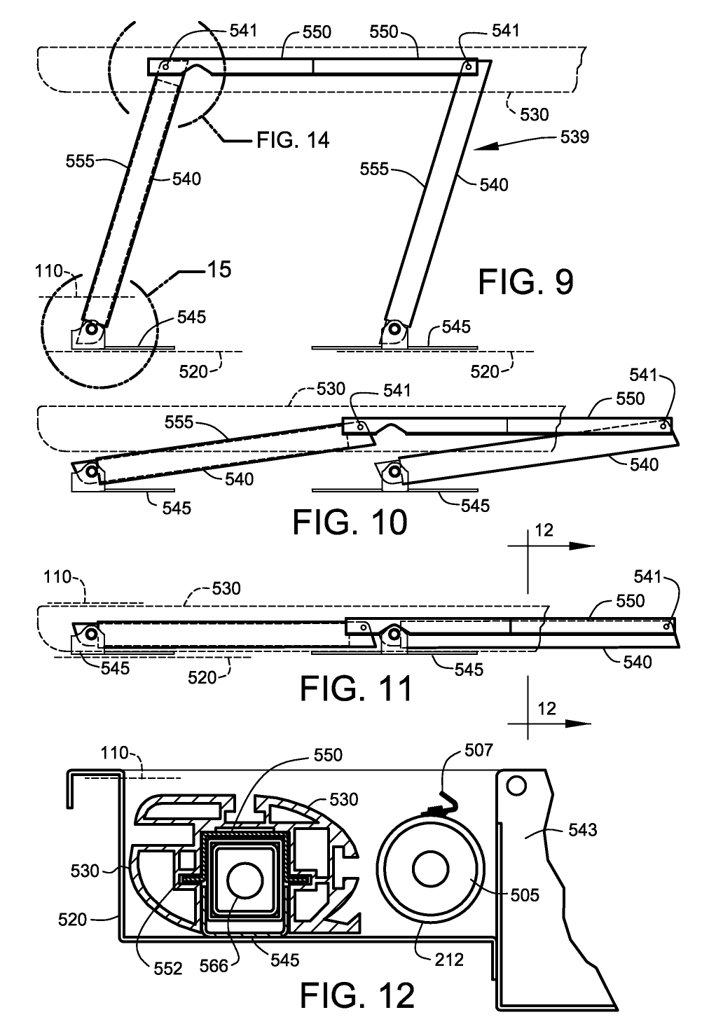

Referring again to both FIG. 1C and FIG. 1D, the preferred dynamic movement of barrier bar 530 (at least embodying herein at least one extendable barrier to assist barring movement of cargo from a truck bed having a tailgate), as it moves from a stowed position adjacent cab-facing external surface 110 (see FIG. 11) to the extended position (illustrated in FIG. 1A and FIG. 9), is diagrammatically illustrated. Preferably, barrier bar 530, when unextended in a stowed position lies substantially in a first plane 50 along cab-facing external surface 110 of tailgate 105 and, when moved to the extended position, lies in second plane 52 spaced from and substantially parallel to first plane 50, as shown. The preferred linear upward motion of barrier bar 530 to the extended position falls substantially within third plane 54 comprising an angle AA of no more than about 30 degrees from fourth plane 56 oriented substantially perpendicular to first plane 50. It is noted that in preferred operation, first plane 50 is both substantially horizontal and substantially parallel to cab-facing external surface 110 and fourth plane 56 comprises a substantially vertical orientation, as shown. The preferred dynamics of the deployment comprises a substantially linear movement, as shown. Such preferred movement does not require pivoting or rotation of the barrier assembly during extension from the stowed position to the extended position. This highly preferred feature is important in that cargo may be located on or over tailgate 105 (very near barrier bar 530) without hindering the extension tailgate barrier assembly 101.

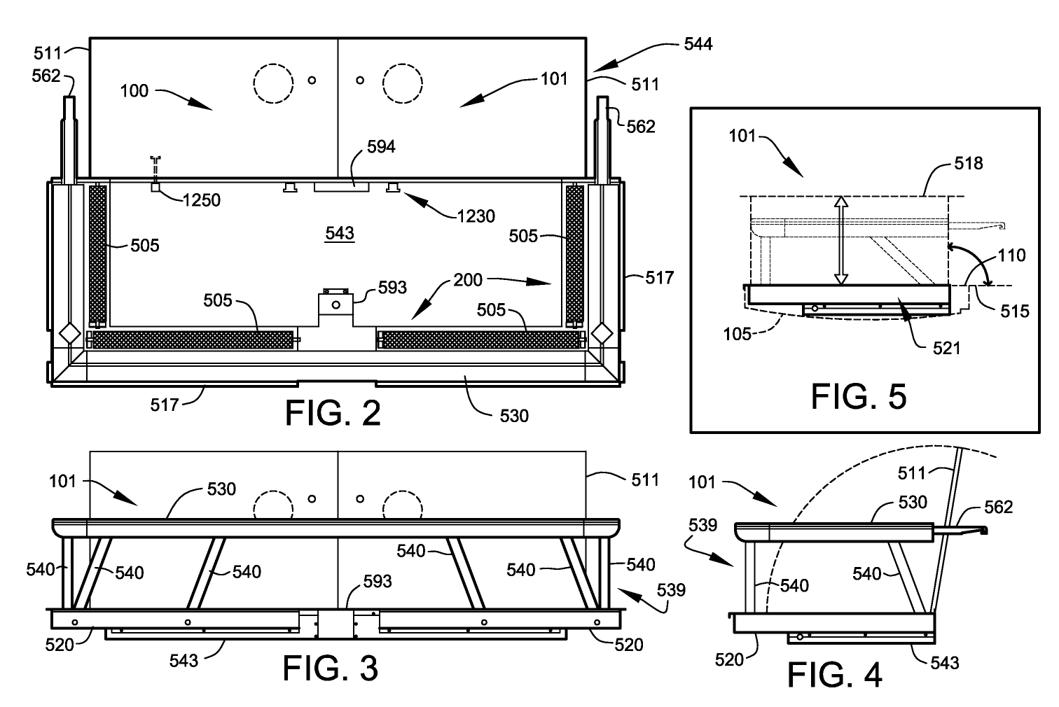

FIG. 2 shows a top view of tailgate barrier assembly 101, according to the preferred embodiment of FIG. 1A. FIG. 3 shows a front view of tailgate barrier assembly 101, according to the preferred embodiment of FIG. 1A, in a deployed position. FIG. 4 shows a side view of tailgate barrier assembly 101, according to the preferred embodiment of FIG. 1A, in a deployed position. FIG. 2 through FIG. 4 illustrates various views of an assembled tailgate barrier assembly 101. In FIG. 2 through FIG. 4, storage cover assembly 544 is shown in an open position and preferably comprises two independently operable hinged cover panels 511, as shown.

FIG. 5 shows a side view of tailgate barrier assembly 101, illustrating an alternate preferred translational motion of barrier bar 530 moving between a stowed and a deployed configuration, according to the preferred embodiment of FIG. 1A. Preferably, barrier bar 530 is deployed from first storage section 520 in a single substantially vertical motion, as shown.

Preferably, barrier bar 530, when unextended in a stowed position within first storage section 520, lies substantially within first plane 515 generally adjacent cab-facing external surface 110 of tailgate 105, as shown. Preferably, barrier bar 530 extends upwardly to the extended position shown in FIG. 1A, placing barrier bar 530 in second plane 518, as shown. Preferably, second plane 518 is parallel to, and spaced perpendicularly from, first plane 515, as shown.

Preferably, extendable support assembly 539 (at least embodying herein at least one at least one conveyor to convey such at least one load-bearing bar from the at least one stowed position to the at least one extended position) conveys barrier bar 530 substantially perpendicularly from the stowed position in first plane 515 to the extended position in second plane 518, as shown. Preferably, when tailgate 105 is in the lowered position, the action of the extendable support assembly 539 maintains the motion of barrier bar 530 along a substantially vertical path between the stowed position and the extended position. Preferably, extendable support assembly 539 functions as the above-described deployable barrier to bar cargo from crossing the rear perimeter 106 of tailgate 105 when tailgate 105 is in the lowered position, as generally depicted in FIG. 1A.

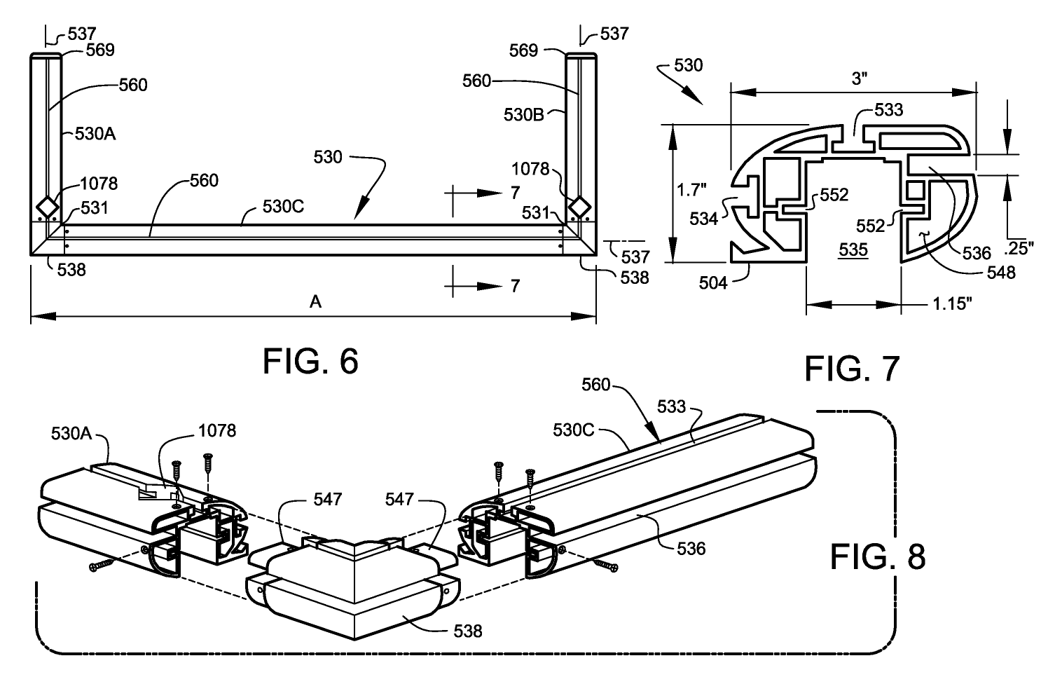

FIG. 6 shows a top view of barrier bar 530, isolated from the overall barrier assembly, according to the preferred embodiment of FIG. 1A. FIG. 7 shows the sectional view 7-7 of FIG. 6 illustrating a preferred cross-sectional profile of barrier bar 530. FIG. 8 shows an exploded perspective view illustrating rail coupler 538, according to the preferred embodiment of FIG. 1A. Preferably, barrier bar 530 comprises an assembly of longitudinally elongated, substantially rigid rails. Preferably, barrier bar 530 is formed from three elongated rail segments, as shown. Barrier bar 530 preferably comprises first side-rail portion 530A, second side-rail portion 530B, and rear rail portion 530C, as shown. Preferably, each rail portion of barrier bar 530 comprises a substantially constant sectional profile along its main longitudinal axis, identified herein as longitudinal axis 537. Preferably, first side-rail portion 530A, second side-rail portion 530B, and rear rail portion 530C are rigidly joined at intersecting corners 531 forming a generally “U” shaped member, as shown. The length A of barrier bar 530 is preferably matched to size of the tailgate (in the present example, slightly less than about 60 inches).

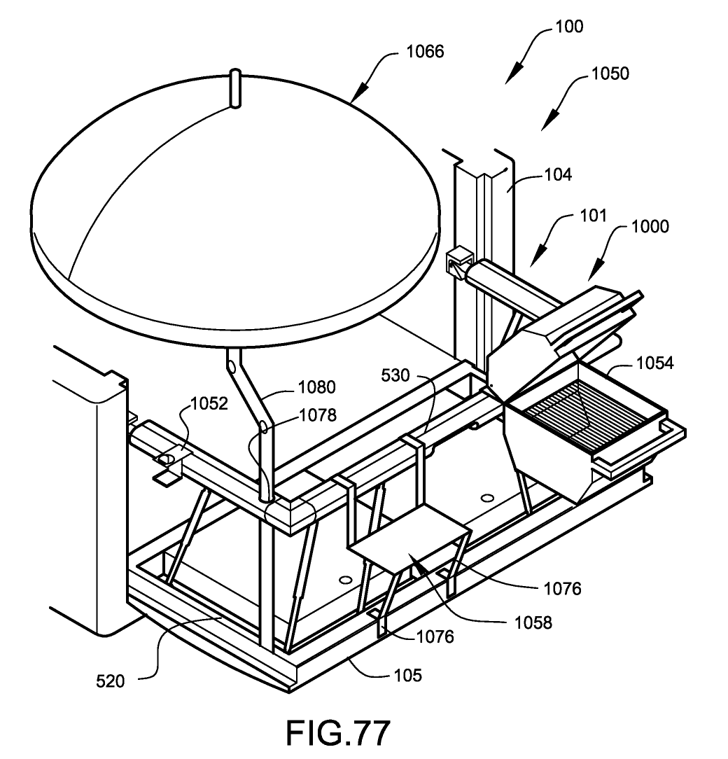

Preferably, first side-rail portion 530A and second side-rail portion 530B each comprise an aperture 1078, as shown. Preferably, aperture 1078 is adapted to allow vertical support structures of mountable accessories (such as stanchions of umbrellas) to pass through barrier bar 530 (see also FIG. 77).

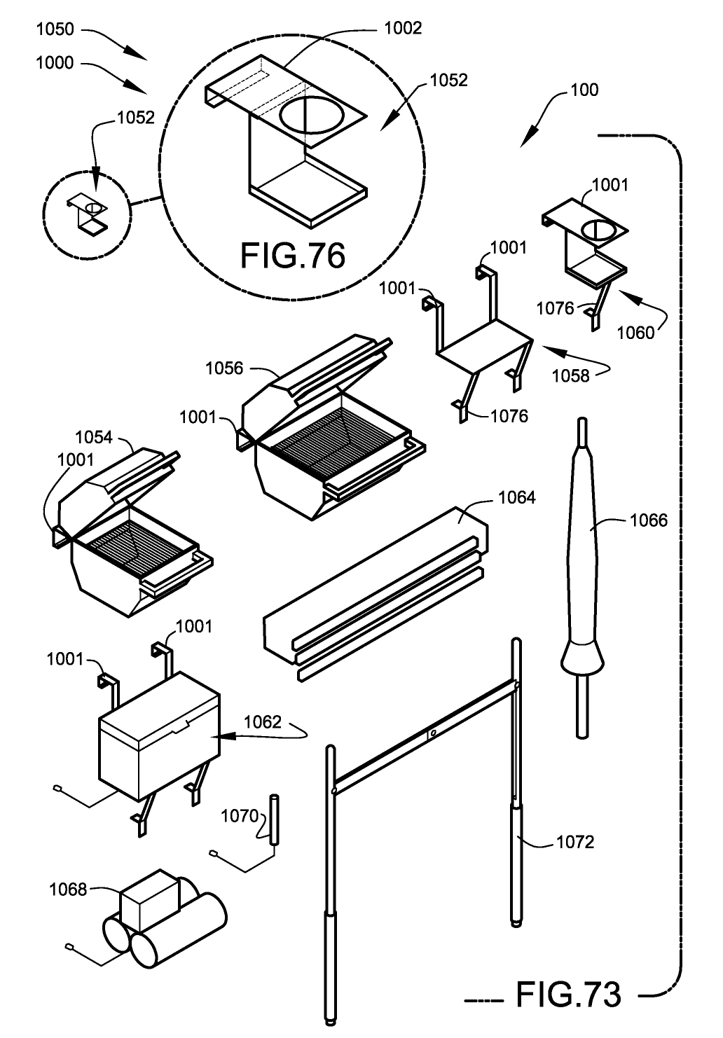

Preferably, barrier bar 530 comprises a specialized cross-sectional profile, as shown. Preferably, the cross-sectional profile of barrier bar 530 comprises lower channel 535, upper channel 533, leading channel 534, trailing channel 536, and projecting ledge 504, as shown. Preferably, projecting ledge 504 is adapted to retain flexible-restraint assembly 200 in a deployed position. Preferably, upper channel 533 and leading channel 534 each comprises a T-shaped slot portion 560 forming a continuous slot opening within barrier bar 530. Preferably, the T-shaped sectional profile of upper channel 533 and leading channel 534 are adapted to receive and removably retain one or more interlocking engagers. The interlocking engagers are preferably used to mount a range of useful devices to barrier bar 530, as further described in FIG. 52 and FIG. 73. To minimize weight and material usage, barrier bar 530 comprises several hollow internal chambers 548, as shown. Example dimensions further enabling a preferred embodiment of the present invention are provided, as shown.

Preferably, barrier bar 530 is constructed from a rigid and durable material with metallic materials being most preferred. Other preferred materials include plastics. Barrier bar 530 is preferably made in an extrusion process, which produces uniform, and cost efficient rail stock, suitable for high volume production. Most preferably, barrier bar 530 comprises an extrusion of aluminum alloy.

The preferred U-shaped embodiment of barrier bar 530 is manufactured from such rail stock by cutting a segment of the rail stock into appropriate lengths, as shown in FIG. 6. Three such lengths (first side-rail portion 530A, second side-rail portion 530B, and rear rail portion 530C) are preferably assembled to form a rigid and solid frame by connecting the lengths using a set of rail couplers 538 shown in FIG. 8, the coupler extensions 547 of each rail coupler 538 being inserted into the ends of adjacent barrier bar portions, as shown. Preferably, rail couplers 538 maintain first side-rail portion 530A and second side-rail portion 530B at about a 90-degree orientation relative to rear rail portion 530C, as shown. After assembly of barrier bar 530, rail couplers 538 are preferably fastened by means of mechanical fasteners, as shown.

FIG. 9 shows a partial front view of two rear extendable supports 540 of extendable support assembly 539, in an extended position. FIG. 10 shows a partial front view of the two rear extendable supports 540, in a partially extended position. FIG. 11 shows a partial front view of the two rear extendable supports 540, in a fully stowed position. FIG. 12 shows a cross-sectional view, through the section 12-12 of FIG. 11, illustrating the stored barrier bar 530, and cargo net retractor 205 of flexible-restraint assembly 200 in first storage section 520, according to a preferred embodiment of the present invention.

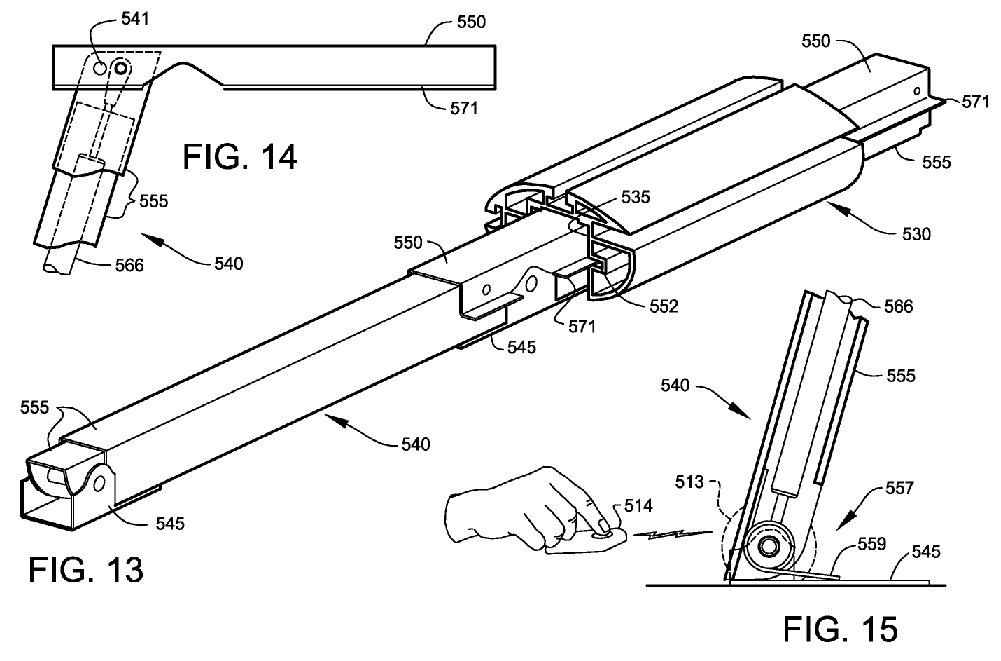

FIG. 13 shows a cut-away perspective view illustrating the main operable components of tailgate barrier assembly 101 in a stowed position. FIG. 14 shows the detailed cut-away view 14 of FIG. 9 and FIG. 15 shows the detailed cut-away view 15 of FIG. 9.

Preferably, each extendable support assembly 539 comprises a plurality of extendable supports 540, most preferably comprising four rear extendable supports 540 and two side extendable supports 540, as shown. Preferably, each extendable support 540 comprises a set of length adjustable bars, adapted to raise and lower barrier bar 530, as described above.

Preferably, each extendable support 540 is constructed using a pair of telescoping sections 555, preferably comprising interfitting legs, preferably square tube leg members, which allow the length of extendable support 540 to be slidably adjusted for length, as shown (at least embodying herein at least one telescoping leg to telescopically adjust at least one linear distance between said at least one first connector and said at least one second connector). Preferably, extendable supports 540 are adjustable to at least one pre-selected length (preferably corresponding to the height of an anchor point within the vehicle bed), as shown. During deployment, extendable supports 540 preferably swings through a near 90-degree arc, as shown. Preferably, in the extended position, extendable supports 540 are oriented near vertical, relative to the horizontally oriented cab-facing surface 110, when fully extended and ready for use, as shown. Preferably, the angular rotation of extendable supports 540 is limited to less than 90-degrees relative to the horizontally oriented cab-facing surface 110, as shown. This preferred limit of rotation arranges extendable supports 540 to allow a smooth downward angular rotation of extendable supports 540 during the lowering and stowing of barrier bar 530.

Preferably, the lower (proximal) ends of extendable supports 540 are pivotally mounted within first storage section 520, as shown. Preferably, each extendable support 540 is pivotally mounted within first storage section 520 at base connector bracket 545, as shown. Preferably, base connector bracket 545 is adapted to allow the pivoting of extendable support 540 with a single degree of freedom. Preferred arrangements of base connector bracket 545 are described in FIG. 46 though FIG. 48.

Preferably, each extendable support 540 comprises at least one rotator 557 adapted to generate at least one rotational force usable to assist in lifting extendable support 540 during deployment, as shown. Preferably, rotator 557 comprises at least one spring 559, as shown. Spring 559 is preferably positioned around base connector bracket 545, as shown. Preferably, spring 559 is adapted to apply an opposing force to the interior of the adjacent telescoping section 555 and at least one fixed element, preferably base connector bracket 545, as shown. Alternate preferred embodiments of the present invention comprise power-assisted rotators. For example, in preferred embodiments of the present invention, base connector bracket 545 is modified to comprise an electrically-operated gear-reduction motor 513 structured and arranged to rotate each extendable support 540. Preferably, such power-assisted actuators comprise at least one actuator control to provide user control of the operation of the power-assisted actuator. This preferably assists the user in locating boundary rail between the stowed and extended positions. Such a user control comprises an electrical switch or relay system. Most preferably, such a user control operates in conjunction with at least one remote wireless interface 514, as shown.

Preferably, the upper end of each extendable support 540 is pivotally coupled to a hat-shaped channel identified herein as slider 550, as shown. Preferably, lower channel 535 of barrier bar 530 comprises two opposing slide slots 552, as shown, in which slider 550 is movably captured. Preferably, slider 550 is adapted to horizontally translate within slide slots 552 as barrier bar 530 is raised or lowered. Preferably, side projections 571 of slider 550 are arranged to fit within slide slots 552 of lower channel 535 such that slider 550 may slide along the length of lower channel 535 without becoming disengaged from slide slots 552. Upon reading the teachings of this specification, those with ordinary skill in the art will now understand that, under appropriate circumstances, considering such issues as advances in technology, user preference, etc., other arrangements, such as bearings, other sliding arrangements, motorized supports, actuated supports, hydraulic supports, scissors-type collapsible supports, accordion-type collapsible supports, etc., may suffice.

It is preferred that the movement of adjacent pairs of rear extendable supports 540 be coordinated during deployment and stowing, as shown. Preferably, the length of the sliders 550 of the rear extendable supports 540 are set at lengths that coordinates the movement of the depicted pair of rear extendable supports 540 (when the adjacent ends of the two sliders 550 come into contact), as shown. Preferably, the combined length of the two adjacent sliders 550 sets the distance between the upper pivot points 541 about equal to the distance between the two lower pivot points of base connector brackets 545, as best shown in FIG. 9.

Preferably, each extendable supports 540 comprise at least one telescopic assister, more preferably, at least one gas-charged spring 566, as shown. Preferably, gas-charged spring 566 is adapted to support, at least partially, the weight of the moving assemblies of tailgate barrier assembly 101, thus assisting the user in raising and lowering barrier bar 530. Preferably, gas-charged spring 566 is located within telescoping sections 555, as shown. Preferably, gas-charged spring 566 is operably coupled to the upper distal end of the upper telescoping section 555, and lower pivot of base connector brackets 545, as shown. Preferred gas-charged spring assemblies suitable for use as gas-charged spring 566 are available from the SUSPA Corporation (www.suspa-inc.com).

Preferably, lower channel 535 comprises sufficient internal size to accommodate substantially the entire assembly of slider 550, extendable support 540, and base connector bracket 545, as best illustrated in FIG. 12 and FIG. 13.

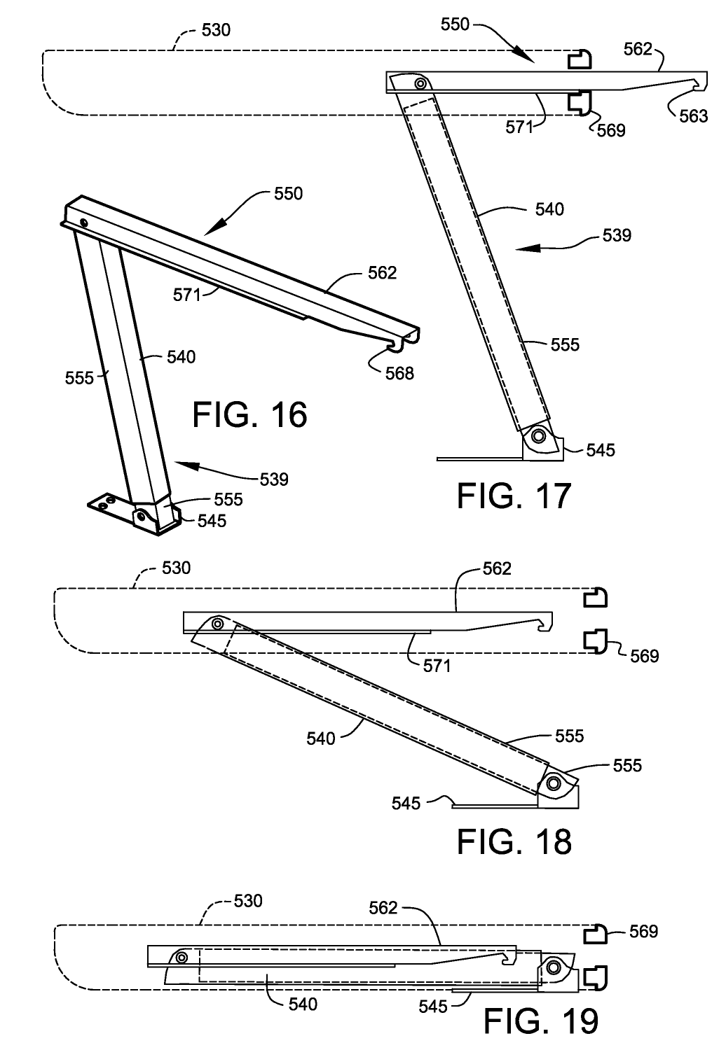

FIG. 16 shows a perspective view illustrating a side extendable support 540, isolated from tailgate barrier assembly 101, according to the preferred embodiment of FIG. 1A. FIG. 17 shows a side cut-away view of the side extendable support 540 of the tailgate barrier, according to the preferred embodiment of FIG. 1A, in an extended position. FIG. 18 shows a side cut-away view of the side extendable support 540, according to the preferred embodiment of FIG. 1A, in a partially extended position. FIG. 19 shows a side cut-away view of the side extendable support 540, according to the preferred embodiment of FIG. 1A, in a stowed position.

Preferably, the side extendable supports 540 differ from the rear extendable supports 540 in that the side-mounted sliders 550 are structured and arranged to deploy outwardly from first side-rail portion 530A and second side-rail portion 530B as barrier bar 530 is raised to the extended position depicted in FIG. 17. For clarity, these specialized side-mounted sliders 550 are hereinafter referenced as extendable side supports 562. Preferably, extendable side supports 562 moveably extend from barrier bar 530 to engage at least one fixed element of cargo bed 103, most preferably rail stabilization assembly 501, as shown (at least embodying herein at least one bar-stabilization assembly structured and arranged to stabilize such at least one U-shaped member when in such at least one extended position; wherein such at least one bar-stabilization assembly comprises at least one bed-mounted anchor structured and arranged to provide at least one anchor point within the truck bed, coupled with such at least one U-shaped member, at least one anchor engager structured and arranged to engage such at least one bed-mounted anchor; wherein such at least one anchor engager comprises at least one rail coupler structured and arranged to couple such at least one anchor engager to such at least one load-bearing bar; wherein when such at least one U-shaped member is in the at least one stowed position, such at least one anchor engager is retracted to a position substantially within such at least one extruded side channel; and wherein such at least one anchor engager is deployed from such at least one extruded side channel by movement of such at least one load-bearing bar between the at least one stowed position and the at least one extended position).

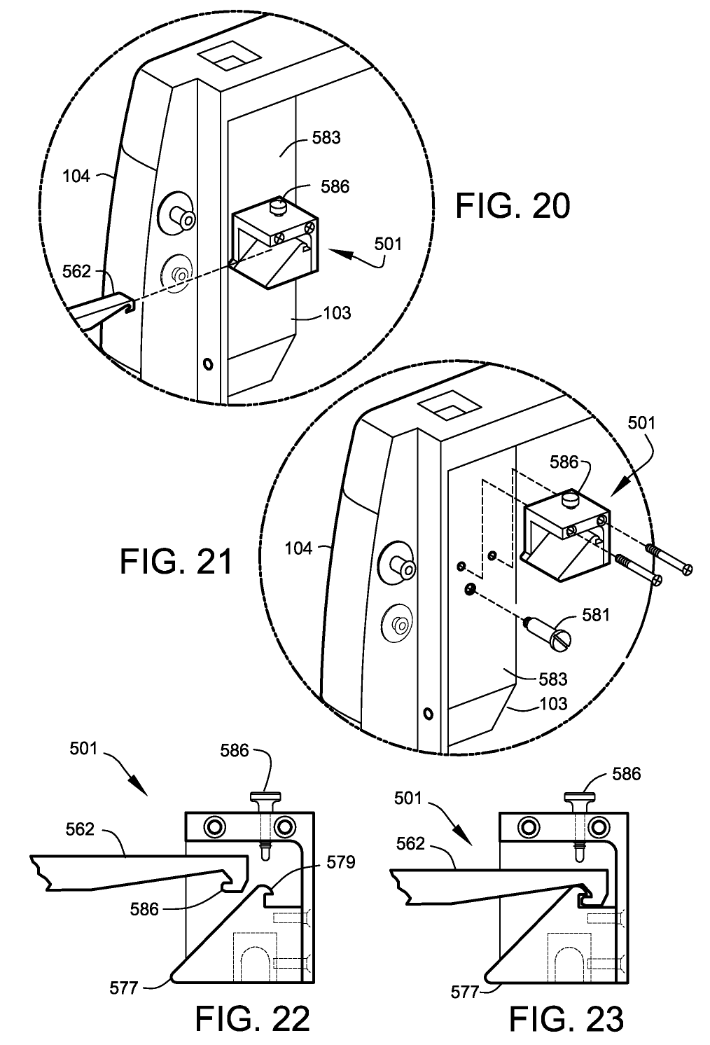

Preferably, each extendable side support 562 comprises a substantially linear bar comprising an end hook 568, as shown. Preferably, hook 568 is adapted to releasably engage rail stabilization assembly 501 as described in FIG. 20. Preferably, the distal ends of side-rail portion 530A and second side-rail portion 530B are each fitted with end cap 569, as shown. Preferably, end cap 569 functions to limit the translational movement of its respective extendable side support 562, in and out of barrier bar 530, as shown. This preferred feature is enabled by the deletion of the horizontal side projections 571 from an end portion of extendable side support 562, as shown. Preferably, end cap 569 is adapted to pass the end portion of extendable side support 562 (without side projections 571), and block the outward passage of the remainder of extendable side support 562 containing side projections 571, as shown.

Preferably, extendable side supports 562 are adapted to support and releasably couple the deployed barrier bar 530 to cargo bed 103, thus providing additional structural stability to tailgate barrier assembly 101 while retaining barrier bar 530 in the extended position. Upon reading the teachings of this specification, those with ordinary skill in the art will now understand that, under appropriate circumstances, considering such issues as advances in technology, user preference, etc., other stabilizer arrangements, such as rail extenders that unfold from the rail, rail extenders that attach to the truck, rail-extending chains, the use of multiple extenders, etc., may suffice.

FIG. 20 shows a perspective view of the detailed view 20 of FIG. 1B, illustrating rail stabilization assembly 501 according to the preferred embodiment of FIG. 1A. FIG. 21 shows an exploded illustrating rail stabilization assembly 501 of FIG. 20. FIG. 22 shows a side view of rail stabilization assembly 501, positioned to receive extendable side support 562 of barrier bar 530, according to a preferred embodiment of the present invention. FIG. 23 shows a side view of rail stabilization assembly 501, interlocked with extendable side support 562 of FIG. 22.

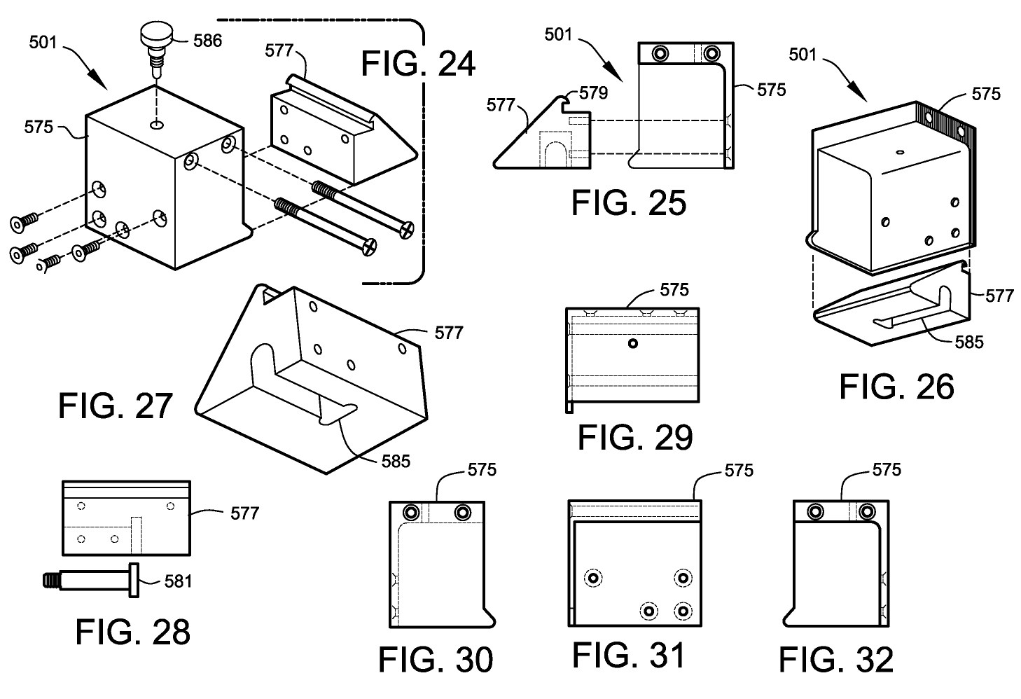

FIG. 24 shows an exploded perspective view of rail stabilization assembly 501 of FIG. 20. FIG. 25 shows an exploded side view of rail stabilization assembly 501. FIG. 26 shows another exploded perspective view of rail stabilization assembly 501 of FIG. 20.

FIG. 27 shows a perspective view of a ramp-shaped guide member of rail stabilization assembly 501. FIG. 28 shows a front view of the ramp-shaped guide member of rail stabilization assembly 501. FIG. 29 shows a front view and FIG. 30 shows a first side view of rail stabilization assembly 501. FIG. 31 shows a rear view of rail stabilization assembly 501 and FIG. 32 shows a second side view of the rail stabilization assembly 501 of FIG. 20.

Reference is now made to FIG. 20 through FIG. 32 with continued reference to the prior figures. Preferably, rail stabilization assembly 501 comprises a bed-mounted coupler structured and arranged to couple an extendable side support 562 to at least one load-bearing portion of cargo bed 103, as shown. Preferably, tailgate barrier assembly 101 comprises two rail stabilization assemblies 501, as shown, with each receiving one extendable side support 562, as best shown in the prior FIG. 1B.

Preferably, rail stabilization assembly 501 is formed in two parts comprising a box-like hollow receiver 575 containing a ramp-shaped guide member identified herein as removable guide ramp 577, as shown. Preferably, guide ramp 577 mounts to receiver 575 using mechanical fasteners, as shown. Preferably, guide ramp 577 comprises capture notch 579 structured and arranged to releasably capture hook 568, as best shown in FIG. 23. Preferably, the ramp-like shape of guide ramp 577 assists in guiding hook to capture notch 579 as extendable side support 562 automatically deploys from barrier bar 530, as shown.

Preferably, rail stabilization assembly 501 further comprises at least one post 581 structured and arrange to be coupled to a load-bearing portion of cargo bed 103, such as stake pocket 583, as shown. Preferably, guide ramp 577 comprises socket 585 structured and arranged to engage post 581 to form a load-bearing structural connection between rail stabilization assembly 501 and cargo bed 103, as shown.

Preferably, the upper face of receiver 575 comprises a user releasable retainer 586, as shown. Preferably, releasable retainer 586 assists in retaining hook 568 on capture notch 579. Preferably, retainer 586 comprises a quick release plunger threadably mounted to receiver 575, as shown. Quick release plungers suitable for use as retainer 586 preferably include quick release plungers provided by the M. J. Vail Company, Inc. of Belle Mead, N.J.

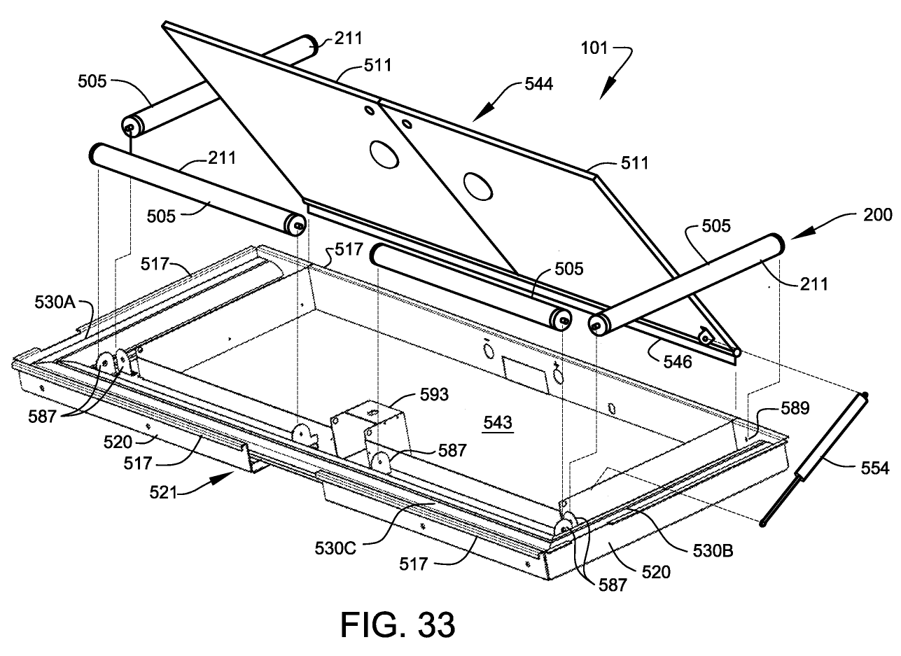

FIG. 33 shows an exploded perspective view of storage housing assembly 521 of the tailgate barrier of FIG. 1A. Preferably, tailgate barrier assembly 101 comprises a substantially self-contained, as shown. In the depicted illustration of FIG. 33, barrier bar 530 is shown in a fully retracted position within first storage section 520. The depth of first storage section 520 is established to fully accommodate the thickness of barrier bar 530, as shown. This preferred arrangement allows the retracted system to reside entirely flush with cab-facing surface 110 (see also FIG. 12.

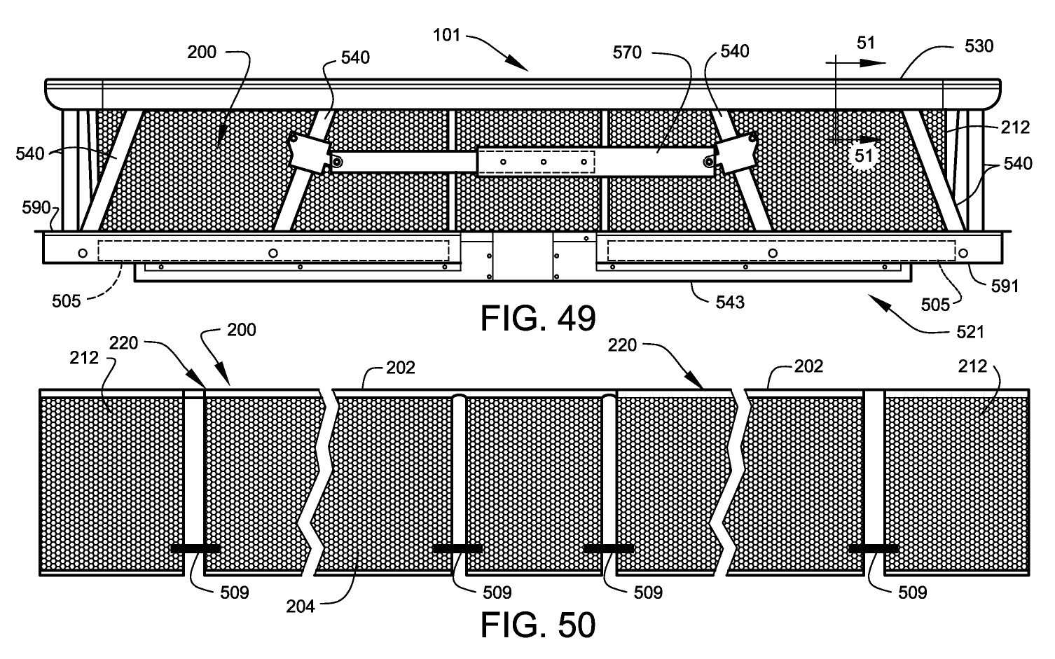

The four retractors 505 of flexible-restraint assembly 200 have been removed from first storage section 520 to show the preferred mounting points for the retractors 505, which comprise a combination of net-retractor support brackets 587 and engageable apertures 589 located within the vertical walls of first storage section 520, as shown. Preferably, each retractor 505 comprises a spring-loaded roller, having a generally cylindrical shape, comprising a set of mounting projections at each end, as shown. Preferably, each retractor 505 is adapted to support a rolled panel of flexible cargo netting 211, as further described in FIG. 49. Preferably, retractors 505 comprise commercially available retractor assemblies such as the JD03OMA line of products available from Carefree of Colorado, Broomfield, Colo., USA.

Storage cover assembly 544 has been separated from storage housing assembly 521 to further illustrate the preferred arrangements of the centrally located second storage section 543. Storage cover assembly 544 preferably comprises a securable (lockable) set of cover panels 511 hingedly attached to second storage section 543 at cover hinge 546, as shown. Each cover panel 511 is preferably adapted to receive a tubular cam-type lock.

Preferably, second storage section 543 is centrally situated adjacent the U-shaped first storage compartment 520, generally residing between first side-rail portion 530A, second side-rail portion 530B, and rear rail portion 530C, as shown. Preferably, second storage section 543 is adapted to hold storable articles such as tools, small cargo items, emergency equipment, etc. Upon reading the teachings of this specification, those with ordinary skill in the art will now understand that, under appropriate circumstances, considering issues such as vehicle type, user preference, etc., other storage arrangements, such as, for example, adapting a secondary storage space to the storage of automatic gate actuators, motors, drives, audio speakers, audio amplifiers, video displays, etc., may suffice. Furthermore, those with ordinary skill in the art will now understand that, under appropriate circumstances, considering issues such as vehicle type, user preference, etc., other storage arrangements, such as, for example, equipping the secondary storage with tool holders, cargo restraints, storage clips, etc., may suffice. Support strut 554 is preferably provided to support storage cover assembly 544 in an open position during user access.

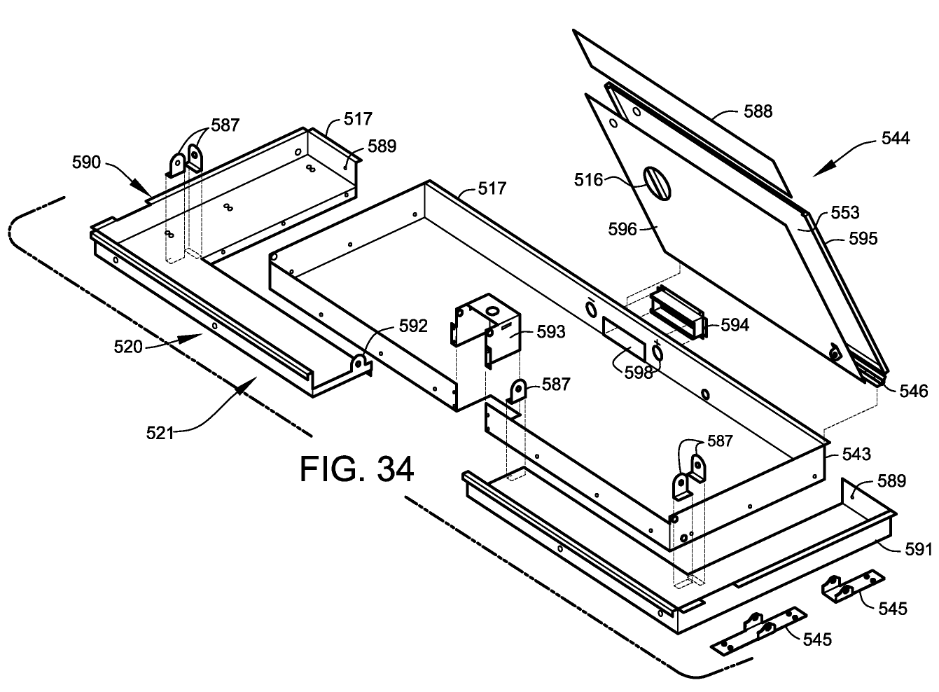

FIG. 34 shows an exploded perspective view further illustrating the preferred construction of storage housing assembly 521 of the tailgate barrier of FIG. 1A. Storage housing assembly 521 is preferably constructed from multiple individual component pieces, as shown.

Preferably, first storage compartment 520 comprises a two-part assembly identified herein as port-side first storage section 590 and starboard-side first storage section 591, as shown. Preferably, port-side first storage section 590 and starboard-side first storage section 591 each comprise mounting tabs allowing mounting to the external walls of second storage section 543. Five net-retractor support brackets 587 are permanently mounted to the interior bottom face of port-side first storage section 590 and starboard-side first storage section 591, as shown. Each net-retractor support bracket 587 is adapted to support one end of a retractor 505. The preferred configuration of port-side first storage section 590 allows an integral net-retractor support bracket 592 to be formed within the over assembly, as shown. Two engageable apertures 589, located within the leading vertical walls of port-side first storage section 590 and starboard-side first storage section 591, support the engaging end projections of the retractors 505.

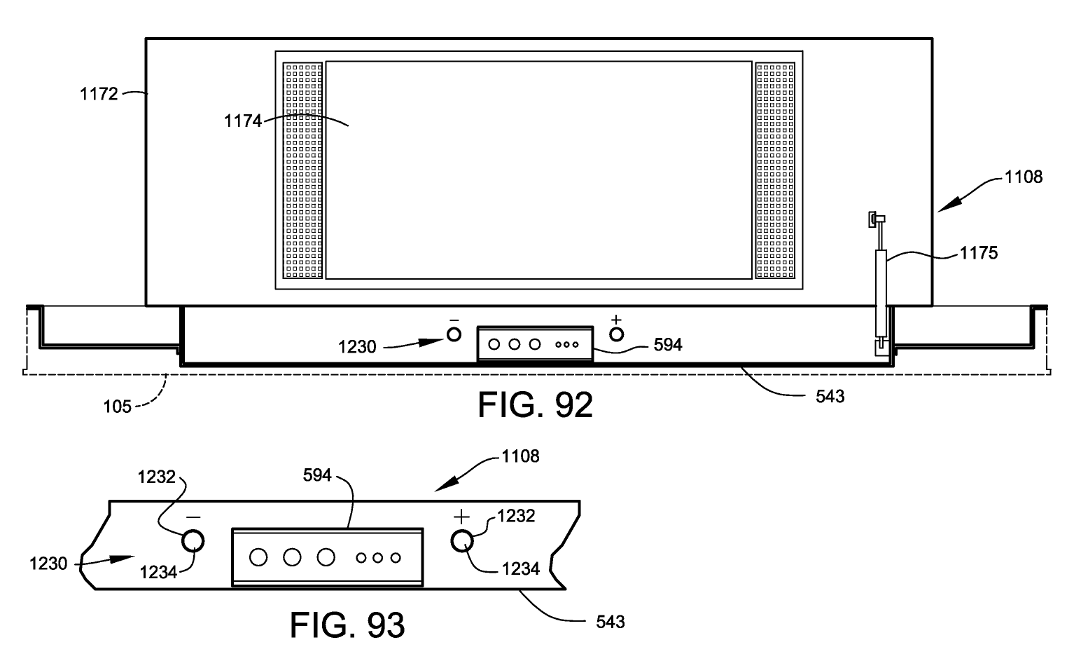

Preferably, latch box 593 and power box 594 comprise individual assemblies permanently mountable to second storage section 543 during assembly, as shown. Preferably, latch box 593 is adapted to support a tubular cam-type lock assembly used to secure storage cover assembly 544. Power box 594 preferably supports electrical connection points as further described in FIG. 92.

Preferably, cover panel 511 of storage cover assembly 544 comprises outer cover panel 595 and inner cover panel 596, as shown. In addition, preferred embodiments of storage cover assembly 544 comprise extendable cover portion 588, adapted to slide outwardly from storage cover assembly 544 to protectively cover a portion of first storage section 520. Preferably, extendable cover portion 588 is situated within an interstitial slot cavity 553 of storage cover assembly 544, as shown. Upon reading the teachings of this specification, those with ordinary skill in the art will now understand that, under appropriate circumstances, considering issues such as cover thickness, cover material, etc., other extendable cover arrangements, such as, for example, fold-down extensions, tonneau-style flexible covers, etc., may suffice.

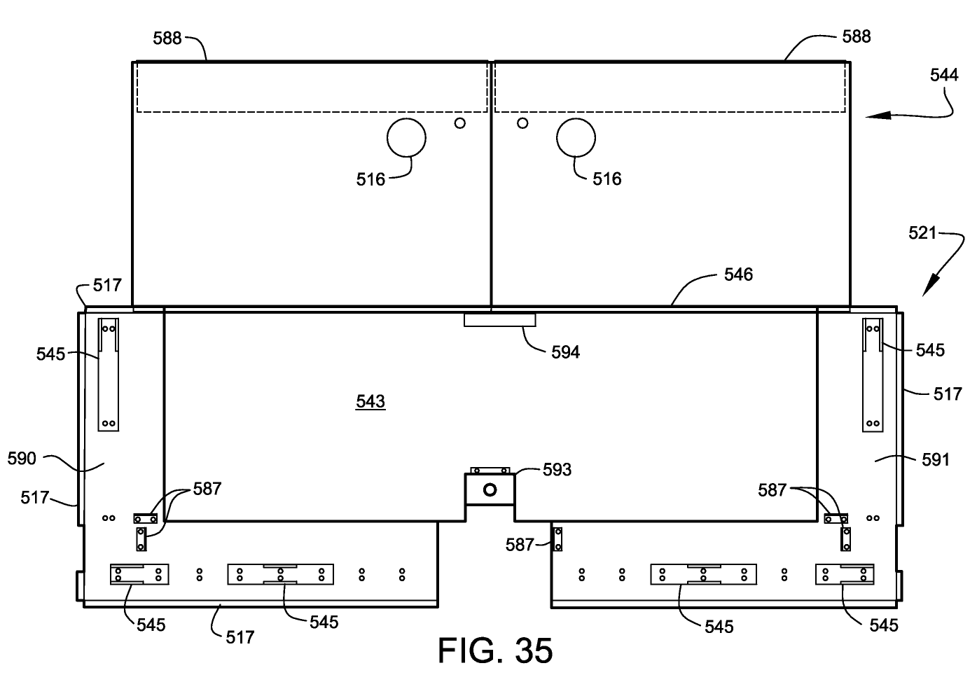

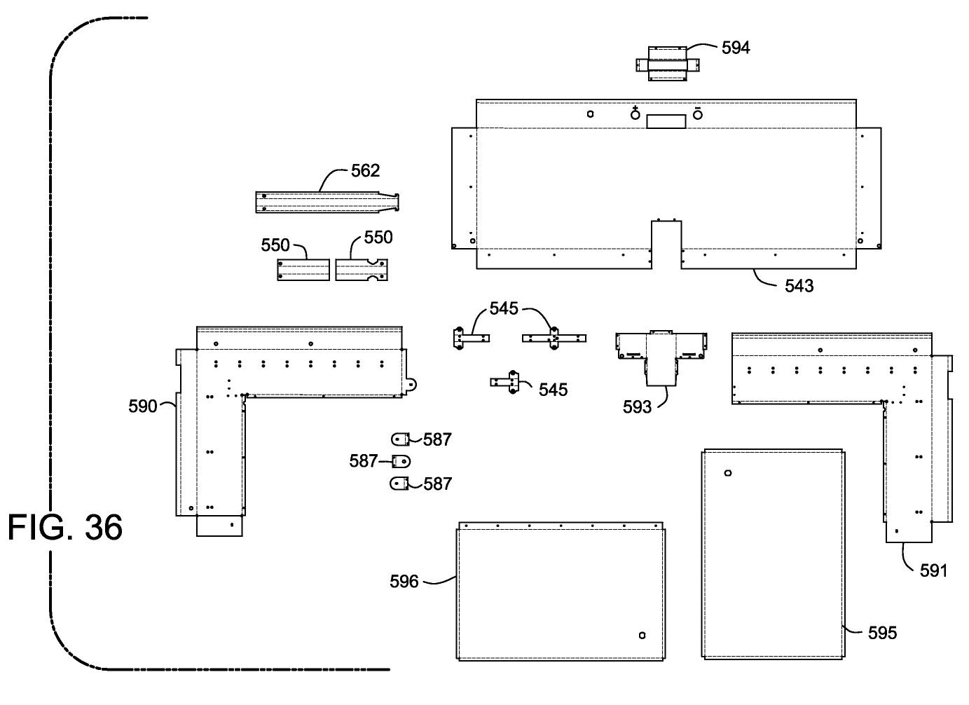

Inner cover panel 596 is illustrated with a preferred modification comprising aperture opening 516 adapted to accommodate a partially recessed light fixture. Upon reading the teachings of this specification, those with ordinary skill in the art will now understand that, under appropriate circumstances, considering issues such as cover thickness, cover material, etc., other arrangements, such as, for example, accommodations for speakers, electronics, video screens, etc., may suffice. FIG. 35 shows a top view of storage housing assembly 521 of FIG. 34 in a preferred assembled configuration. Preferably, storage housing assembly 521 comprises peripheral flange 517 used to secure tailgate barrier assembly 101 to cab-facing surface 110 of tailgate 105. Preferably, peripheral flange 517 is mechanically fastened to cab-facing surface 110 using screw-type fasteners. Upon reading the teachings of this specification, those with ordinary skill in the art will now understand that, under appropriate circumstances, considering issues such as tailgate design, system material, etc., other mounting arrangements, such as, for example, welding, bonding, clamping using quick-release devices, etc., may suffice. Preferably, components of tailgate barrier assembly 101 are constructed from a combination of materials, each having an application-appropriate level of durability and weather resistance. Preferably, tailgate barrier assembly 101 substantially comprises metal, most preferably steel and/or aluminum. For economy and ease of manufacture, many of the components of tailgate barrier assembly 101, including storage housing assembly 521, are formed from sheet panels, most preferably metallic sheet panels, as shown. FIG. 36 shows a plan view illustrating layouts of individual sheet panels used to form components of tailgate barrier assembly 101. These sheet metal components preferably include second storage section 543, port-side first storage section 590, starboard-side first storage section 591, latch box 593, power box 594, outer cover panel 595, inner cover panel 596, extendable cover portion 588, net-retractor support brackets 587, sliders 550, extendable side supports 562, and base connector brackets 545, as shown. Preferably, each of the above noted components are cut from sheet stock and are brake-formed (folded using a mechanical bending tool) to produce the finished components shape. For heavy-duty applications, seams are preferably joined by welding. With the exception of port-side first storage section 590, and base connector brackets 545, starboard-side first storage section 591, and the sheet metal components of tailgate barrier assembly 101 are preferably constructed from 0.50 5052-H32 sheet aluminum. Port-side first storage section 590, starboard-side first storage section 591, and base connector brackets 545 are preferably constructed from a heavier 0.90 5052-H32 sheet aluminum. Upon reading the teachings of this specification, those with ordinary skill in the art will now understand that, under appropriate circumstances, considering such issues as advances in technology, user preference, etc., other materials, such as molded plastics, composite material constructions, combinations of differing materials, etc., may suffice.

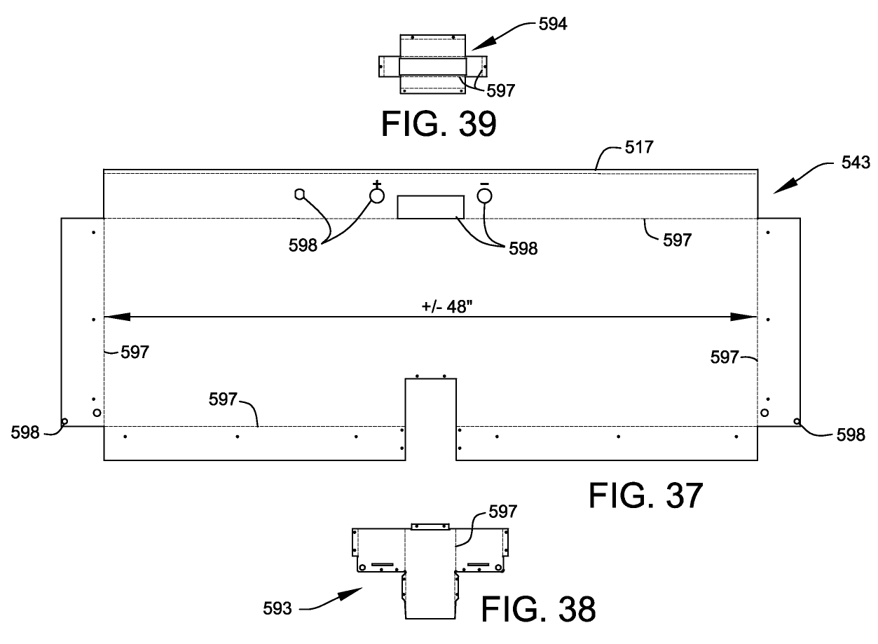

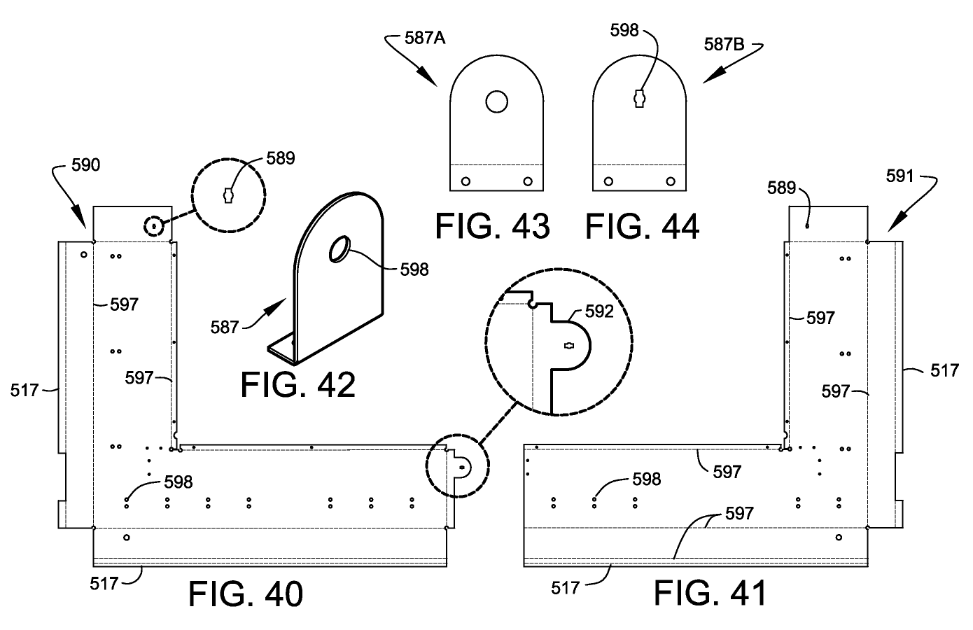

FIG. 37 shows a plan view of a flattened sheet layout used to assemble a preferred embodiment of second storage section 543 of tailgate barrier system 101 of FIG. 1A. FIG. 38 shows a plan view of a flattened sheet layout used to assemble a preferred embodiment of latch box 593 of second storage section 543. FIG. 39 shows a plan view of a flattened sheet layout used to assemble a preferred embodiment of power box 594 of second storage section 543. FIG. 40 shows a plan view of a flattened sheet layout used to assemble a preferred embodiment of port-side first storage section 590. FIG. 41 shows a plan view of a flattened sheet layout used to assemble a preferred embodiment of starboard-side first storage section 591 of tailgate barrier system 101 of FIG. 1A. Preferred fold lines 597 of the illustrated sheet layouts of FIG. 37 through FIG. 41 are depicted by dashed lines, as shown. Apertures 598 accommodating the fitting of preferred mechanical fasteners, electrical power devices, locking devices, etc. are provided as shown.

FIG. 42 shows a perspective view of a net-retractor support bracket 587 of tailgate barrier system 101 of FIG. 1A. FIG. 43 shows a plan view of a flattened sheet layout used to assemble a preferred embodiment of first net-retractor support bracket 587A according to a preferred embodiment of the present invention. FIG. 44 shows a plan view of a sheet layout used to assemble a preferred embodiment of second net-retractor support bracket 587B according to a preferred embodiment of the present invention. Preferably, second net-retractor support bracket 587B comprises shaped aperture 598 adapted to receive the engageable projection of retractor 505. The preferred configuration of shaped aperture 598 facilitates the spring-actuated operation of retractor 505 by resisting rotation of the retractor's projecting engager.

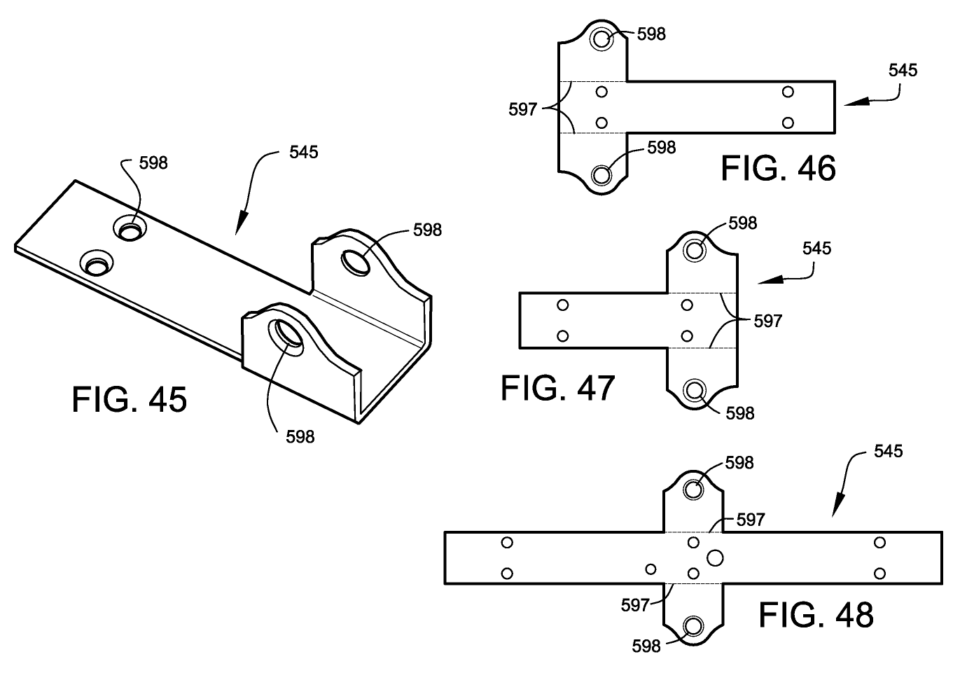

FIG. 45 shows a perspective view of a base connector bracket 545 used to pivotally connect a conveyor assembly of the tailgate barrier to the first storage section, according to the preferred embodiment of FIG. 1A. FIG. 46 through FIG. 48 show plan views of sheet layouts used to assemble preferred embodiments of the base connector brackets 545 of preferred embodiments of the present invention. Preferred application of the base connector brackets 545 to extendable supports 540 are depicted in the illustrated examples of FIG. 9 and FIG. 17.

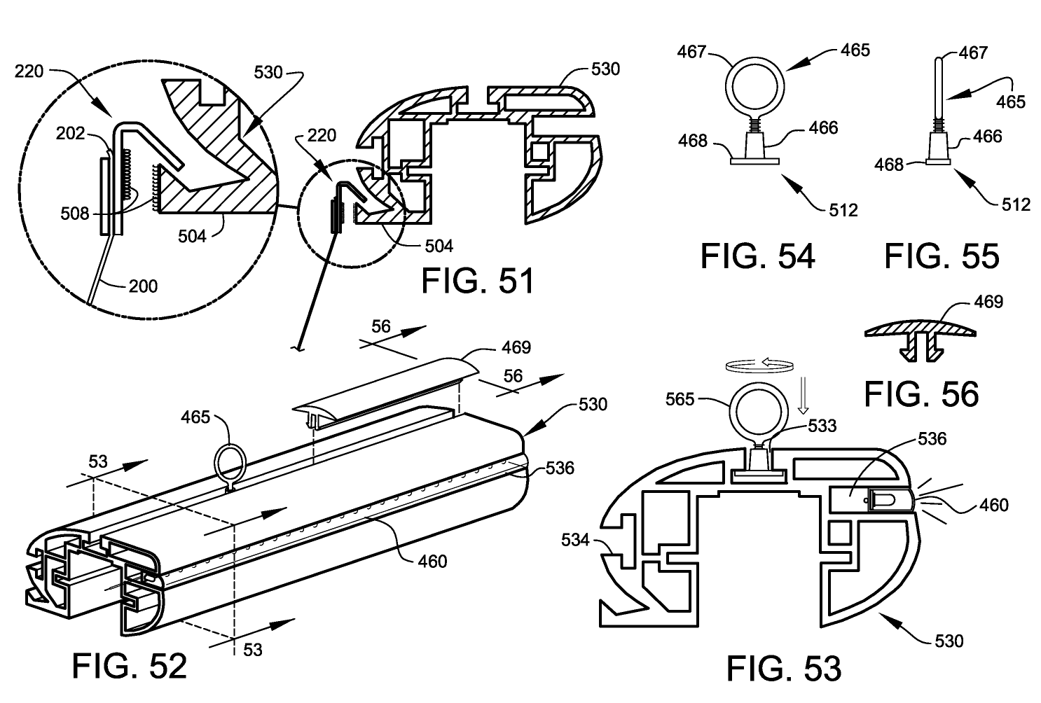

FIG. 49 shows a rear view of tailgate barrier assembly 101, in an extended position, comprising flexible barrier assembly 200, according to the preferred embodiment of FIG. 1A. FIG. 50 shows a plan view of flexible barrier 212 of flexible barrier assembly 200. FIG. 51 shows a sectional view through the section 51-51 of FIG. 49.

Preferably, flexible barrier assembly 200 is used to prevent cargo from moving through the gaps between extendable supports 540. Preferably, retractor 505 is adapted to feed out flexible barrier 212 as barrier bar 530 is raised, and to store flexible barrier 212, in a scroll-like manner, as barrier bar 530 is lowered. Preferably, retractor 505 is adapted to continuously tension flexible barrier 212 during deployment.

Preferably, flexible barrier assembly 200 is removably attached to barrier bar 530 at the top edge 202 of flexible barrier 212 and to retractor 505 at the bottom edge 204 of flexible barrier 212, as best shown in the sectional view of FIG. 51. Preferably, flexible barrier 212 is attached to projecting ledge 504 of barrier bar 530 utilizing attacher 220, as shown. Preferably, attacher 220 comprises hook 507 in combination with hook and loop fasteners 508, as shown. Upon reading the teachings of this specification, those with ordinary skill in the art will now understand that, under appropriate circumstances, considering such issues as advances in technology, user preference, etc., other attachers, such as hooks and grommets, snaps, magnets, clips, clamps, permanent attachment, etc., may suffice.

Preferably, flexible barrier 212 comprises individual panels of cargo netting 211, as shown. Preferably, cargo netting 211 comprises durable plastic (nylon, polypropylene, etc.) or fabric netting. Upon reading the teachings of this specification, those with ordinary skill in the art will now understand that, under appropriate circumstances, considering such issues as advances in technology, user preference, etc., other arrangements, such as the retractor being installed on the exterior of the storage compartment, a single cargo net covering an entire facet of the perimeter of the tailgate, cargo net retractors in the rail extenders, other types of retractors, powered retractors, other cargo netting materials, such as metallic fabric, etc., may suffice.

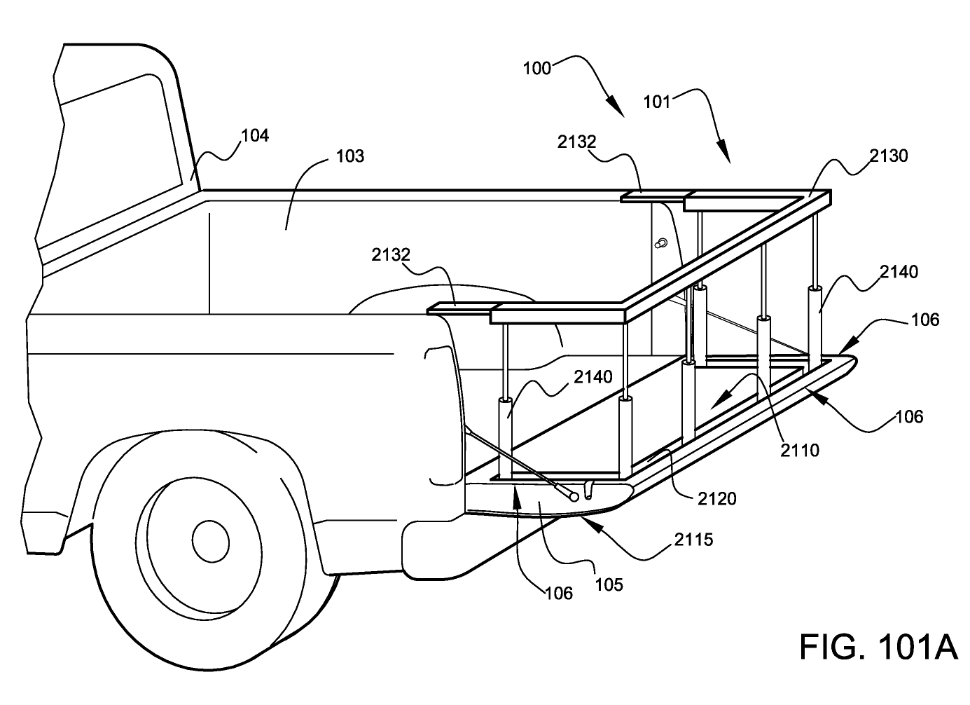

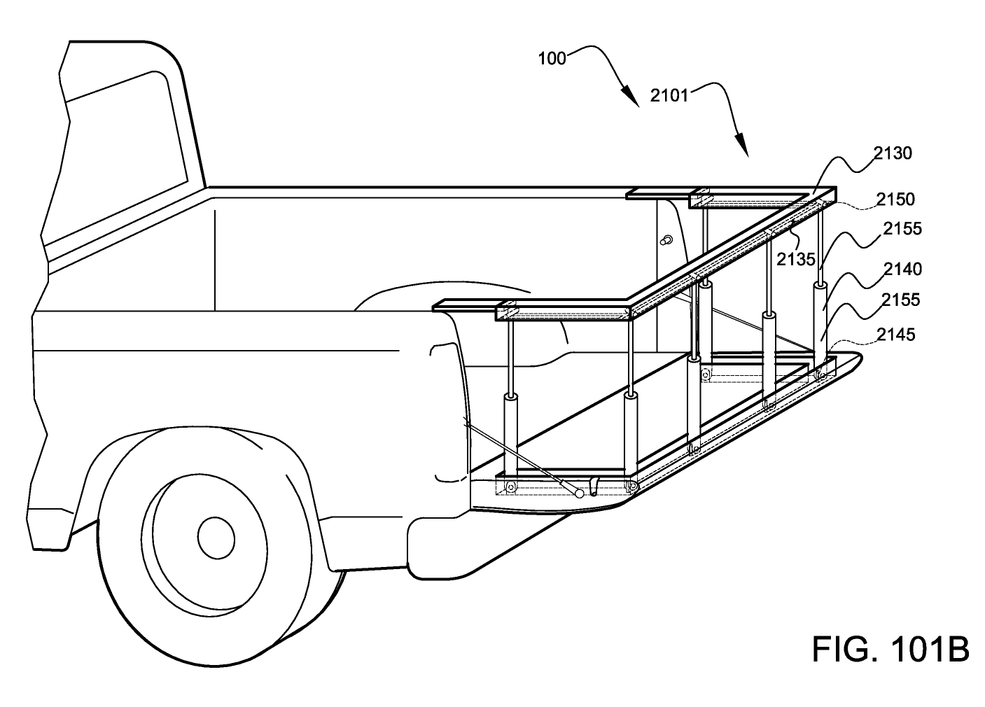

Flexible barrier 212 is preferably divided into a plurality of panels corresponding to the locations of the retractors 505, as shown. Each panel is continuously interconnected along top edge 202, as shown. Hook-and-loop ties 509 are preferably used to stabilize the lower portions of the panels, as shown. Flexible barrier 212 preferably comprises center panel 510, having no associated retractor 505, which is preferably secured to the adjacent panels using hook-and-loop ties 509. Also visible in FIG. 49 is a preferred accessory cross bar 570 described in greater detail in FIG. 101A.

FIG. 52 shows a perspective view, in partial section, of barrier bar 530 illustrating preferred illumination devices and an example of an accessory component removably mountable to tailgate barrier assembly 101. FIG. 53 shows a sectional view through the section 53-53 of FIG. 52. Preferably, barrier bar 530 is fitted with indicator light assembly 460, as shown. Preferably, indicator light assembly 460 functions as a secondary running light, brake light, turn signal, and/or hazard light (for added safety). Preferably, indicator light assembly 460 comprises an array of super high-intensity light emitting diodes (LED), as shown. Preferably, the LED array is housed within a one-piece, weather proof, polymer housing mounted within barrier bar 530, as shown. Preferably, indicator light assembly 460 comprises an application appropriate length of between about 36 inches and 72 inches. Preferably, indicator light assembly 460 is firmly mounted trailing channel 536, as shown. Preferably, indicator light assembly 460 is adapted to electrically couple with the taillight wiring circuit of truck 104. More preferably, indicator light assembly 460 is adapted to plug directly into the standard four-prong towing harness of truck 104. NHSTA approved indicator light assemblies suitable for use as indicator light assembly 460 include commercially available products available from RECON Truck Accessories of Boca Raton, Fla. Upon reading the teachings of this specification, those of ordinary skill in the art will now understand that, under appropriate circumstances, considering such issues as user preference, intended use, etc., other lighting arrangements, such as custom lighting installations, multiple lighting devices, devices comprising flashers/motion effects, etc., may suffice.

FIG. 54 shows a front view of a cargo anchor 465 of the tailgate barrier system. FIG. 55 shows a side view of the cargo anchor 465 of FIG. 54. Upper channel 533 and leading channel 534 of barrier bar 530 each comprises a T-shaped slot portion 560 forming a continuous slot opening within barrier bar 530 (at least embodying herein at least one T-shaped-cross-section slot portion forming at least one continuous slot opening portion within such at least one load-bearing bar). Preferably, the T-shaped sectional profiles of upper channel 533 and leading channel 534 are adapted to receive and removably retain one or more interlocking engagers 512. Interlocking engagers 512 are preferably used to mount a range of useful devices to barrier bar 530.

In the following description, a representative interlocking engager 512 comprising cargo anchor 465 is used to illustrate preferred mounting methods and arrangements. Preferably, cargo anchor 465 comprises a T-shaped insert 466 threadably mounted to anchor eyelet 467, as shown. Preferably, flange 468 of insert 466 comprises a narrow side profile (see FIG. 55), allowing passage through the outer slot opening of upper channel 533 and/or leading channel 534, and a wide front profile (see FIG. 54) adapted to engage the wide slot portion of upper channel 533 and leading channel 534, as shown. Inserting and twisting insert 466 orients flange 468 in a position preventing removal, as shown in FIG. 53.

Preferably, threading the base of anchor eyelet 467 tightly against the outer surface of barrier bar 530 frictionally locks cargo anchor 465 in position along barrier bar 530. Loosening anchor eyelet 467 preferably allows cargo anchor 465 slide freely along barrier bar 530 for subsequent repositioning.

Complete removal of the anchor is enabled by loosening anchor eyelet 467 followed by the rotation of insert 466 to the orientation shown in FIG. 55. This preferably allows the cargo anchor to be drawn out of the channel (at least embodying herein at least one interlocking engager structured and arranged to interlockably engage such at least one T-shaped-cross-section slot portion; wherein such at least one engager comprises at least one first position within such T-shaped-cross-section slot portion preventing removal; wherein such at least one slideable engager comprises at least one second position within such T-shaped-cross-section slot portion allowing removal; and wherein such at least one interlocking engager comprises at least one lashing anchor to provide at least one lashing anchor point; such at least one lashing anchor comprises at least one T-shaped slide structured and arranged to allow engaged sliding of such at least at least one lashing anchor within such at least one T-shaped-cross-section slot portion of such at least one barrier rail, and at least one slide-resister structured and arranged to resist sliding of such at least one lashing anchor within such at least one T-shaped-cross-section slot portion of such at least one barrier rail).

It is preferred that upper channel 533 and leading channel 534 of barrier bar 530 be protectively covered when not in use. Channel insert 469 is preferably adapted to engage and cover the channels. FIG. 56 shows a sectional view through the section 56-56 of FIG. 52 illustrating a preferred sectional profile of channel insert 469. Preferably, channel insert 469 comprises a length of commercially available T-molding, as shown. The T-molding preferably comprises a continuous flexible trim material, most preferably a plastic having a distinct T-shaped section. T-molding suitable for use as channel insert 469 includes a range of commercially distributed products supplied through URL http://www.t-molding.com.

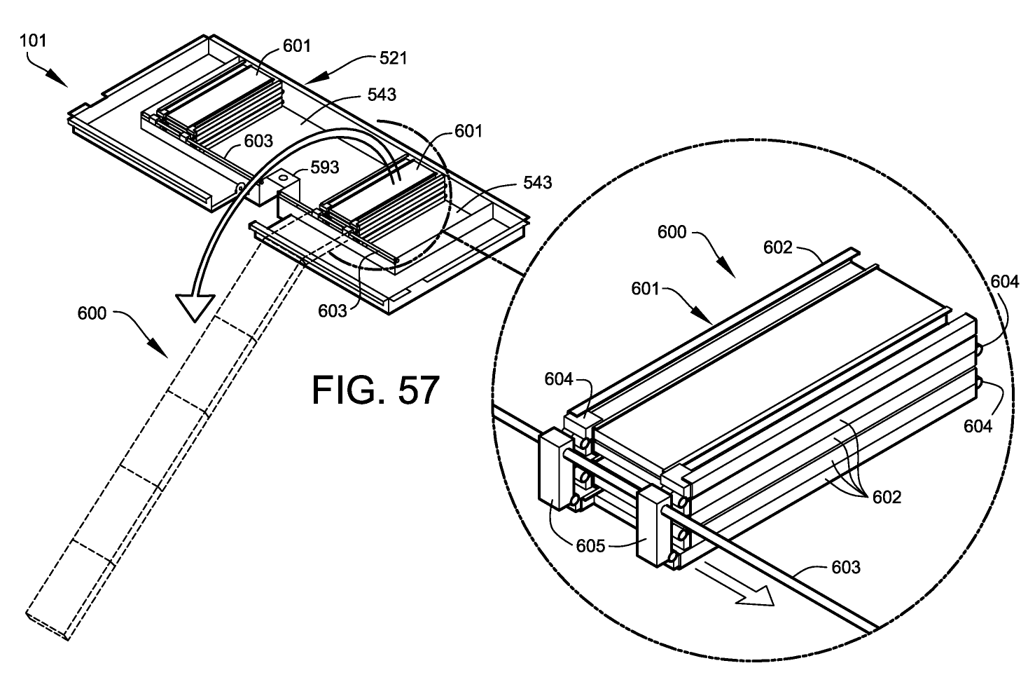

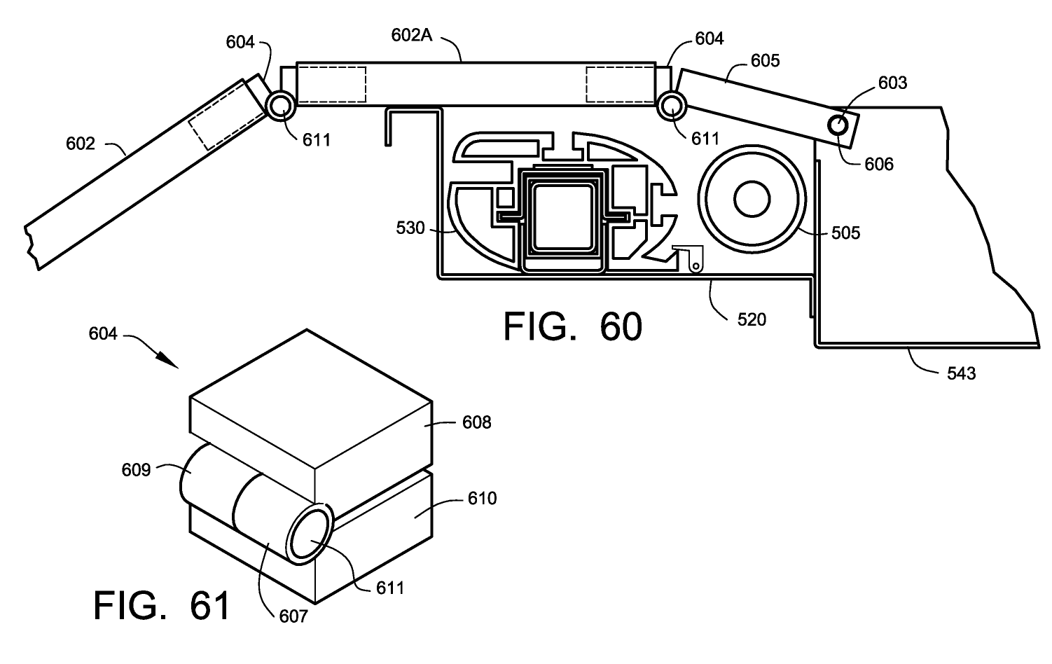

FIG. 57 shows a perspective view illustrating folding ramp assembly 600 according to a preferred embodiment of the present invention. Preferably, folding ramp assembly 600 is adapted to provide assisted user access to the interior of cargo bed 103. Preferably, folding ramp 601 of folding ramp assembly 600 is adapted to fold into a compact configuration for storage, preferably fitting within second storage section 543, as shown. Preferably, folding ramp assembly 600 is adapted to be deployable when barrier bar 530 is in a stowed position within first storage section 520 (see FIG. 60).

Preferably, folding ramp assembly 600 comprises two folding ramps 601 movably mounted within second storage section 543, as shown. Preferably, each folding ramp 601 is permanently engaged on linear guide rod 603, as shown (although folding ramp assembly 600 is preferably configured to be removable from second storage section 543 using basic hand tools). Preferably, linear guide rod 603 spans between latch box 593 and a vertical sidewall of second storage section 543, as shown. Preferably, each folding ramp 601 is free to slide along the length of linear guide rod 603, between latch box 593 and a vertical sidewall of second storage section 543, as shown. Each folding ramp 601 is thus free to translate to a preferred position, allowing the distance between the two folding ramps 601 to be highly adjustable. This preferred feature allows folding ramp assembly 600 to accommodate wheeled cargo vehicles having differing track widths. Preferably, each folding ramp 601 is free to pivot about linear guide rod 603, allowing the overall ramp assembly to rotate upwardly out of second storage section 543 during deployment, as shown.

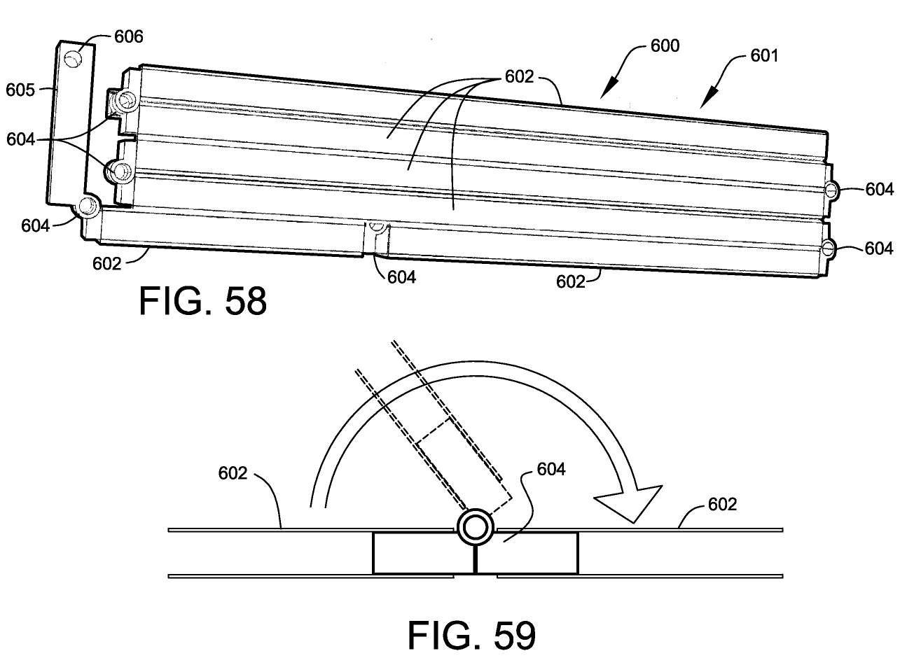

FIG. 58 shows a perspective view of folding ramp 601 removed from second storage section 543. Preferably, each folding ramp 601 comprises a plurality of articulating ramp segments 602, as shown. Preferably, each articulating ramp segment 602 is joined by a set of pivotal couplers 604, as shown. FIG. 59 shows a partial side view of folding ramp 601 illustrating the articulating action of the pivotal couplers 604. Pivotal couplers 604, in the orientation depicted in FIG. 59, pivot to form a self-supporting joint, as shown. The alternating orientation of successive pivotal couplers 604 requires the use of a secondary support, to stabilize the joint, as further described in FIG. 68.

FIG. 60 shows a sectional view through first storage section 520, illustrating a preferred deployed arrangement of folding ramp 601. Preferably, the initial pivotal coupler, identified herein as first coupler 605 comprises an elongated bar having an aperture 606 (adapted to engage linear guide rod 603) and a pivot knuckle (adapted to engage the pivotal coupler 604 of the first ramp segment 602A), as shown.

FIG. 61 shows a perspective view of a pivotal coupler 604 isolated from the ramp segment 602. Preferably, pivotal coupler 604 comprises at least one cylindrical upper knuckle 607 integrally formed with upper pivot body 608, and at least one lower knuckle 609 integrally formed with the lower pivot body 610, as shown. Preferably, the upper knuckle 607 is positioned adjacent lower knuckle 609, and a retaining pin 611 is pressed through lower knuckle 609 and upper knuckle 607, thereby pivotally joining the two pivot bodies, as shown.

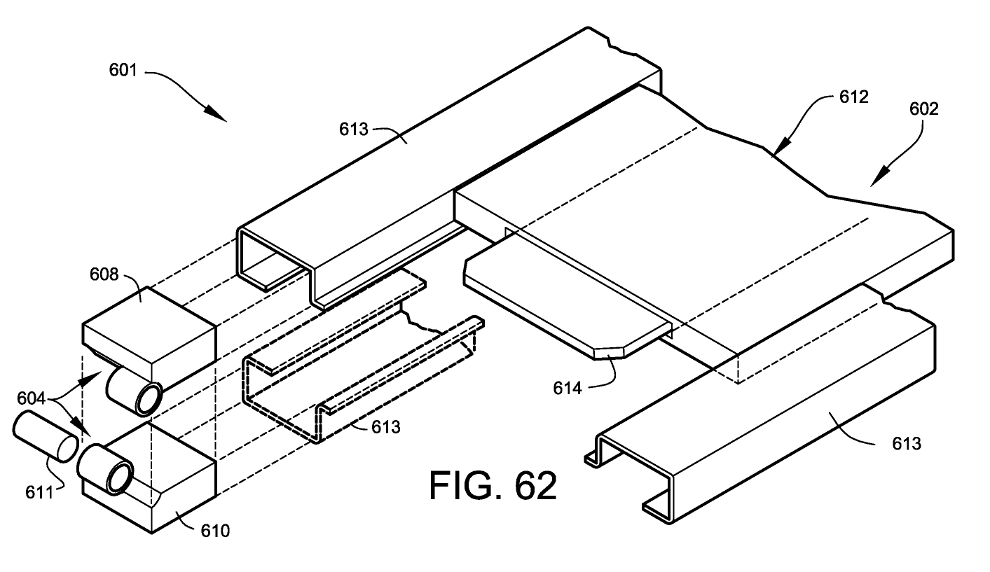

FIG. 62 shows a partial exploded perspective view illustrating preferred components of folding ramp 601. Preferably, each articulating ramp segment 602 comprises a generally planar center support 612 flanked by two side channels 613, as shown. Folding ramp 601 is preferably assembled by rigidly securing the pivot bodies of the pivotal couplers 604 within the ends of side channels 613, as shown.

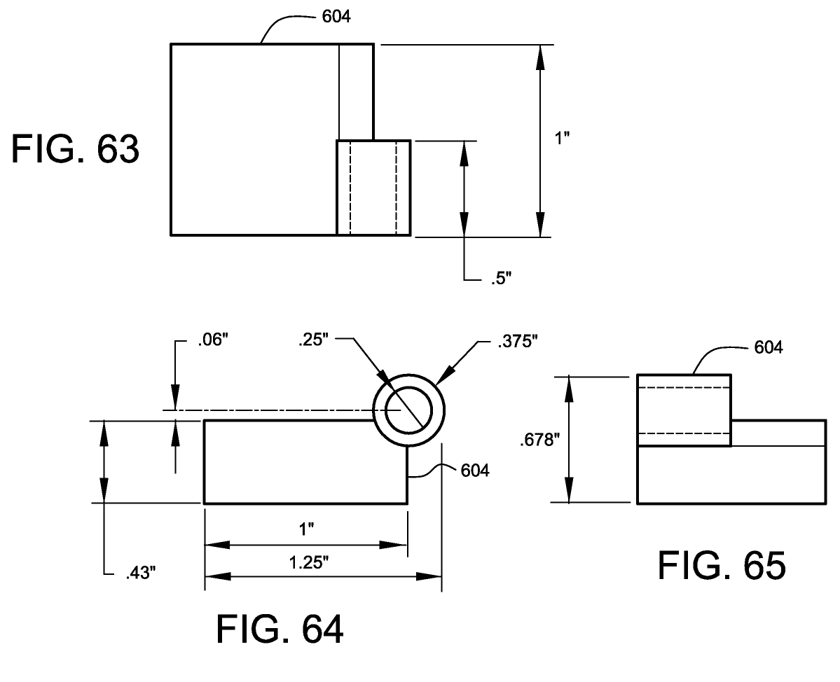

FIG. 63 shows a dimensioned top view of a pivot body of pivotal coupler 604. FIG. 64 shows a dimensioned side view of a pivot body of pivotal coupler 604. FIG. 65 shows a dimensioned end view of a pivot body of pivotal coupler 604. Preferably, pivotal couplers 604 are constructed from a rigid and durable material, preferably a metal, most preferably aluminum.

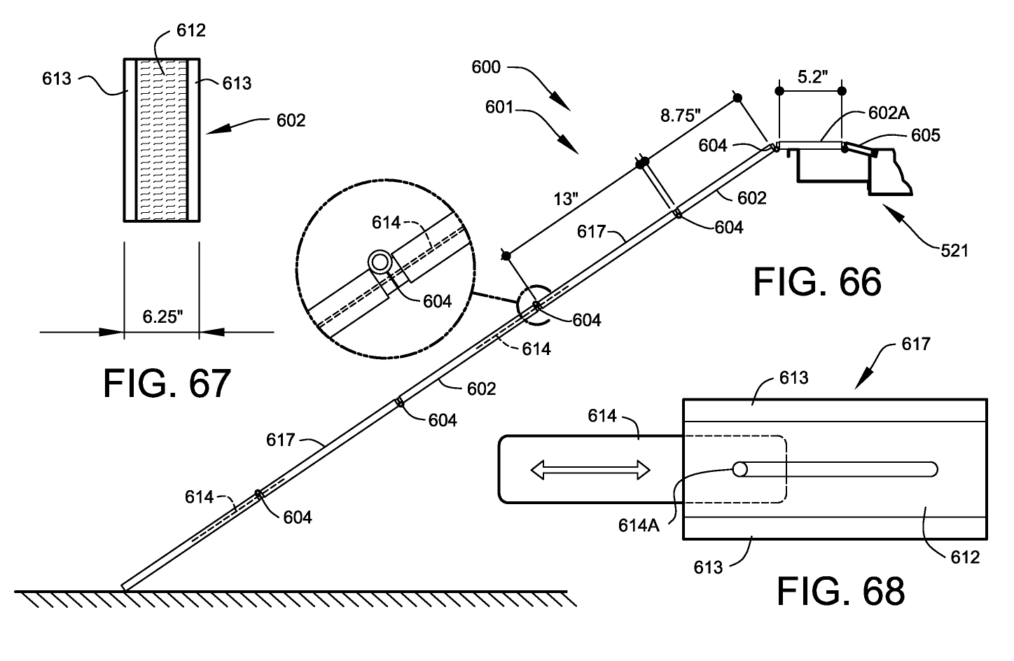

FIG. 66 shows a side view of folding ramp assembly 600 in a deployed configuration. FIG. 67 shows a plan view of a ramp segment 602 of folding ramp 601. FIG. 68 shows a bottom view of a position-fixing ramp segment 617 of folding ramp 601. Each folding ramp 601 preferably comprises six ramp segments 602, as shown. Preferred dimensions for each type of ramp segment are provided, as shown. Note that in the preferred embodiment of FIG. 66, pivotal couplers 604 comprise alternating (up/down) orientations. Two of the pivotal couplers 604 within the series are not self-supporting and require a secondary means of stabilization to maintain the ramp in the preferred configuration of FIG. 66. To maintain folding ramp 601 in the preferred operable configuration, two of the six ramp segments 602 comprise position-fixing ramp segments 617, as shown. Preferably, position-fixing ramp segment 617 comprises an extendable coupler 614 used to supportively span a non-supporting joint to rigidly couple position-fixing ramp segment 617 to the adjacent ramp segment 602, as shown. Extendable coupler 614 preferably comprises a rigid member adapted to slide from center support 612 (of position-fixing ramp segments 617), to a receiver within center support 612 of the adjacent ramp segment 602. Extendable coupler 614 is preferably adapted to deploy essentially automatically, by the action of gravity, as folding ramp 601 is deployed. User accessible knob 614A, coupled with extendable coupler 614, is preferably provided to assist in manipulating extendable coupler 614 during retraction of the ramp.

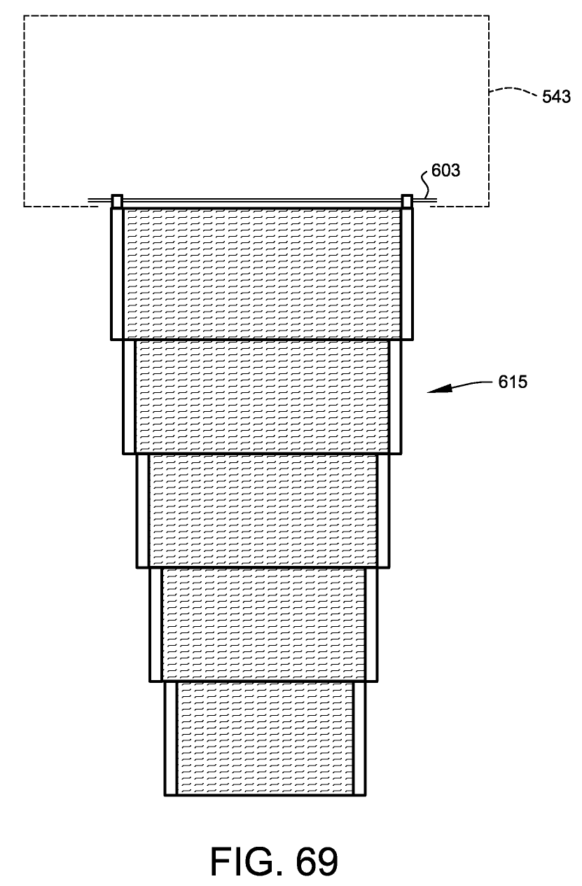

FIG. 69 shows a plan view of telescoping ramp 615 according to another preferred embodiment of the present invention. Preferably, telescoping ramp 615 comprises a plurality of nested panels that telescopically deploy to form the illustrated ramp. Telescoping ramp 615 is movably mounted within second storage section 543 in manner similar to the prior ramp embodiment (translating along linear guide rod 603), as shown. Telescoping ramp 615 is preferably configured to be fully stowable within second storage section 543. Preferably, telescoping ramp 615 is free to pivot about linear guide rod 603, allowing the nested ramp assembly to rotate upwardly out of second storage section 543 prior to telescopic deployment, as shown.

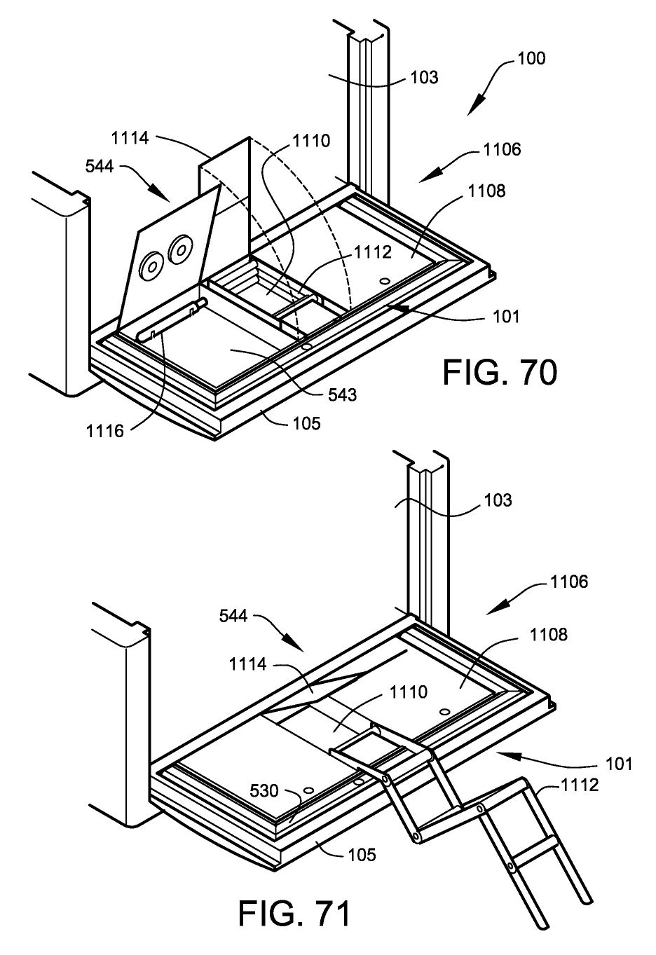

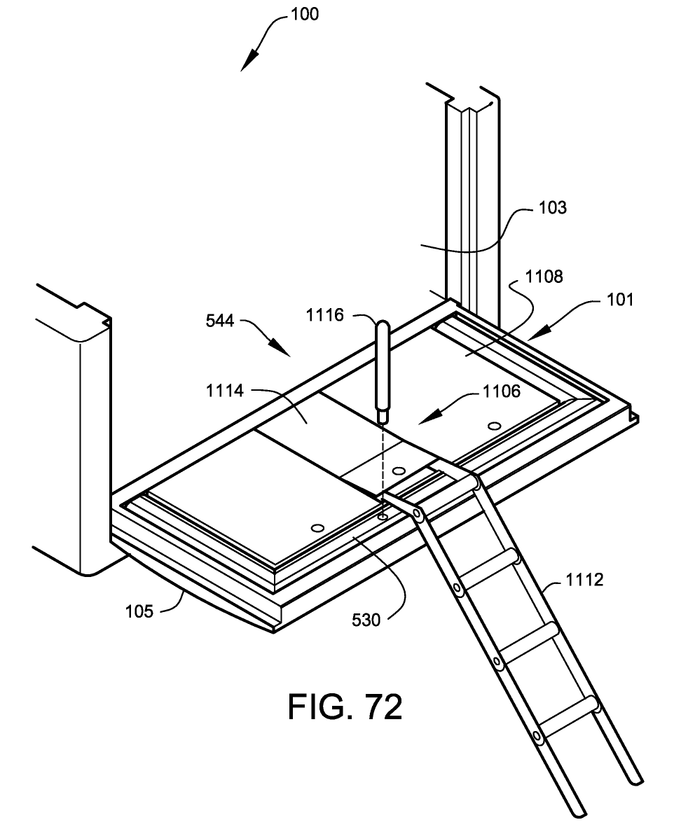

FIG. 70 shows a perspective view of foldaway ladder system 1106 of tailgate barrier system 100 according to preferred embodiments of the present invention. FIG. 71 shows a perspective view of foldaway ladder system 1106 of FIG. 70 in partial deployment. FIG. 72 shows a perspective view of foldaway ladder system 1106 of FIG. 70 in full deployment. Preferably, foldaway ladder system 1106 is adapted to provide assisted user access to the interior of cargo bed 103, as shown. Preferably, foldaway ladder 1112 of foldaway ladder system 1106 is adapted to fold for storage, preferably fitting within compartment 1110 of second storage section 543, as shown. Preferably, foldaway ladder 1112 is adapted to be deployable when barrier bar 530 is in the stowed position, as shown. Preferably, foldaway ladder 1112 comprises two articulated support rails joined by a plurality of horizontal steps, as shown. A set of hinged segments preferably allows the support rails to interfold, as shown. Preferably, foldaway ladder 1112 is adapted to unfold from second storage section 543 (as best shown in FIG. 71) and lock into the unfolded configuration of FIG. 72. Preferably, hinged cover 1114 of storage cover assembly 544 functions to cover compartment 1110 after the deployment of foldaway ladder 1112, as shown.

Preferably, foldaway ladder system 1106 comprises a removable grab post 1116 adapted to mount to barrier bar 530, as shown. Preferably, grab post 1116 is adapted to assist a user in safely traversing foldaway ladder 1112 by providing a raised grab-point near the top of the ladder, as shown. Upon reading the teachings of this specification, those of ordinary skill in the art will now understand that, under appropriate circumstances, considering such issues as user preference, intended use, etc., other inclined access arrangements, such as folding ramps adapted to assist in the loading and unloading of wheeled vehicles, etc., may suffice.

FIG. 73 shows a perspective view of accessory group 1050 of tailgate barrier system 100 according to preferred embodiments of the present invention. Preferably, accessory group 1050 comprises a range of mountable accessories 1000 specifically adapted to interoperate with tailgate barrier system 100. Preferably, accessory group 1050 at least comprises cup holder 1052, small grille 1054, large grille 1056, attachable table 1058, water cooler support 1060, food storage cooler 1062, portable canopy 1064, umbrella 1066, air compressor 1068, electrical accessory 1070, and collapsible ladder rack 1072, as shown. Upon reading the teachings of this specification, those of ordinary skill in the art will now understand that, under appropriate circumstances, considering such issues as user preference, intended use, etc., special construction arrangements, such as, constructing most mountable accessories of the accessory group from planar panels joined by corner hinges thus allowing the accessory to fold flat for storage within a second storage section of the tailgate, etc., may suffice. In addition, substantially all of the mountable accessories 1000 of accessory group 1050 preferably comprise at least one of two interlocking engager devices used to mount the accessory to barrier bar 530, as described below.

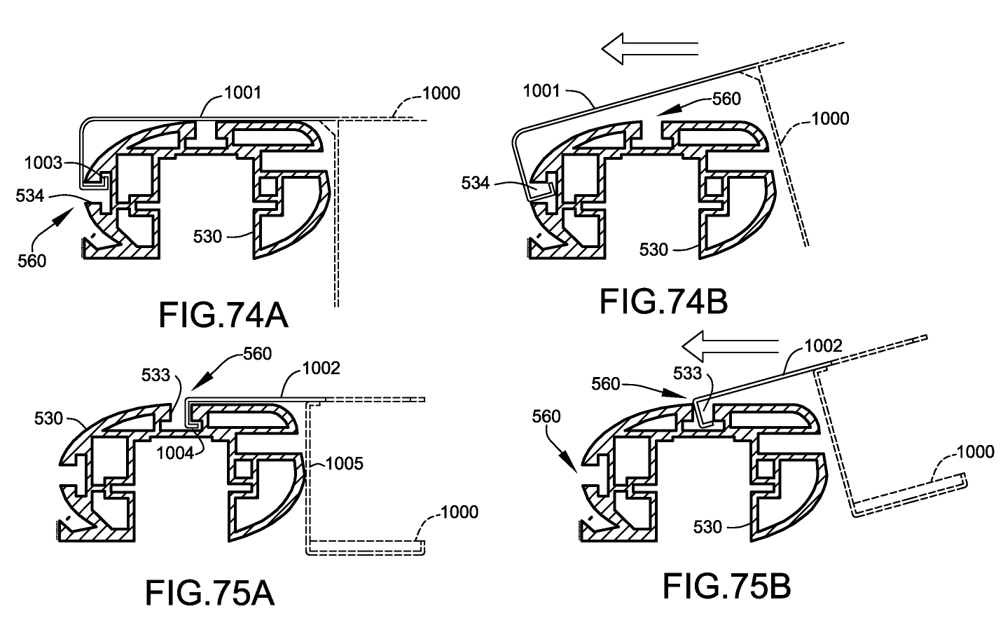

FIG. 74A shows a sectional view through barrier bar 530 illustrating a preferred first interlocking engager 1001 according to a preferred mounting embodiment of the present invention (at least embodying herein at least one interlocking engager structured and arranged to interlockably engage such at least one T-shaped-cross-section slot portion). FIG. 75A shows a sectional view through barrier bar 530 illustrating a preferred second interlocking engager 1002 according to another preferred mounting embodiment of the present invention (at least embodying herein at least one interlocking engager structured and arranged to interlockably engage such at least one T-shaped-cross-section slot portion). Preferably, both interlocking-engager types enable the removable mounting of one or more mountable accessories 1000 to barrier bar 530, as previously shown.

First interlocking engager 1001 preferably comprises a generally L-shaped bracket, as shown. Preferably, a first end of first interlocking engager 1001 comprises an upwardly projecting end extension 1003, as shown. The second end of first interlocking engager 1001 is preferably joined with at least one mountable accessory 1000. Preferably, end extension 1003 of first interlocking engager 1001 is adapted to engage the T-shaped slot 560 of leading channel 534, as shown. In the relational position of FIG. 74A, end extension 1003 is “interlocked” within the T-shaped profile of leading channel 534, as shown (at least embodying herein at least one first position of engagement within such at least one T-shaped-cross-section slot portion preventing removal of such at least one interlocking engager). In this interlocked position, first interlocking engager 1001 provides a secure load-bearing attachment to barrier bar 530.

FIG. 74B shows a sectional view through barrier bar 530 illustrating first interlocking engager 1001 rotated to a removable position (at least embodying herein at least one second position of engagement within such at least one T-shaped-cross-section slot portion allowing removal of such at least one interlocking engager). Preferably, first interlocking engager 1001 is disengaged from leading channel 534 by moving first interlocking engager 1001 to a position allowing the overall movement of the mounted assembly toward occupant cab 104A (indicated by the arrow depiction). Preferably, first interlocking engager 1001 is suitable for supporting moderate to heavy mountable accessories 1000, such as, for example, large grille 1056, attachable table 1058, water cooler support 1060, and food storage cooler 1062.

Second interlocking engager 1002 of FIG. 75A preferably comprises a generally L-shaped bracket, as shown. Preferably, a first end of second interlocking engager 1002 comprises a projecting end extension 1004, as shown. The second end of second interlocking engager 1002 is preferably joined with at least one mountable accessory 1000. Preferably, end extension 1004 of second interlocking engager 1002 is adapted to engage the T-shaped slot 560 of upper channel 533, as shown. In the relational position of FIG. 75A, end extension 1004 is “interlocked” within the T-shaped profile of upper channel 533, as shown (at least embodying herein at least one first position of engagement within such at least one T-shaped-cross-section slot portion preventing removal of such at least one interlocking engager). Preferably, mountable accessories 1000 (utilizing second interlocking engager 1002) comprise a vertical wall 1005 that rests against a trailing edge of barrier bar 530, as shown. In this interlocked position, second interlocking engager 1002 provides a secure load-bearing attachment to barrier bar 530.

FIG. 75B shows a sectional view through barrier bar 530 illustrating second interlocking engager 1002 rotated to a removable orientation (at least embodying herein at least one second position of engagement within such at least one T-shaped-cross-section slot portion allowing removal of such at least one interlocking engager). Preferably, second interlocking engager 1002 is disengaged from upper channel 533 by rotating second interlocking engager 1002 vertically toward occupant cab 104A (indicated by the arrow depiction). Preferably, second interlocking engager 1002 is suitable for supporting mountable accessories 1000 of light to moderate weight, such as, for example, cup holder 1052.

FIG. 76 shows a perspective view illustrating a preferred mountable accessory 1000, comprising cup holder 1052 utilizing second interlocking engager 1002.

FIG. 77 shows a perspective view of individual accessories of accessory group 1050, attached to barrier bar 530 of tailgate barrier assembly 101, according to a preferred embodiment of the present invention. Reference is now made to FIG. 77 with continued reference to the larger accessory group of FIG. 73. Tailgate barrier assembly 101 is shown integrated with tailgate 105 of truck 104. Preferably, the individual accessories of accessory group 1050 are adapted to interoperate with tailgate barrier system 100 by utilizing tailgate barrier assembly 101 as a means of support, as shown. In the present example, cup holder 1052, small grille 1054, attachable table 1058, and umbrella 1066 are each illustrated in a preferred supported position adjacent barrier bar 530. Preferably, cup holder 1052, small grille 1054, large grille 1056, attachable table 1058, water cooler support 1060, and food storage cooler 1062 are supported from barrier bar 530 by at least one first interlocking engager 1001 or second interlocking engager 1002, as shown. Accessories comprising significant weight are also preferably equipped with lower support strut 1076, as shown. Preferably, lower support struts 1076 are adapted transfer a portion of the weight of the accessory directly to tailgate 105 by rest on the peripheral edge of tailgate 105, as shown. Upon reading the teachings of this specification, those of ordinary skill in the art will now understand that, under appropriate circumstances, considering such issues as user preference, intended use, etc., other attachment arrangements, such as magnets, hook-and-loop fasteners, etc., may suffice.

Preferably, aperture 1078 (as best shown in the prior illustration of FIG. 6), allows vertical support structures of the accessories, such as stanchion 1080 of umbrella 1066 to pass through barrier bar 530, as shown.

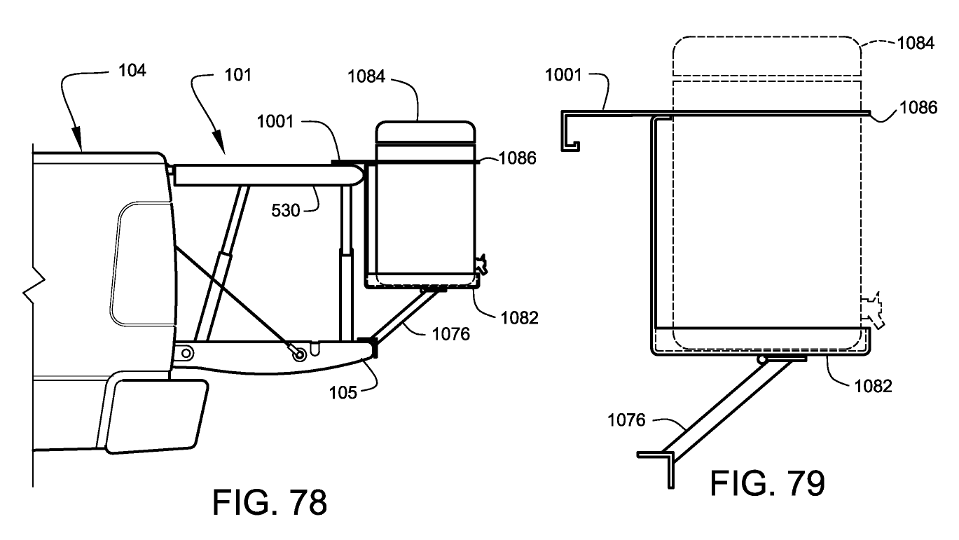

FIG. 78 shows a side view of an example accessory of the accessory group, comprising water cooler support 1060, mounted to the deployed tailgate barrier assembly 101 according to a preferred embodiment of the present invention. FIG. 79 shows a side view of water cooler support 1060 of FIG. 78. The illustrations of FIG. 78 and FIG. 79 provide examples enabling preferred support arrangements for a range of accessory embodiments of the present invention. Preferably, water cooler support 1060 comprises first interlocking engager 1001 coupled to supporting platform 1082, as shown. Preferably, supporting platform 1082 is adapted to support the base of a commercially available water cooler, preferably a cylindrical water cooler 1084 having at least a 5-gallon capacity. Water coolers suitable for use with water cooler support 1060 include those produced under the Igloo™ brand. Preferably, an apertured upper panel 1086 is adapted to surround water cooler 1084 to prevent overturning. Preferably, supporting platform 1082 is further supported by lower support strut 1076 engaging tailgate 105, as shown. Preferably, lower support strut 1076 is pivotally mounted to the underside of supporting platform 1082 and folds flat for compact storage.

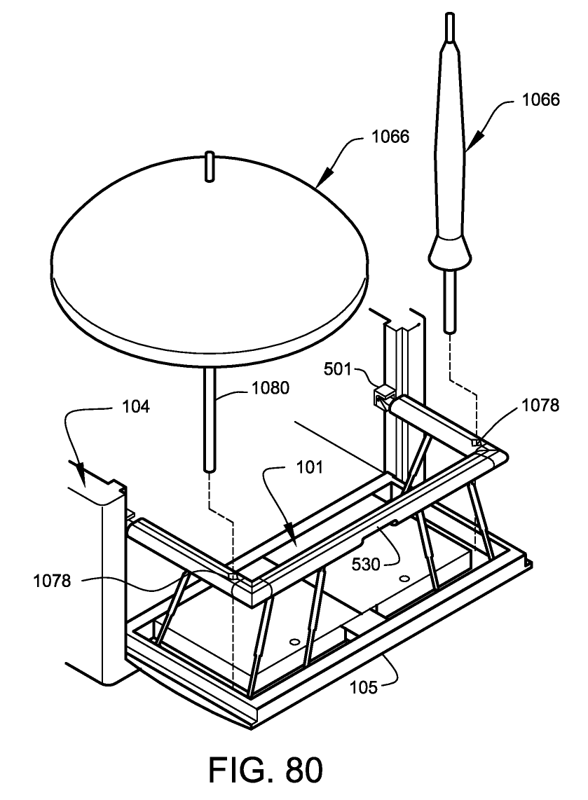

FIG. 80 shows a perspective view of umbrella 1066 of FIG. 77 adjacent the deployed tailgate barrier assembly 101 according to a preferred embodiment of the present invention. Accessory group 1050 preferably includes several shade-producing provisions, as shown. Barrier bar 530 is preferably adapted to receive one or two individual umbrellas 1066, as shown. It is noted that, upon reading the teachings of this specification, those of ordinary skill in the art will now understand that, under appropriate circumstances, considering such issues as user preference, intended use, etc., other umbrella arrangements, such as the accommodation of additional umbrellas, utilizing alternate mounting methods such as clamps, etc., may suffice. Preferably, umbrella 1066 is of a collapsible design known in the art, as shown, and may preferably comprise identifying indicia including advertising indicia (e.g., brand, team name or sponsor name, etc.).

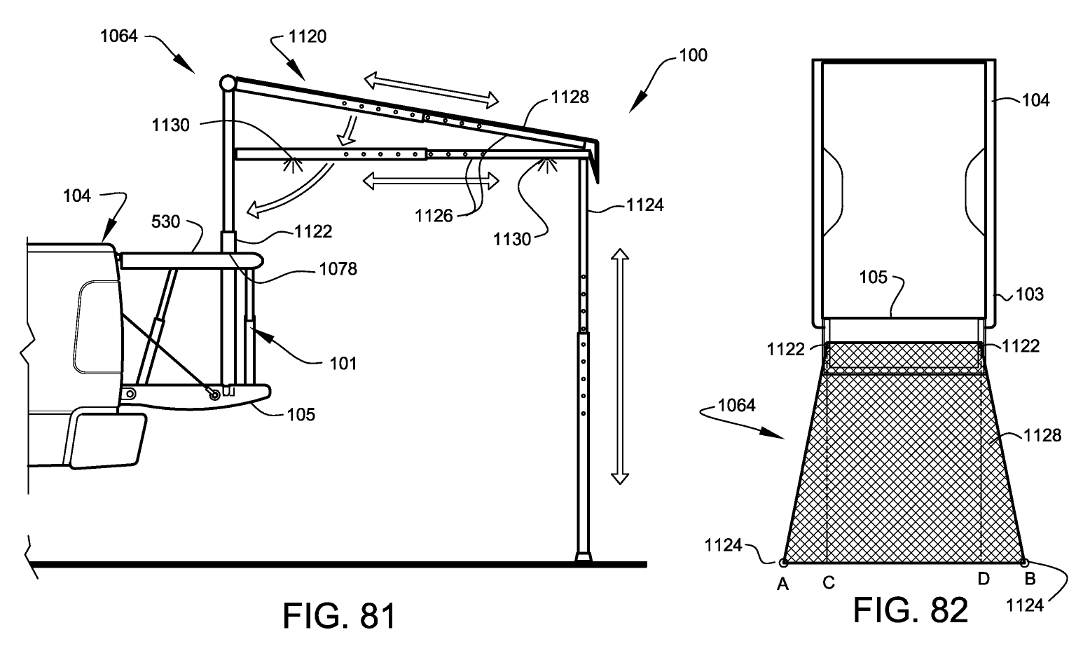

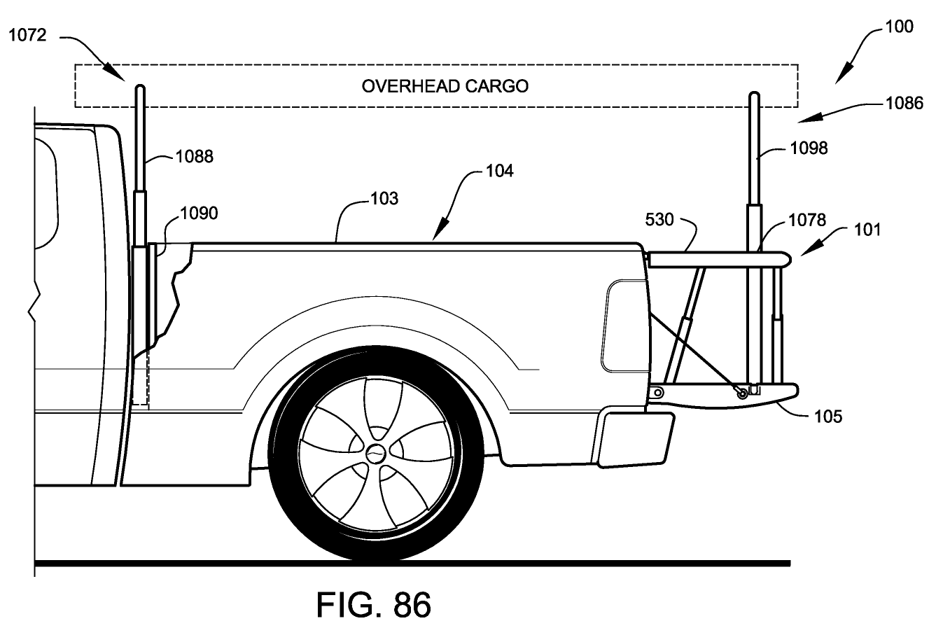

FIG. 81 shows a side view of a portable canopy 1064 identified herein as shade canopy 1120 mounted to truck 104 comprising a deployed tailgate barrier assembly 101 according to a preferred embodiment of the present invention. FIG. 82 shows a top view of shade canopy 1120 of FIG. 81. Preferably, shade canopy 1120 comprises two barrier-mounted stanchions 1122 and two ground mounted support posts 1124, as shown. Preferably, stanchions 1122 and support posts 1124 are adapted to support a framework of collapsible spreaders 1126, as shown. Preferably, the upper spreaders 1126 support shade fabric 1128 and are preferably pitched to assist in shedding water, as shown. Preferably, spreaders 1126 are adapted to collapse telescopically for storage, as shown. In addition, spreaders 1126 are pivotally mounted to stanchions 1122 in a manner similar to the arrangements described for the rear horizontal cargo supports 1098 and rear horizontal cargo support 1102 of collapsible ladder rack 1086 of FIG. 86. Preferably, stanchions 1122 are telescopically collapsible for storage, as shown. Preferably, shade fabric 1128 is adapted to roll into the upper spreader 1126 for storage. Preferably, support posts 1124 are telescopically adjustable to accommodate variations in ground elevation, as shown. Upon reading the teachings of this specification, those of ordinary skill in the art will now understand that, under appropriate circumstances, considering such issues as intended use, etc., other shade arrangements, such as, for example, providing a smaller shade structure, without the ground-mount support posts, utilizing tension cables in combination with rigid spreaders, etc., may suffice.

Preferably, shade canopy 1120 is configurable between a narrow footprint and an expanded footprint as best illustrated in the top view of FIG. 82. To assemble a wide footprint, support posts 1124 are set at positions A and B, as shown. Preferably, shade fabric 1128 comprises a trapezoidal-shaped panel to accommodate the expanded layout, as shown. Preferably, spreaders 1126 comprise length adjusters to allow the development of a proper spreader length, as shown. Preferably, to assemble a narrow shade footprint, support posts 1124 are set at positions C and D, as shown. Preferably, spreaders 1126 are adjustable to comprise a shorter spreader length, as shown. Preferably, the side wings of shade fabric 1128 are folded inward as required to generate a generally rectangular footprint. Upon reading the teachings of this specification, those of ordinary skill in the art will now understand that, under appropriate circumstances, considering such issues as intended use, etc., other shade fabric arrangements, such as, for example, alternate shapes, adapting the shade to include wind breaks, side walls, netting, enclosures, etc., may suffice.

Preferably, several structural support members of shade canopy 1120 comprise electrical components, more preferably illuminated electrical components adapted to provide local lighting, as shown. Most preferably, spreaders 1126 comprise permanently mounted low voltage lighting fixtures 1130, as shown. Most preferably, lighting fixtures 1130 comprise LED-based fixtures for superior durability, weight, and size integration. Preferably, electrical power for lighting fixtures 1130 is preferably supplied by an electrical connection at tailgate barrier assembly 101. Upon reading the teachings of this specification, those of ordinary skill in the art will now understand that, under appropriate circumstances, considering such issues as intended use, etc., other electrical provisions and arrangements, such as, for example, switches, support-mounted power outlets, mounts and connectors for audio/video components, etc., may suffice. Furthermore, upon reading the teachings of this specification, those of ordinary skill in the art will now understand that, under appropriate circumstances, considering such issues as intended use, etc., other electrical connection arrangements, such as, for example, energizing the support stanchions by the insertion into the tailgate assembly, etc., may suffice.

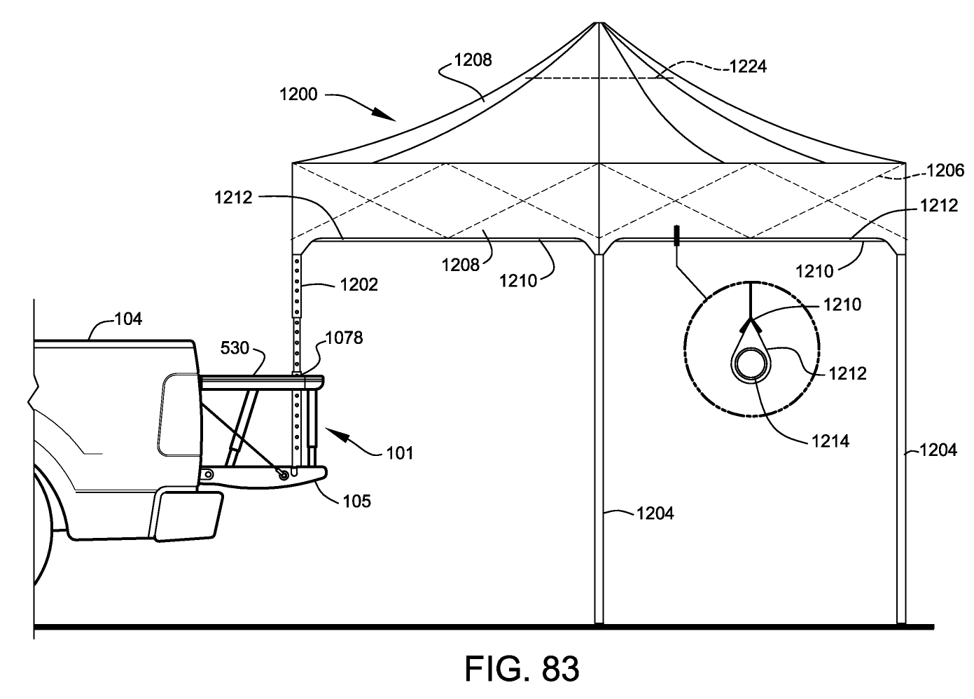

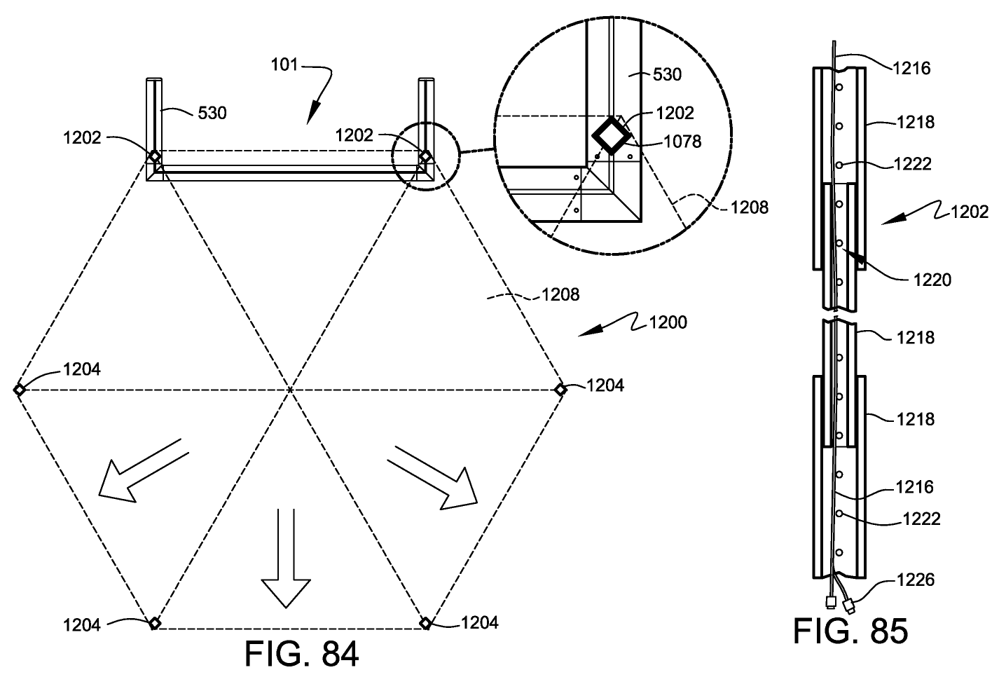

FIG. 83 shows a perspective view of an alternate shade canopy 1200, mounted to barrier bar 530 of tailgate barrier assembly 101, according to a preferred embodiment of the present invention. FIG. 84 shows a top view of the alternate shade canopy 1200 of FIG. 83. FIG. 85 shows a side view in partial section of an adjustable support strut 1202 of alternate shade canopy 1200 of FIG. 83.

Alternate shade canopy 1200 is shown in a preferred deployed configuration adjacent truck 104. Adjustable support strut 1202 of alternate shade canopy 1200 is preferably supported from tailgate barrier assembly 101 by engaging apertures 1078 of barrier bar 530, as shown.

Preferably, alternate shade canopy 1200 comprises a geometric layout having two barrier-mounted adjustable support struts 1202 and a plurality of ground mounted support posts 1204, as shown. Most preferably, alternate shade canopy 1200 comprises a hexagonal layout having two barrier-mounted adjustable support struts 1202 and four ground mounted support posts 1204, as shown. Preferably, adjustable support struts 1202 and ground mounted support posts 1204 are adapted to support a collapsible frame 1206, as shown. Preferably, the collapsible frame 1206 supports shade fabric 1208 and is adapted to collapse telescopically for storage. A canopy adaptable for use as alternate shade canopy 1200 includes products produced by KD Kanopy of Westminster Colo.

An unexpected advantage resulting from combination alternate shade canopy 1200 comprises the ability of a single individual to deploy alternate shade canopy 1200, preferably enabled by the rigid positioning of adjustable support struts 1202 while engages within barrier bar 530. Preferably, alternate shade canopy 1200 is deployed by first engaging the adjustable support struts 1202 within apertures 1078 of barrier bar 530, as shown. Adjustable support struts 1202 preferably comprise at least three telescoping sections 1218 with each section adapted to interlock using button lock arrangement 1220, as shown. Preferably, the button lock arrangement 1220 engages holes 1222 when telescoping sections 1218 extend upward and downward to form an appropriate strut length. Upon reading the teachings of this specification, those with ordinary skill in the art will now understand that, under appropriate circumstances, considering such issues as advances in technology, user preference, etc., other locking mechanisms, such as twist-locks, ratchets, clamps, multiple holes permitting multiple heights, etc., may suffice. A user preferably utilizes the immovable mounting of the two adjustable support struts to draw the free portions of alternate shade canopy 1200 (collapsible frame 1206) to the deployed configuration of FIG. 83.

Alternate shade canopy 1200 preferably comprises electrical components, more preferably a unique arrangement of illuminated electrical components adapted to provide local lighting, as shown. Preferably, a lower peripheral edge 1210 of shade fabric 1208 comprises at least one light permeable sleeve 1212 extending generally along the peripheral edge 1210, as shown. Preferably, light permeable sleeve 1212 internally supports at least one illuminated cable, preferably a low voltage rope light 1214 to provide at least one substantially continuous line of illumination along peripheral edge 1210, as shown. Preferably, light permeable sleeve 1212 comprises at least one fabric having at least one net-like weave. Preferably, both rope light 1214 and light permeable sleeve 1212 are substantially flexible allowing the overall assembly to fold to a compact configuration. Preferably, light permeable sleeve 1212 is permanently attached to peripheral edge 1210, preferably by mechanical sewing.

Upon reading the teachings of this specification, those of ordinary skill in the art will now understand that, under appropriate circumstances, considering such issues as intended use, etc., other mounting arrangements, such as, for example, providing a light permeable sleeve assembly with a removable fastener, to allow user locating, etc., may suffice. Flexible rope lighting suitable for use as rope light 1214 includes UL recognized, 12 Volt illuminated flexible rope having micro-tungsten bulbs spaced 1″ on centers, sheathed in clear or colored PVC resin tubing, as provided through Northwood Marine Services of Georgetown, Ky.

Electrical power is preferably supplied to rope light 1214 by electrical conductors 1216 routed within the hollow interior of an adjustable support strut 1202, as shown in FIG. 85. Preferably, electrical power transferred by electrical conductors 1216 is supplied at a plug and socket connector (preferably comprising a male plug and a female socket) located within first storage section 520 of tailgate barrier assembly 101.

Preferably, alternate shade canopy 1200 further comprises at least one integral antenna apparatus 1224 structured and arranged to receive and transmit electromagnetic waves. Integral antenna apparatus 1224 is preferably supported within an elevated portion of collapsible frame 1206, as shown. Integral antenna apparatus 1224 preferably comprises at least one electric coupler 1226 structured and arranged to couple antenna apparatus 1224 to at least one antenna-using device. Electric coupler 1226 is preferably routed along with electrical conductors 1216 and preferably terminates a coupling point located within first storage section 520 of tailgate barrier assembly 101, as shown.

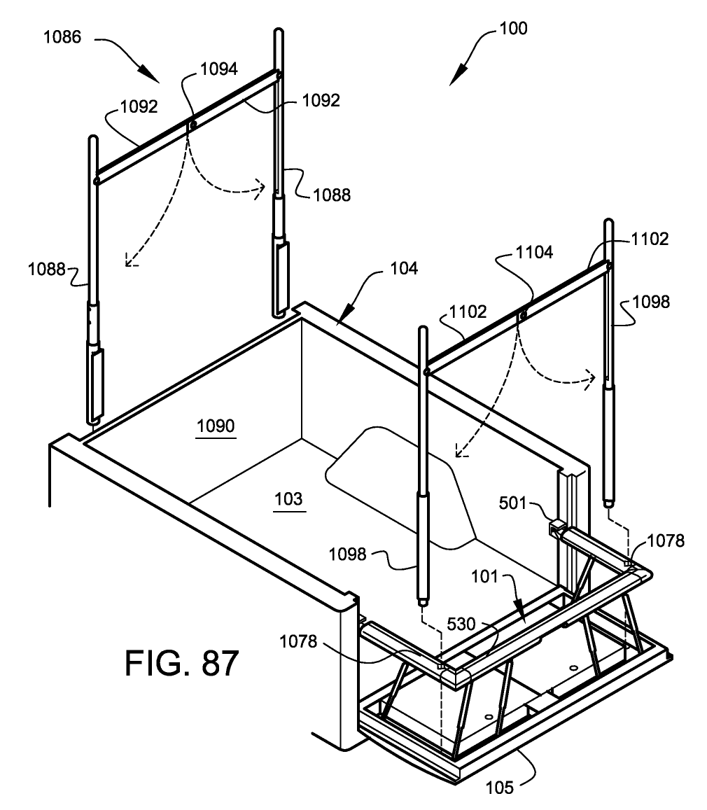

FIG. 86 shows a side view of collapsible ladder rack 1086 mounted to tailgate barrier assembly 101 of truck 104, as shown. FIG. 87 shows an exploded perspective view of collapsible ladder rack 1086 of FIG. 86. Preferably, collapsible ladder rack 1086 comprises four generally vertical supports adapted to support two generally horizontal cargo supports, as shown. Preferably, the leading supports, each identified herein as front collapsible post 1088, are permanently mounted to front bulkhead 1090 of cargo bed 103, as shown. Preferably, each front collapsible post 1088 telescopes downward to a fully stowed position behind front bulkhead 1090. Preferably, the upper segments of the front horizontal cargo supports 1088 are joined by a two-part horizontal cargo support identified herein as front horizontal cargo support 1092, as shown. Preferably, front horizontal cargo support 1092 is divided into two segments that are pivotally coupled to a respective front horizontal cargo support, as shown. A central retainer 1094 is adapted to rigidly maintain the positioning of each half-segments of front horizontal cargo support 1092 during use, as shown. On release of central retainer 1094, each portion of front horizontal cargo support 1092 preferably pivots into a storage slot located within its respective front collapsible post 1088, as shown.

Preferably, the trailing supports, each identified herein as rear collapsible post 1098, are removably mounted within an aperture 1078 of tailgate barrier assembly 101, as shown. Preferably, each rear collapsible post 1098 telescopes downward to form a relatively compact and stowable unit. Preferably, the upper segments of the rear horizontal cargo supports 1098 are joined by a two-part horizontal cargo support identified herein as rear horizontal cargo support 1102, as shown. Preferably, rear horizontal cargo support 1102 is divided into two segments that are pivotally coupled to a respective rear horizontal cargo support, as shown. A central retainer 1104 is adapted to rigidly maintain the positioning of each half-segments of rear horizontal cargo support 1102 during use, as shown. On release of central retainer 1104, each portion of rear horizontal cargo support 1102 preferably pivots into a storage slot located within its respective rear collapsible post 1098, as shown.

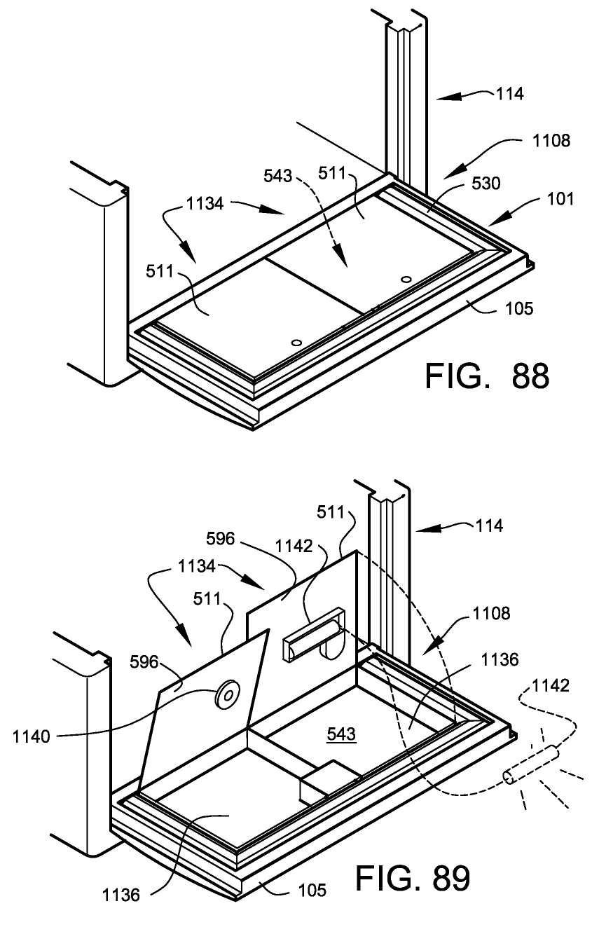

FIG. 88 shows a perspective view of a functionally enhanced second storage section 543 identified herein as multi-function storage box 1108 according to preferred embodiments of the present invention. FIG. 89 shows a perspective view of multi-function storage box 1108 of FIG. 88. Preferably, multi-function storage box 1108 comprises a single hinged storage cover 1172 (see FIG. 92) or a split cover 1134, as shown. Preferably, split cover 1134 provides at least two independently operable hinged cover panels 511, as shown. Preferably, each cover panel 511 functions to enclose divided storage compartment 1136 within multi-function storage box 1108, as shown. Preferably, each cover panel 511 comprises a lockable closure allowing independent locking of each divided storage compartment 1136. Upon reading the teachings of this specification, those of ordinary skill in the art will now understand that, under appropriate circumstances, considering such issues as intended use, etc., other divided compartment arrangements, such as, for example, providing more than the depicted two compartments, providing smaller access doors within a larger divided or undivided cover, etc., may suffice.

Inner cover panel 596 of cover panel 511 is preferably adapted to receive functional lighting elements, preferably LED area lights 1140 and extendable reel light 1142, as shown. Preferably, LED area lights 1140 are manually switchable and are preferably powered by the vehicle electrical system. Upon reading the teachings of this specification, those of ordinary skill in the art will now understand that, under appropriate circumstances, considering such issues as intended use, etc., other power arrangements, such as, for example, local battery power, solar power supplied by solar cells mounted to the upper surface of the split cover, etc., may suffice. Preferred electrical arrangements are further presented below.

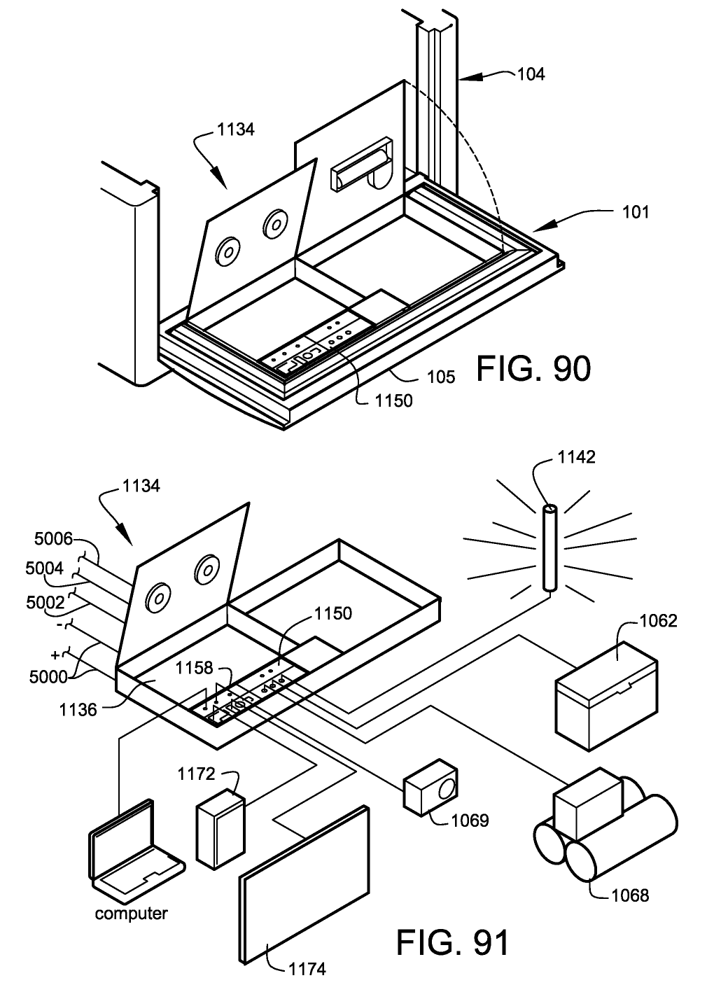

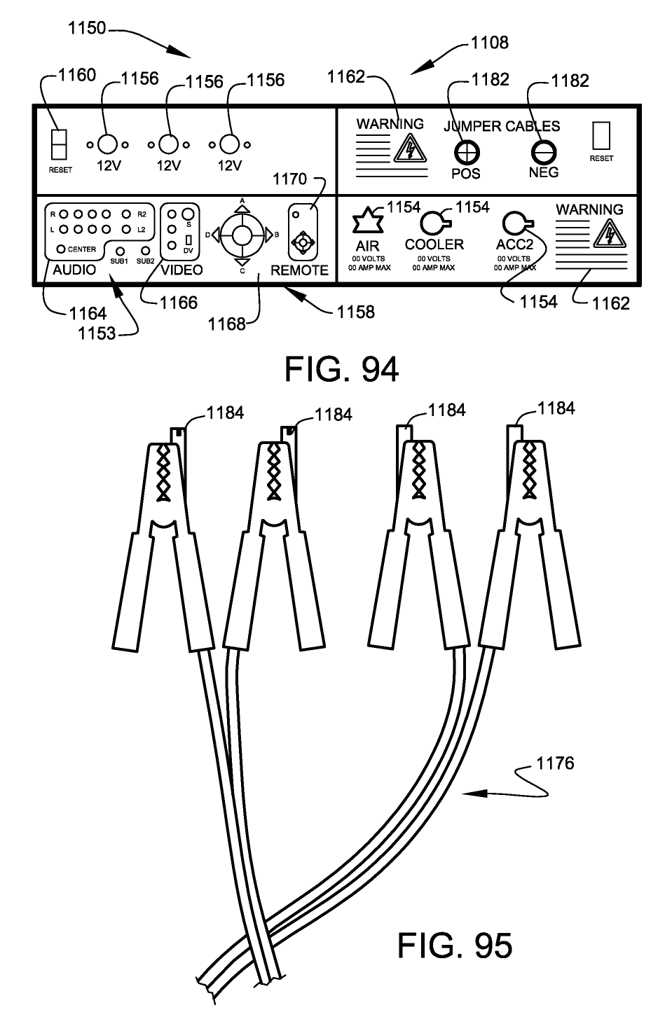

FIG. 90 shows a perspective view of accessory connector panel 1150 located within multi-function storage box 1108 of tailgate 105 according to preferred embodiments of the present invention. Preferably, accessory connector panel 1150 provides convenient point of electrical connection at the rear of the vehicle, as shown. Preferably, accessory connector panel 1150 comprises a weather protected and securable point of connection for power, audio, video, and data, as shown. Preferably, accessory connector panel 1150 comprises a grouping of both standard and proprietary connectors (see FIG. 94).

FIG. 91 shows a diagram illustrating a range of accessories connectable to accessory connector panel 1150 of FIG. 90. Preferred components of accessory group 1050, connectable to accessory connector panel 1150, include food storage cooler 1062, air compressor 1068, extendable reel light 1142, and similar powered devices 1169, as shown. Preferably, members of accessory group 1050, including food storage cooler 1062, air compressor 1068, and extendable reel light 1142, are adapted to comprise proprietary connectors 1154, as shown. Such proprietary connectors function to control the number and type of devices that are connectable to connector panel 1150, as shown. This preferred feature enhances safety of the system by matching the power output of connector panel 1150 two the current draw of the devices electrically coupled to connector panel 1150.

In addition, connector panel 1150 comprises audio and video outputs and controls 1158, as shown. Preferably, audio and video outputs and controls 1158 are adapted to operationally couple with A/V electronic devices including speakers 1172 and video panel 1174, as shown. Preferably, the above noted accessories and connections are electrically coupled to an appropriate electrical circuit of truck bed 104, preferably including electrical power circuit 5000 audio circuit 5002, video circuit 5004, and data circuit 5006, as shown.

Upon reading the teachings of this specification, those of ordinary skill in the art will now understand that, under appropriate circumstances, considering such issues as intended use, etc., other electronic connection arrangements, such as, for example, providing wireless computer data output connections, data connections providing information on the performance and operation of the vehicle, two-way radio communication connections, satellite data outputs including GPS data, etc., may suffice.

FIG. 92 shows a front view, in partial section, of video panel 1174 mounted to the interior face of a single hinged storage cover 1172 according to an alternate preferred embodiment of the present invention. Preferably, video panel 1174 comprises flat-panel electronic display such as an LCD video panel. Preferably, video panel 1174 is mechanically fastened to the interior face of storage cover 1172, allowing video panel 1174 to be raised and lowered with storage cover 1172. Video panel 1174 is preferably stored within second storage section 543 of tailgate 105 when not in use. A power-assisted actuator 1175 assists in raising and lowering storage cover 1172, as shown. Preferably, such power-assisted actuator 1175 comprises at least one controller to provide user control of the operation of the power-assisted actuator, preferably comprising at least one remote wireless interface. Upon reading the teachings of this specification, those with ordinary skill in the art will now understand that, under appropriate circumstances, considering issues such as vehicle type, user preference, etc., other hinged storage cover arrangements, such as, for example, adapting a hinged storage cover to support audio speakers, special-effects lighting, game boards, utensil holders, small access doors, keypads, transparent windows, fluid dispensers, cooking grills, etc., may suffice.

FIG. 93 shows a front view of a completed power box 594 within second storage section 543 of multi-function storage box 1108. Power box 594 of FIG. 93 preferably comprises a highly preferred arrangement of industry standard electrical couplers 1156, as shown. Power box 594 is preferably used in lieu of connector panel 1150 when a “basic” electrical embodiment is preferred. Power box 594 preferably provides a convenient source of electrical power within tailgate 105, as shown.

FIG. 93 also shows a preferred jumper-cable connector assembly 1230. Preferably, jumper-cable connector assembly 1230 comprises positive and negative connector posts 1232 adapted to provide electrical mounting points for standard electrical jumper cables comprising spring-actuated conductive clamps. Standard electrical jumper cables are preferably used to conduct electrical current from the electrical system (battery) of a first vehicle to the dead battery of another vehicle (a jump-start operation). Connector posts 1232 preferably project through apertures within the forward wall of second storage section 543, as shown. The positive connector post 1232, identified by “+” indicia, is electrically coupled to the positive side of the vehicle electrical system. Preferably, negative connector post 1232, identified by “−” indicia, is electrically coupled to the negative or grounded side of the vehicle electrical system. Electrical conductors servicing each connector post 1232 preferably comprises appropriate amperage capacities and safety enhancements including load breakers, fuses, etc. Preferably, each connector post 1232 comprises a removable insulative cover 1234, as shown.

FIG. 94 shows a front detail view of accessory connector panel 1150 of FIG. 90. Preferably, connector panel 1150 comprises at least one industry standard electrical coupler 1156, as shown. Preferably, connector panel 1150 comprises safety enhancements that preferably include load breakers 1160, fuses, etc. Preferably, connector panel 1150 further comprises informational and instructional indicia 1162, as shown.

Preferably, audio and video outputs and controls 1158 comprise audio outputs 1164 (preferably industry-standard outputs such as RCA-type connectors), video outputs 1166 (preferably industry-standard outputs such as RGB composite, S-video, digital video, etc.), as shown. Preferably, audio outputs 1164 are coupled with the audio system of the vehicle. Similarly, video outputs 1166 are operationally coupled to the video system of the vehicle.

Preferably, connector panel 1150 comprises local controls 1168 adapted to provide local control of the audio and visual outputs of connector panel 1150. Preferably, local controls 1168 comprise both panel-mounted controls and wireless controls enabled by remote control unit 1170, as shown.

FIG. 95 shows a front view of multi-connector jumper-cable 1176 (embodying herein at least one jumper cable structured and arranged to transfer the electrical power from said at least one electrical coupler to assist jump-starting operations) according to preferred embodiments of the present invention. Reference is now made to FIG. 95 with continued reference to FIG. 94. Preferably, connector panel 1150 comprises a rear mounted jumper cable connector feature identified herein as jumper-cable connector block 1180. Preferably, jumper-cable connector block 1180 comprise proprietary positive and negative female connectors 1182 adapted to interoperate with a set of complementary male connectors 1184 located at multi-connector jumper-cable 1176, as shown. Preferably, each connector is both color coded and physically keyed to reduce the crossing of polarities during use. Preferably, female connectors 1182 are electrically coupled to the battery of truck 104. Preferably, female connectors 1182 are protected at the battery source and at connector panel 1150 by at least one voltage interrupter, preferably a breaker, adapted to trip on detecting an excessive draw of current.

Preferably, multi-connector jumper-cable 1176 is structured and arrange to substantially resemble a conventional set of vehicular jumper cables, as shown. Preferably, multi-connector jumper-cable 1176 comprises a modified set of spring-actuated clamps, as shown. Preferably, each spring-actuated clamp comprises a male connector 1184, as shown. This preferred arrangement allows multi-connector jumper-cable 1176 to function with jumper-cable connector block 1180, and apart from jumper-cable connector block 1180 (as to provide remote conventional battery-to-battery jumping). Upon reading the teachings of this specification, those of ordinary skill in the art will now understand that, under appropriate circumstances, considering such issues as intended use, etc., other panel arrangements, such as, for example, locating the connector panel at an alternate location within the vehicle, etc., may suffice.

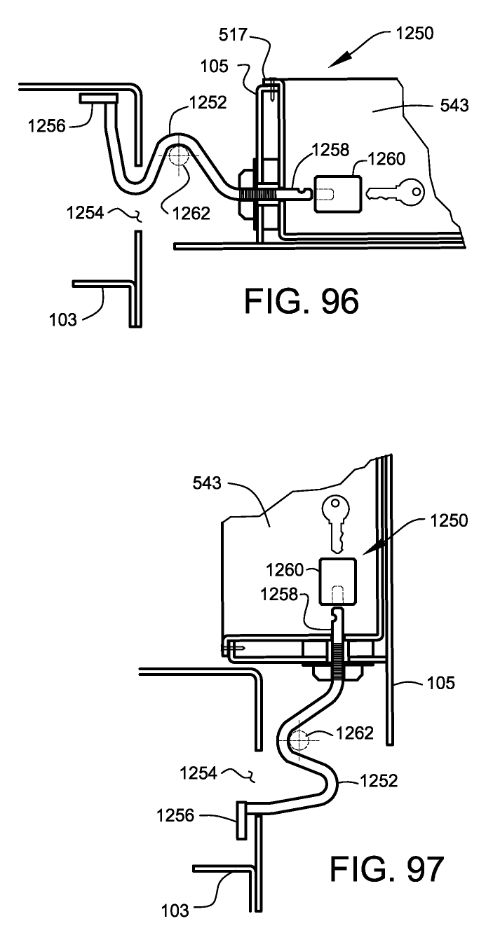

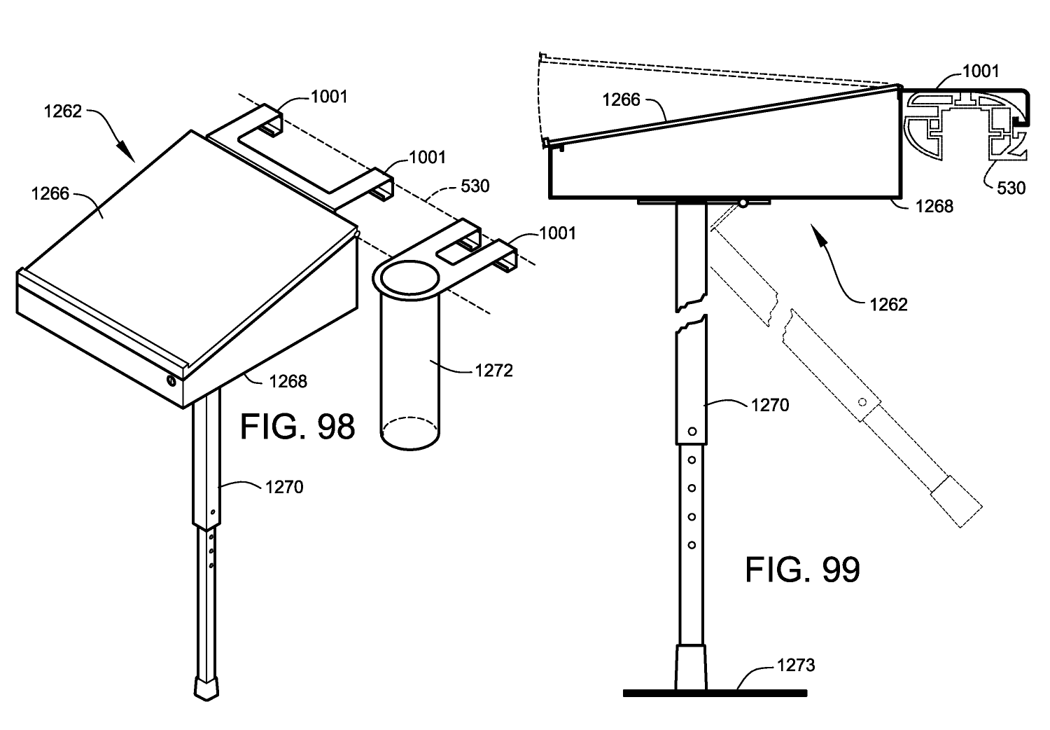

FIG. 96 and FIG. 97 show side views in partial section illustrating tailgate security system 1250 according to a preferred embodiment of the present invention. Tailgate security system 1250 preferably comprises a theft-deterrent device adapted to prevent unauthorized removal of tailgate 105 from cargo bed 103. Preferably, tailgate security system 1250 comprises a specially shaped linking bar 1252 extending from the interior of second storage section 543 through an aperture 1254 of cargo bed 103, as shown. Linking bar 1252 preferably comprises an enlarged end 1256, preferably located within cargo bed 103, as shown. Linking bar 1252 further comprises lock-securable end 1258, adapted to receive a user operable lock device 1260, as shown. Linking bar 1252 is preferably secured to tailgate 105 by the securing of lock device 1260 to lock-securable end 1258. Linking bar is preferably configured to allow free rotation of tailgate 105 about the conventional pivot point 1262 of tailgate 105, as shown. The configuration of linking bar illustrated in FIG. 97 and FIG. 98 prevents the passage of enlarged end 1256 through aperture 1254, regardless of the rotational orientation of tailgate 105, as shown. Lock device 1260 preferably comprises a post-engaging tubular-style lock utilizing a key, as shown.

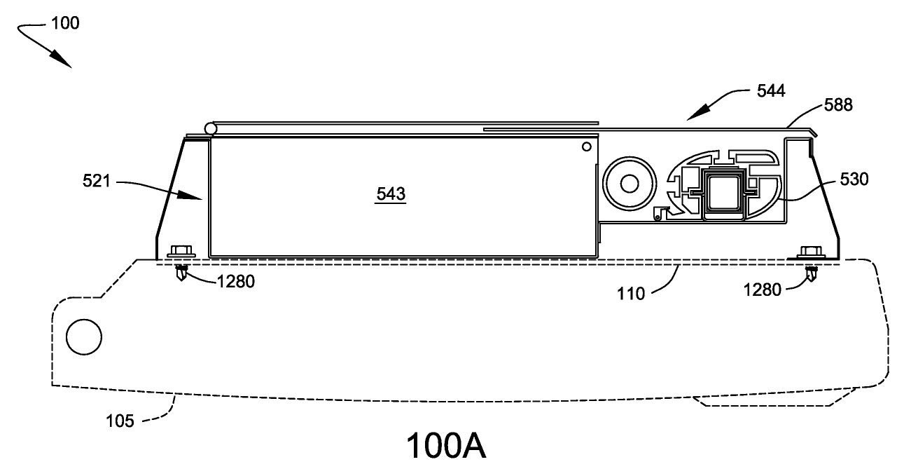

FIG. 98 shows a perspective view of a contractor's table assembly 1262, mountable to tailgate barrier system 100, according to a preferred embodiment of the present invention. FIG. 99 shows a sectional view through the section 99-99 of FIG. 98. Preferably, contractor's table assembly 1262 comprises a set of first interlocking engagers 1001 allowing the support of table unit 1264 on barrier bar 530. Preferably, table unit 1264 comprises upper work surface 1266 hinge-mounted to an underlying storage compartment 1268, as shown. Preferably, a lower support strut 1270 is provided to support table unit 1264 from the adjacent supporting ground surface 1273, as shown. Preferably, lower support strut 1270 comprises two telescoping sections allowing height adjustments between the underside of storage compartment 1268 and the adjacent supporting ground surface 1273, as shown. Preferably, lower support strut 1270 is pivotally mounted to the underside of storage compartment 1268 and folds flat for compact storage.

Contractor's table assembly 1262 further comprises rolled document holder 1272, as shown. Rolled document holder 1272 preferably comprises a hollow cylindrical housing, having a partially closed bottom end and a substantially open upper end, as shown. A first interlocking engager 1001 is mounted to the housing to allow rolled document holder 1272 to be supported from barrier bar 530. Rolled document holder 1272 is preferably designed to support rolled-up or folded-over documents, such as large-format (30″×42″) rolled construction drawings. Preferably, the rolled drawings are inserted into the interior of the cylindrical housing where they are protectively supported near table unit 1264.

Upon reading the teachings of this specification, those of ordinary skill in the art will now understand that, under appropriate circumstances, considering such issues as intended use, etc., other accessory arrangements, such as, for example, embodiments comprising hunting aides, such as gun racks, fishing pole racks, game dressing supports, scales, measurement aids, scope supports, etc., may suffice.

FIG. 100A shows a side view in partial section illustrating a preferred surface-mounted embodiment of tailgate barrier system 100. Tailgate barrier system 100 comprises at least two preferred mounting positions adjacent cab-facing external surface 110. The first preferred mounting arrangement (depicted in FIG. 1A) places tailgate barrier assembly 101 substantially within interior cavity 108 of tailgate 105, as shown (at least embodying herein at least one inner cavity). A second preferred mounting arrangement, as illustrated in FIG. 100, comprises a surface mounted embodiment adapted to externally mount to cab-facing external surface 110, as shown. In both mounting arrangements, storage-housing assembly 521 is secured to tailgate 105 using removable fasteners 1280, as shown.

FIG. 100B shows a front view of accessory cross bar 570, according to the preferred embodiment of FIG. 49. FIG. 100C shows the sectional view 100C-100C of FIG. 100B. Preferably, tailgate barrier assembly 101 of tailgate barrier system 100 further comprises accessory cross bar 570, as shown. Preferably, accessory cross bar 570 comprises at least one first bar coupler 572 adapted to couple accessory cross bar 570 to a first extendable support 540, and at least one second bar coupler 574 adapted to couple accessory cross bar 570 to at least one second extendable support 540, as shown (see also FIG. 49). Preferably, first bar coupler 572 and second bar coupler 574 comprise at least one link 576 adapted to link first bar coupler 572 and second bar coupler 574, as shown. Thus, accessory cross bar 570 preferably functions to assist positioning of long cargo 102 during transport. Preferably, accessory cross bar 570 is especially useful in supporting cargo of extended length such as pipes, stick lumber, etc. Preferably, first bar coupler 572 and second bar coupler 574 each comprise a clamping assembly 578, preferably adapted to adjustably clamp first bar coupler 572 and second bar coupler 574 to a respective telescoping section 555, as shown. Preferably, clamping assembly 578 comprises a deformable sleeve sized to fit over telescoping sections 555, as shown. Preferably, a threaded tightener 584 is used to compress (deform) clamping assembly 578 about telescoping section 555, as shown.

Preferably, first bar coupler 572 and second bar coupler 574 are pivotally mounted to link 576 at pivots 580, as shown. Preferably, link 576 is constructed using a pair of telescoping sections 582, preferably comprising interfitting tubes, preferably square tube members that allow the length of link 576 to be slidably adjusted, as shown.

FIG. 101A shows a perspective view illustrating another preferred embodiment of tailgate barrier system 100 according to the present invention. FIG. 101B shows a perspective view illustrating a tailgate extender system, according to the preferred embodiment of FIG. 101A, with hidden areas illustrated.

Preferably, tailgate barrier system 100 comprises tailgate extender 2101, as shown. Preferably, tailgate barrier system 100 comprises tailgate 105, as shown, which is preferably hingedly installed on a truck 104, as shown. Preferably, tailgate extender 2101 is adapted to be retractably stored within tailgate 105, as shown. Preferably, tailgate barrier system 100 is provided to consumers either as a feature originally installed on a truck 104 by the truck manufacturer, or as an aftermarket replacement tailgate 105 with tailgate extender 2101. Upon reading the teachings of this specification, those with ordinary skill in the art will now understand that, under appropriate circumstances, considering such issues as advances in technology, user preference, etc., other arrangements, such as providing a tailgate extender kit for installation in an existing tailgate, providing tailgate extender systems for other types of vehicles, etc., may suffice.

Preferably, tailgate 105 comprises internal surface 2110, external surface 2115, and storage compartment 2120, as shown. Preferably, internal surface 2115 is the surface of tailgate 105 that faces the interior of the truck 104 bed when tailgate 105 is closed, and which faces upwards then tailgate 105 is open, as shown. Preferably, external surface 2115 is the surface of tailgate 105 that faces the exterior of the truck 104 when tailgate 105 is closed, and which faces downwards then tailgate 105 is open, as shown. Preferably, storage compartment 2120 is situated between internal surface 2110 and external surface 2115, as shown. Preferably, storage compartment 2120 is open to and accessible through only internal surface 2110, as shown.

Preferably, tailgate extender 2101 comprises rail 2130 and supports 2140, as shown. Preferably, rail 2130 is a strong, preferably continuous, rail adapted to restrain cargo. Preferably, supports 2140 are strong, collapsible supports adapted to raise and lower rail 2130 from within storage compartment 2120, as shown. Preferably, supports 2140 are also adapted to restrain cargo. Preferably, tailgate extender 2101 collapses to store entirely within storage compartment 2120, as shown, and raises up to at least one settable height, preferably approximately the height of the sidewalls of truck 104, as shown, when in use. Preferably, tailgate extender 2101 is adjacent at least a portion of the rear perimeter 106 of tailgate 105, as shown. Upon reading the teachings of this specification, those with ordinary skill in the art will now understand that, under appropriate circumstances, considering such issues as advances in technology, user preference, etc., other arrangements, such as multi-part rails, the tailgate extender extending above the tailgate internal surface in storage, other heights, multiple adjustable heights, etc., may suffice.

Preferably, tailgate extender 2101 is constructed of strong, durable material, preferably metal, most preferably steel. Upon reading the teachings of this specification, those with ordinary skill in the art will now understand that, under appropriate circumstances, considering such issues as advances in technology, user preference, etc., other materials, such as plastic, composite materials, wood, ceramics, combinations of materials, etc., may suffice.

Preferably, rail 2130 comprises gap rails 2132, as shown. Preferably, gap rails 2132 slidingly extend from within rail 2130 to bridge the gaps between rail 2130 and the sidewalls of truck 104, as shown. Upon reading the teachings of this specification, those with ordinary skill in the art will now understand that, under appropriate circumstances, considering such issues as advances in technology, user preference, etc., other arrangements, such as gap rails that unfold from the rail, gap rails that attach to the truck, gap chains, etc., may suffice.

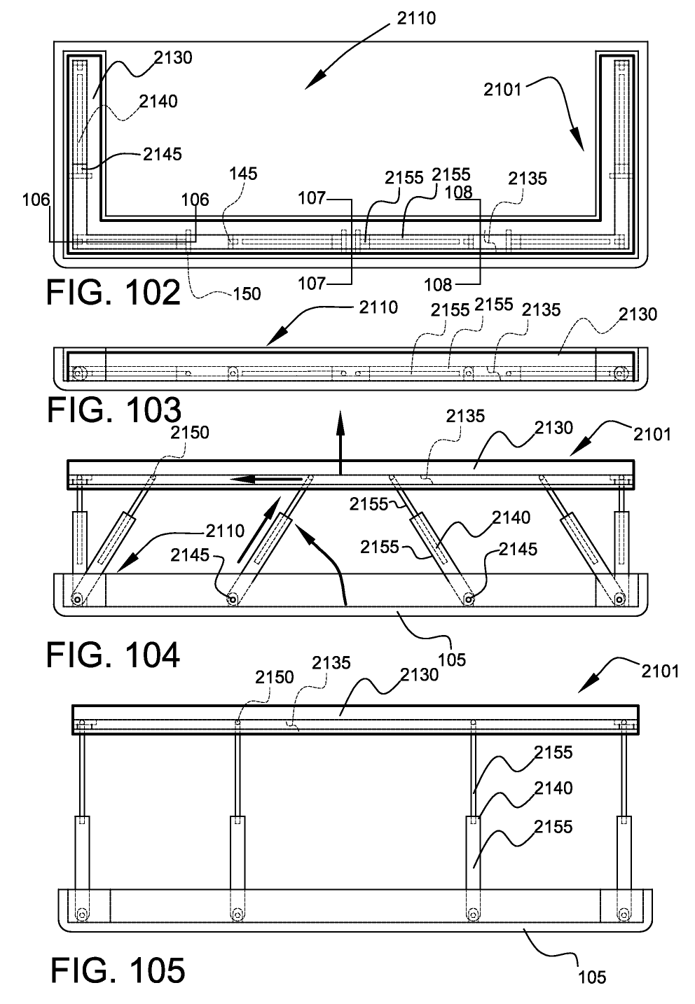

FIG. 102 shows a top view of tailgate extender 2101, according to the preferred embodiment of FIG. 101A, in a stowed position. Preferably, supports 2140 comprise hinge 2145, slider 2150, and at least two telescoping sections 2155, as shown. Preferably, rail 2130 comprises at least one channel 2135, as shown, along which slider 2150 slides when tailgate extender 2101 is being raised or lowered. Preferably, slider 2150 is wider than telescoping sections 2155, and is substantially the same width as channel 2135, as shown, so that slider 2150 may slide along the length of channel 2135 without becoming disengaged from channel 2135. Upon reading the teachings of this specification, those with ordinary skill in the art will now understand that, under appropriate circumstances, considering such issues as advances in technology, user preference, etc., other arrangements, such as bearings, other sliding arrangements, spring-loading the channel to provide lift assistance, motorized supports, actuated supports, hydraulic supports, scissors-type collapsible supports, accordion-type collapsible supports, etc., may suffice.

FIG. 103 shows a front view of tailgate extender 2101, according to the preferred embodiment of FIG. 101A, in a stowed position. Preferably, telescoping sections 2155 collapse, lay over parallel to internal surface 2110, and are recessed into rail 2130 and channel 2135 during storage, as shown. Upon reading the teachings of this specification, those with ordinary skill in the art will now understand that, under appropriate circumstances, considering such issues as advances in technology, user preference, etc., other arrangements, such as the slider being longer and angled so that the telescoping supports do not recess into the channel and/or the rail, etc., may suffice.

FIG. 104 shows a front view of tailgate extender 2101, according to the preferred embodiment of FIG. 101A, in a partially extended position. Preferably, to use tailgate extender 2101, tailgate 105 is lowered, and then rail 2130 is pulled up in translational motion perpendicular to internal surface 2110, which causes telescoping sections 2155 to extend and rotate angularly toward vertical as sliders 2150 slide along channel 2135, as shown. The directions of motion to raise tailgate extender 2101 for use are shown with arrows. Preferably, to return tailgate extender 2101 to storage, supports 2140 are unlocked, and then rail 2130 is lowered in translational motion perpendicular to internal surface 2110. The directions of motion to lower tailgate extender 2101 for storage are the opposite of the shown arrows. Upon reading the teachings of this specification, those with ordinary skill in the art will now understand that, under appropriate circumstances, considering such issues as advances in technology, user preference, etc., other component arrangements, such as multiple channels guiding multiple layers of supports, etc., may suffice.

FIG. 105 shows a front view of tailgate extender 2101, according to the preferred embodiment of FIG. 101A, in a fully extended position. Preferably, when telescoping sections 2155 are extended to their maximum height, telescoping sections 2155 lock into position and remain extended, as shown. Preferably, supports 2140 are substantially vertical, relative to open tailgate 105, when fully extended and ready for use, as shown. Upon reading the teachings of this specification, those with ordinary skill in the art will now understand that, under appropriate circumstances, considering such issues as advances in technology, user preference, etc., other arrangements, such as locking portions in the channel which releasably capture the sliders when the supports are fully vertical, multiple locking heights, continuously variable locking heights, the supports being independently lockable such that the rail may be held tilted at an angle, the supports locking at an angle during use, powered supports being held at an angle during use, etc., may suffice.

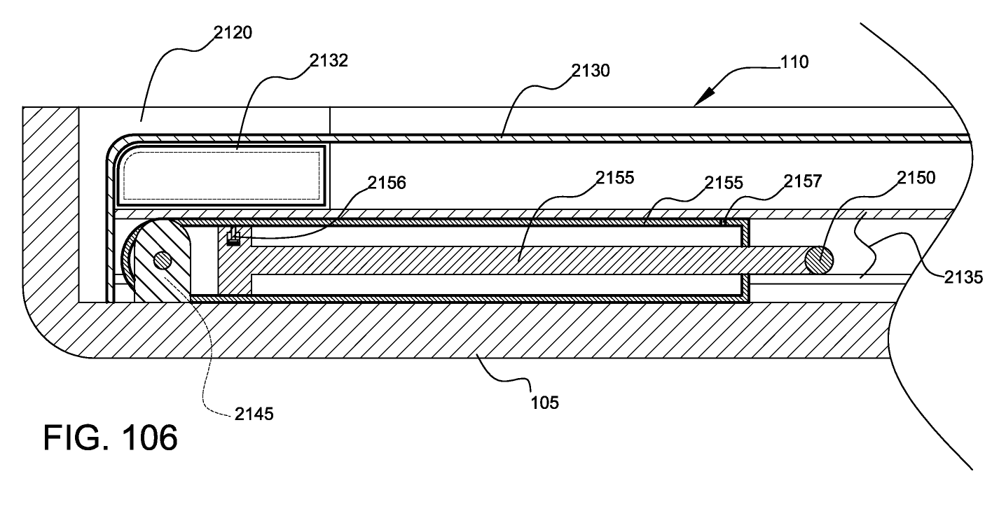

FIG. 106 shows the sectional view 106-106 of FIG. 102 according to the preferred embodiment of FIG. 101A. Preferably, telescoping sections 2155 lock with button lock 2156, as shown. Preferably, button lock 2156 engages hole 2157 when telescoping sections 2155 are fully extended. Upon reading the teachings of this specification, those with ordinary skill in the art will now understand that, under appropriate circumstances, considering such issues as advances in technology, user preference, etc., other locking mechanisms, such as twist-locks, ratchets, clamps, multiple holes permitting multiple heights, etc., may suffice.

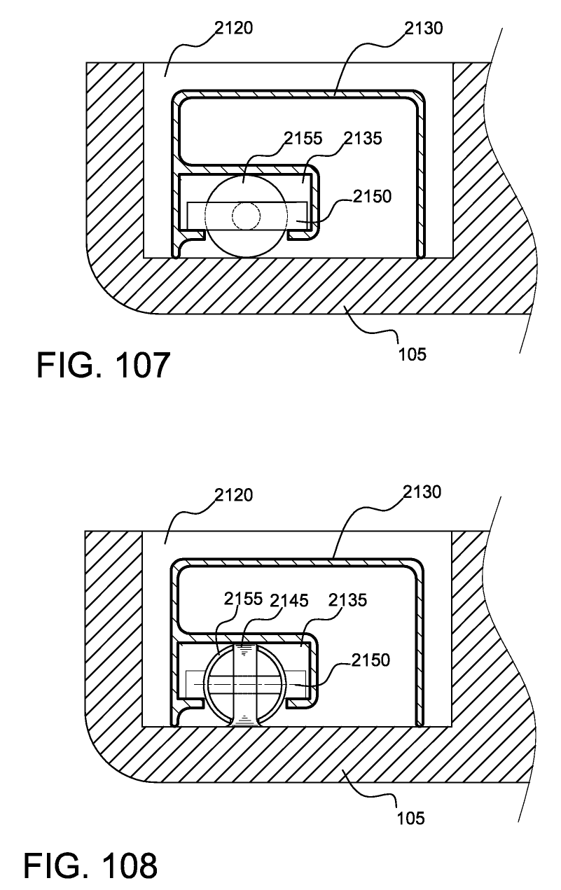

FIG. 107 shows the sectional view 107-107 of FIG. 102 according to the preferred embodiment of FIG. 101A. Preferably, slider 2150 is sized and shaped to be locked within channel 2135, as shown. Preferably, the opening into channel 2135 is wide enough, and the height of channel 2135 is high enough, to permit telescoping sections 2155 to nest within channel 2135 during storage, as shown.

FIG. 108 shows the sectional view 108-108 of FIG. 102 according to the preferred embodiment of FIG. 101A. Preferably, hinge 2145 is adapted to permit telescoping sections 2155 to pivot only substantially parallel to adjacent channel 2135, as shown.

Preferably, rail 2130 is of sufficient size and strength to withstand impact from cargo shifting in the cargo bed of truck 104. Preferably, rail 2130 has a cross section of sufficient size to contain channel 2135, as shown. More preferably, rail 2130 has a cross section of sufficient size to contain channel 2135, retractor 2205 (shown in DIAGS. 9-12), and/or gap rails 2132, as shown. Upon reading the teachings of this specification, those with ordinary skill in the art will now understand that, under appropriate circumstances, considering such issues as advances in technology, user preference, etc., other cross-sectional shapes, such as novelty shaped, shaped to match the theme of the truck, thin and flexible cable with no channel (instead threaded through the ends of the supports), etc., may suffice.

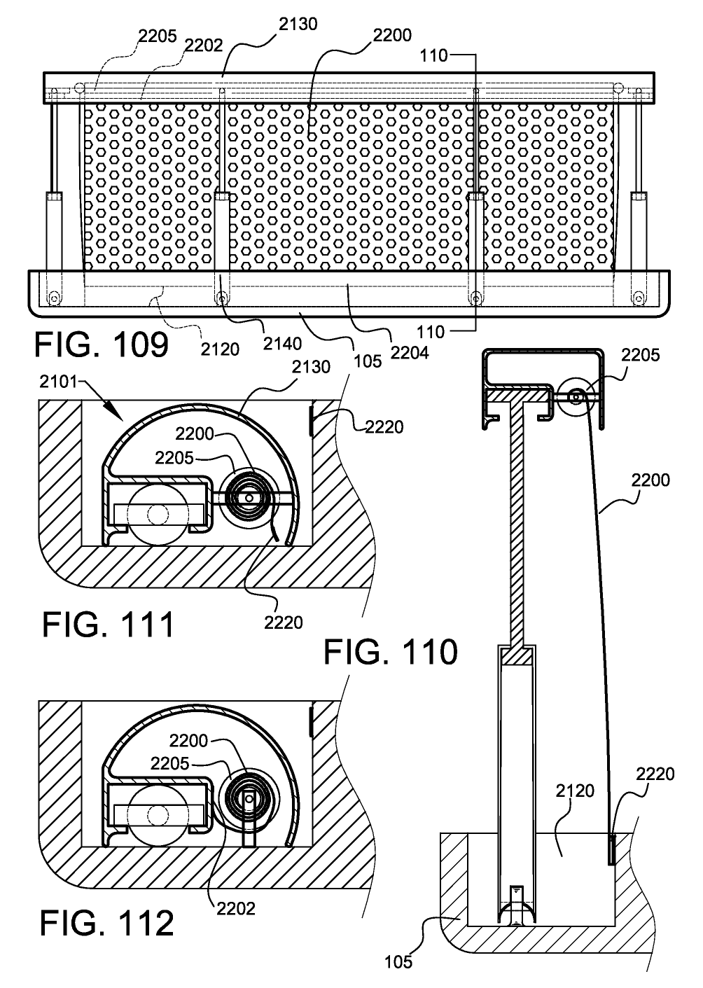

FIG. 109 shows a front view of tailgate extender 2101, according to the preferred embodiment of FIG. 101A, in a fully extended position, with cargo netting 2200. Preferably, cargo netting 2200 is used to prevent cargo from moving through the gaps between supports 2140. Preferably, cargo netting 2200 is attached to rail 2130 at the top edge 2202 of cargo netting 2200 and to tailgate 105 at the bottom edge 2204 of cargo netting 2200, as shown. Preferably, cargo netting 2200 is attached to retractor 2205 which is preferably installed within rail 2130, as shown. Preferably, retractor 2205 is a strong spring-loaded roller of the sort known in the art of retractable cargo-covers. Preferably, the bottom edge 2204 of cargo netting 2200 is attached to tailgate 105 inside storage compartment 2120. Preferably, cargo netting 2200 comprises strong plastic or fabric cargo netting of the sort known in the art. Upon reading the teachings of this specification, those with ordinary skill in the art will now understand that, under appropriate circumstances, considering such issues as advances in technology, user preference, etc., other arrangements, such as the retractor being installed on the exterior of the rail, a single cargo net covering an entire facet of the perimeter of the tailgate, cargo net retractors in the gap rails, other types of retractors, powered retractors, other cargo netting materials, such as metal, etc., may suffice.

FIG. 110 shows the sectional view 110-110 of FIG. 109. Preferably, cargo netting 2200 is attached to tailgate 105 inside storage compartment 2120 with attachers 2220, such as, for example, hook and loop fasteners, as shown. Upon reading the teachings of this specification, those with ordinary skill in the art will now understand that, under appropriate circumstances, considering such issues as advances in technology, user preference, etc., other attachers, such as hooks and grommets, snaps, magnets, clips, clamps, permanent attachment, etc., may suffice.

FIG. 111 shows a cross-sectional view of a stored tailgate extender 2101, with cargo net retractor 2205 in rail 2130. Preferably, tailgate extender 2101 is stored by first releasing cargo netting 2200 from attachers 2220, then retracting cargo netting 2200 onto retractor 2205, and then lowering tailgate extender 2101. Upon reading the teachings of this specification, those with ordinary skill in the art will now understand that, under appropriate circumstances, considering such issues as advances in technology, user preference, etc., other arrangements, such as the cargo netting being automatically retracted as the tailgate extender is lowered, etc., may suffice.

FIG. 112 shows a cross-sectional view of a stored tailgate extender 2101, with cargo net retractor 2205 in storage compartment 2120. Preferably, retractor 2205 is attached to storage compartment 2120, and the top edge 2202 of cargo netting 2120 is attached to rail 2130, as shown. Preferably, when tailgate extender 2101 is raised and lowered, cargo netting 2200 is automatically raised and lowered also. Upon reading the teachings of this specification, those with ordinary skill in the art will now understand that, under appropriate circumstances, considering such issues as advances in technology, user preference, etc., other arrangements, such as cargo netting adapted to fold accordion-style instead of rolling up, etc., may suffice.

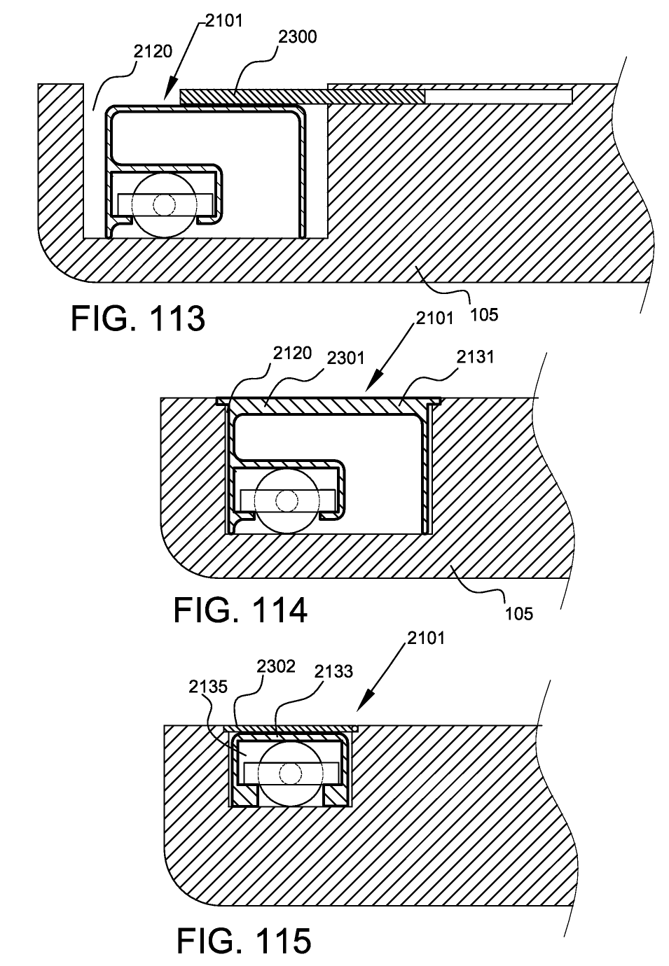

FIG. 113 shows a cross-sectional view of a stored tailgate extender 2101, similar to FIG. 107, with a retractable storage compartment cover 2300. Preferably, retractable storage compartment cover 2300 extends from inside tailgate 105, as shown, and covers storage compartment 2120 when tailgate extender 2101 is collapsed into storage compartment 2120. Preferably, retractable storage compartment cover 2300 creates a waterproof seal over storage compartment 2120 that protects tailgate extender 2101 from dirt and weather.

FIG. 114 shows a cross-sectional view of a stored tailgate extender 2101 with an integral storage compartment cover 2301. Preferably, rail 2130 comprises rail 2131, as shown. Preferably, rail 2131 seals against the edges of storage compartment 2120 to form an integral storage compartment cover 2301, as shown.

FIG. 115 shows a cross-sectional view of a stored tailgate extender 2101, with a small rail 2133, with a hinged storage compartment cover 2302. Preferably, hinged storage compartment cover 2302 creates a waterproof seal over storage compartment 2120 that protects tailgate extender 2101 from dirt and weather. Preferably, rail 2130 comprises rail 2133, as shown. Preferably, rail 2133 substantially comprises only channel 2135, as shown, providing a very compact design especially suitable for thin tailgates 105. Upon reading the teachings of this specification, those with ordinary skill in the art will now understand that, under appropriate circumstances, considering such issues as advances in technology, user preference, etc., other storage compartment covers, such as separate covers, other types of retractable covers, etc., may suffice.

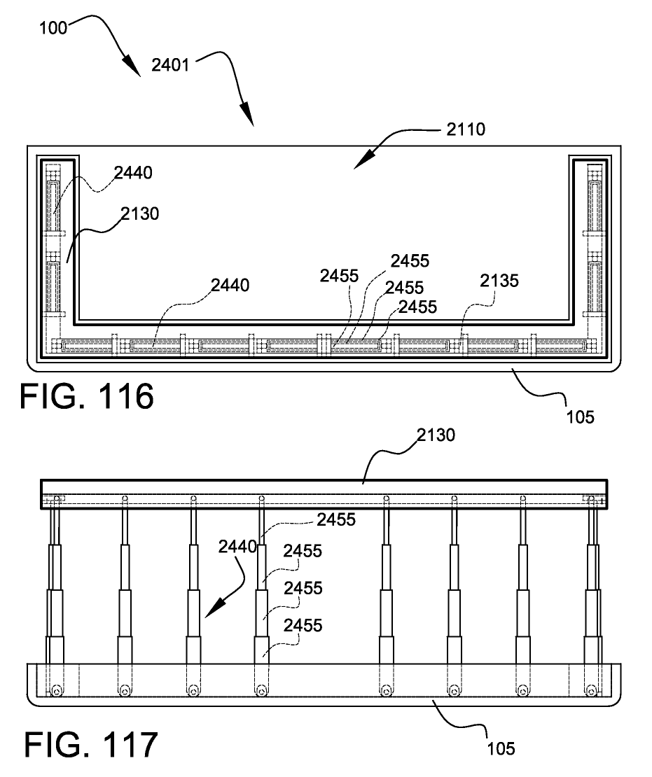

FIG. 116 shows a top view of a tailgate extender 2401, according to a preferred embodiment of the present invention, in a stowed position. Preferably, tailgate barrier system 100 comprises tailgate extender 2401, as shown. Preferably, the number of supports 2140 supporting tailgate extender 2401 may be increased by using supports 2440 with increased numbers of telescoping sections 2455, such as, for example, four telescoping sections 2455, as shown. This permits tailgate extender 2401 to be stronger, with narrower gaps between supports 2440. Upon reading the teachings of this specification, those with ordinary skill in the art will now understand that, under appropriate circumstances, considering such issues as advances in technology, user preference, intended use, etc., other numbers of supports, such as ten, twelve, seven, etc., may suffice. Upon reading the teachings of this specification, those with ordinary skill in the art will now understand that, under appropriate circumstances, considering such issues as advances in technology, user preference, intended use, etc., other numbers of telescoping sections, such as three, five, six, seven, ten, etc., may suffice.

FIG. 117 shows a front view of tailgate extender 2401, according to the preferred embodiment of FIG. 116, in a fully extended position. Preferably, tailgate extender 2401 stores, extends, and functions in the same way as tailgate extender 2101.

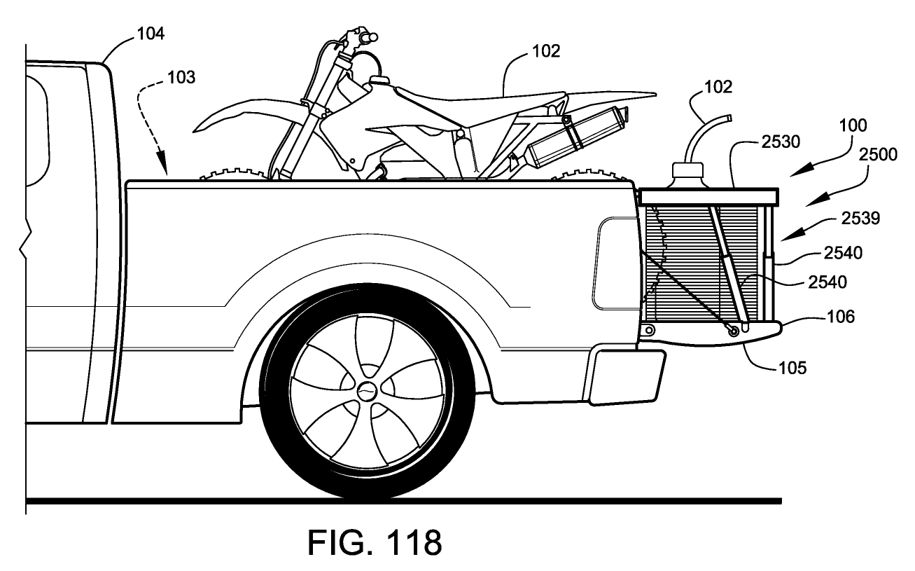

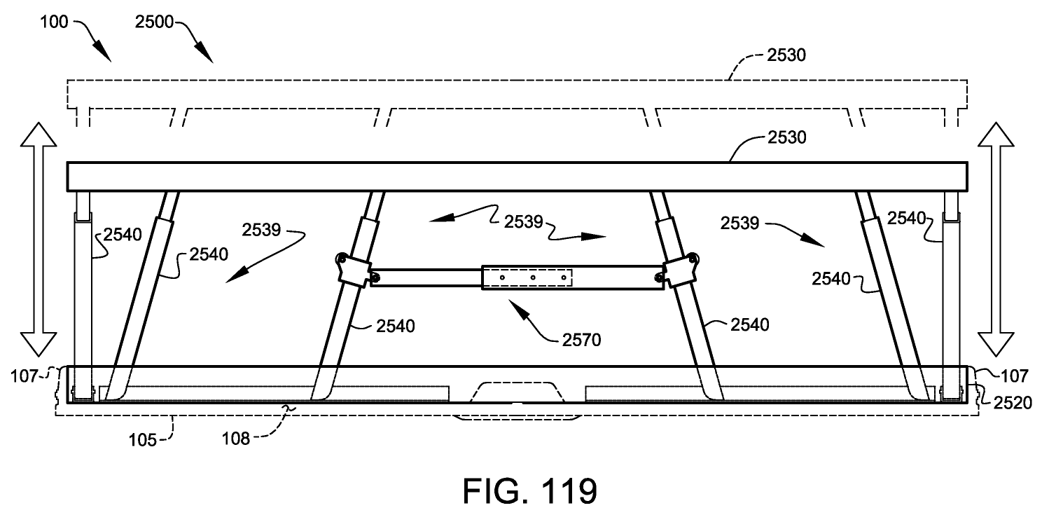

FIG. 118 shows a side view illustrating tailgate extender 2500 of tailgate barrier system 100 according to another preferred embodiment of the present invention. FIG. 119 shows a front view of tailgate extender 2500, according to the preferred embodiment of FIG. 118. FIG. 119 illustrates tailgate extender 2500 in a partially extended position.

As previously depicted, tailgate 105, is pivotally mounted on truck 104, as shown. Preferably, tailgate extender 2500 is adapted to be retractably stored within first storage compartment 2520, as shown. Preferably, first storage compartment 2520 is mounted substantially within interior cavity 2108 of tailgate 105 (see also FIG. 122).

Preferably, tailgate extender 2500 comprises barrier bar 2530 movably supported by arrangement of telescoping support bars identified herein as extendable support assembly 2539, as shown. Preferably, barrier bar 2530 comprises a substantially rigid, substantially continuous member, adapted to retain cargo 102 within cargo bed 103, as shown. Preferably, barrier bar 2530 is of sufficient size and strength to withstand impact from cargo shifting in the cargo bed of truck 104.

Preferably, extendable support assembly 2539 comprises a set of extendable supports 2540, as shown. Preferably, extendable supports 2540 comprise a set of length adjustable bars, adapted to raise and lower barrier bar 2530 along a substantially vertical path. In addition, extendable supports 2540 preferably function to assist in retaining cargo 102 within cargo bed 103, as shown. Preferably, tailgate extender 2500 is adapted to deploy to at least one user-settable height, as shown. Upon reading the teachings of this specification, those with ordinary skill in the art will now understand that, under appropriate circumstances, considering such issues as advances in technology, user preference, etc., other arrangements, such as multi-part rails, the tailgate extender extending above the tailgate internal surface in storage, other heights, multiple adjustable heights, etc., may suffice.

Preferably, barrier bar 2530, extendable supports 2540, and first storage compartment 2520 are constructed of at least one, preferably a combination of materials having an application-appropriate level of durability and weather resistance. Preferably, tailgate extender 2500 substantially comprises metal, most preferably steel and/or aluminum. Upon reading the teachings of this specification, those with ordinary skill in the art will now understand that, under appropriate circumstances, considering such issues as advances in technology, user preference, etc., other materials, such as plastic, composite materials, wood, ceramics, combinations of materials, etc., may suffice. For the example vehicle illustrated in FIG. 118, tailgate extender 2500 comprises a stowed size of about 60 inches length, about 20 inches width, and about 3½ inches depth.

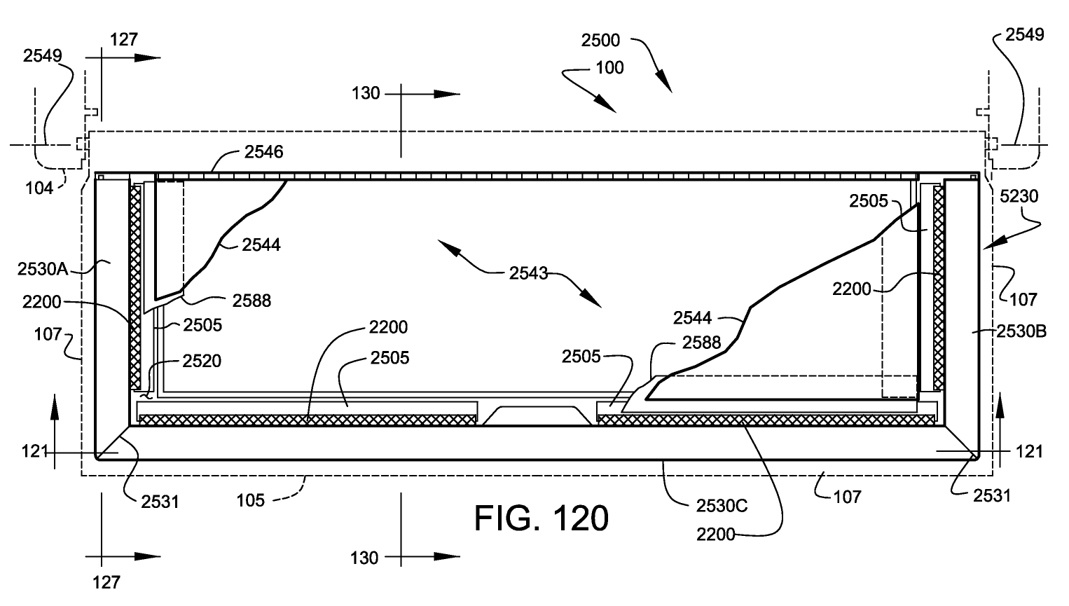

FIG. 120 shows a top view of the tailgate extender, according to the preferred embodiment of FIG. 118. Preferably, tailgate extender 2500 is installed adjacent to, preferably within, tailgate 105 (depicted by dashed lines). Preferably, tailgate extender 2500 is configured to form a fence-like barrier along at least one, more preferably, three of the perimeter edges 107 of tailgate 105, as shown. Preferably, barrier bar 2530 comprises first side-rail portion 2530A, second side-rail portion 2530B, and rear rail portion 2530C, as shown. Preferably, first side-rail portion 2530A, second side-rail portion 2530B, and rear rail portion 2530C are rigidly joined at intersecting corners 2531 forming a generally “U” shaped member, as shown. Preferably, the trough-like first storage compartment 2520 is similarly adapted to form a corresponding “U” shape, as shown.

Tailgate extender 2500 further comprises at least one second accessory storage area identified herein as second storage compartment 2543. Preferably, second storage compartment 2543 is situated adjacent first storage compartment 2520 generally between first side-rail portion 2530A, second side-rail portion 2530B, and rear rail portion 2530C, as shown. Preferably, second storage compartment 2543 is adapted to hold storable articles such as tools, small cargo items, emergency equipment, etc. Upon reading the teachings of this specification, those with ordinary skill in the art will now understand that, under appropriate circumstances, considering issues such as vehicle type, user preference, etc., other storage arrangements, such as, for example, adapting a secondary storage space to the storage of automatic gate actuators, motors, drives, audio speakers, audio amplifiers, video displays, etc., may suffice. Furthermore, those with ordinary skill in the art will now understand that, under appropriate circumstances, considering issues such as vehicle type, user preference, etc., other storage arrangements, such as, for example, equipping the secondary storage with tool holders, cargo restraints, storage clips, etc., may suffice. Preferably, second storage compartment 2543 comprises cover 2544 (illustrated in partial cut-away), preferably a securable (lockable) cover hingedly attached to second storage compartment 2543 at cover hinge 2546, as shown.

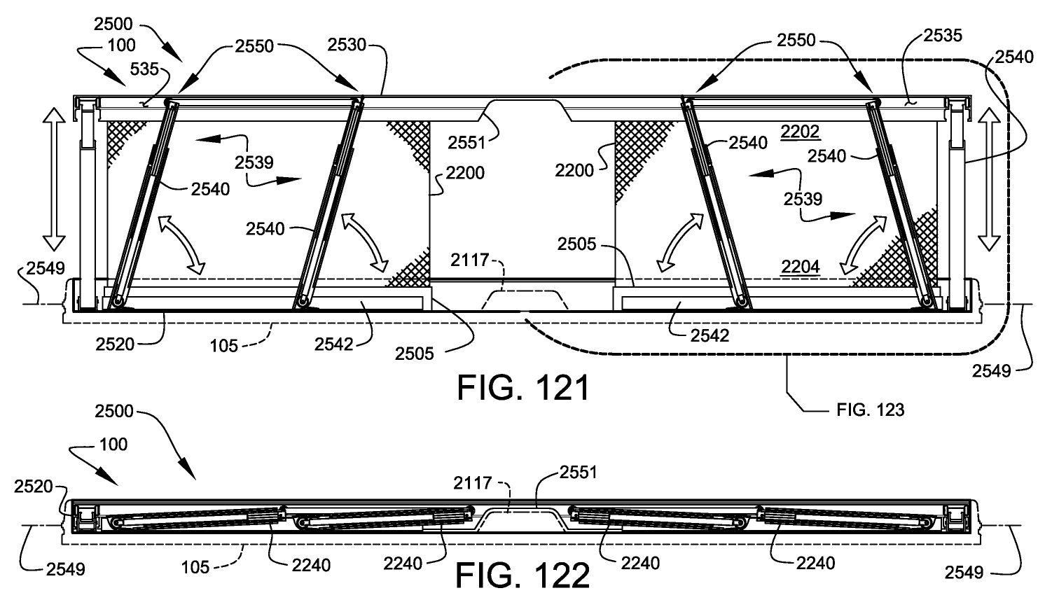

FIG. 121 shows the sectional view 121-121 of FIG. 120 illustrating tailgate extender 2500 in a partially extended (deployed) position. FIG. 122 shows the sectional view 122-122 of FIG. 120 illustrating tailgate extender 2500 in a stowed position. Preferably, tailgate extender 2500 is adapted to be stowable substantially entirely within first storage compartment 2520, as shown. Preferably, extendable supports 2540 are adapted to collapse and pivot to lie in a nearly horizontal position within base channel 2542, as shown. Preferably, base channel 2542 is firmly mounted to the floor of first storage compartment 2520, as shown. Upon reading the teachings of this specification, those with ordinary skill in the art will now understand that, under appropriate circumstances, considering such issues as advances in technology, user preference, etc., other arrangements, such as the slider being longer and angled so that the telescoping supports do not recess into the channel and/or the rail, etc., may suffice.

Preferably, to use tailgate extender 2500, tailgate 105 is lowered, and barrier bar 2530 is pulled in a translational motion substantially perpendicular to the pivot axis 2549 of tailgate 105, as shown. Preferably, such translational movement of barrier bar 2530 results in the telescopic lengthening of extendable supports 2540, as shown. Preferably, as extendable supports 2540 lengthen, they rotate angularly toward positions approaching perpendicular (relative to pivot axis 2549), as shown. Preferably, sliders 2550, coupled to extendable supports 2540, translate horizontally along the interior of internal channel 2535, thus allowing the angular rotation of extendable supports 2540, as shown. At a predetermined height, the movement of sliders 2550 are locked, thus fixing barrier bar 2530 in the deployed position. The directions of components motions in FIG. 121 are diagrammatically depicted with arrows.

Preferably, to return tailgate extender 2500 to the stowed arrangement of FIG. 122, extendable supports 2540 are unlocked, and barrier bar 2530 is lowered in a translational motion generally perpendicular to pivot axis 2549. The directions of motion to lower tailgate extender 2500 for storage are opposite of the arrow depictions of FIG. 121. Preferably, tailgate extender 2500 comprises cargo netting 2200, as shown. Preferably, cargo netting 2200 is used to prevent cargo from moving through the gaps between extendable supports 2540. Preferably, cargo netting 2200 is attached to barrier bar 2530 at the top edge 2202 of cargo netting 2200 and to retractor 2505 at the bottom edge 2204 of cargo netting 2200, as shown. Preferably, retractor 2505 is mounted within first storage compartment 2520, as shown. Preferably, retractor 2505 comprises a spring-loaded roller. Preferably, the bottom edge 2204 of cargo netting 2200 is attached to retractor 2505, as shown. Preferably, cargo netting 2200 comprises durable plastic or fabric cargo netting. Upon reading the teachings of this specification, those with ordinary skill in the art will now understand that, under appropriate circumstances, considering such issues as advances in technology, user preference, etc., other arrangements, such as the retractor being installed on the exterior of the storage compartment, a single cargo net covering an entire facet of the perimeter of the tailgate, cargo net retractors in the rail extenders, other types of retractors, powered retractors, other cargo netting materials, such as metallic fabric, etc., may suffice.

Preferably, barrier bar 2530 is adapted to lower fully into first storage compartment 2520 without interfering with the existing tailgate assemblies, such as, for example, factory gate release mechanism 2117 (indicated in dashed lines). To accommodate such existing structures, barrier bar 2530 is preferably modified with at least one clearance notch 2551, as shown. Depending on the manufacturer, make, and model of vehicle, barrier bar 2530 preferably comprises one or more clearance notches 2551, as shown. In the present embodiment, clearance notch 2551 is preferably used to provide barrier bar clearance at factory gate release mechanism 2117, as shown. Upon reading the teachings of this specification, those of ordinary skill in the art will now understand that, under appropriate circumstances, considering such issues as user preference, intended use, etc., other clearance accommodations, such as apertures, bends, offsets, recesses, etc., may suffice.

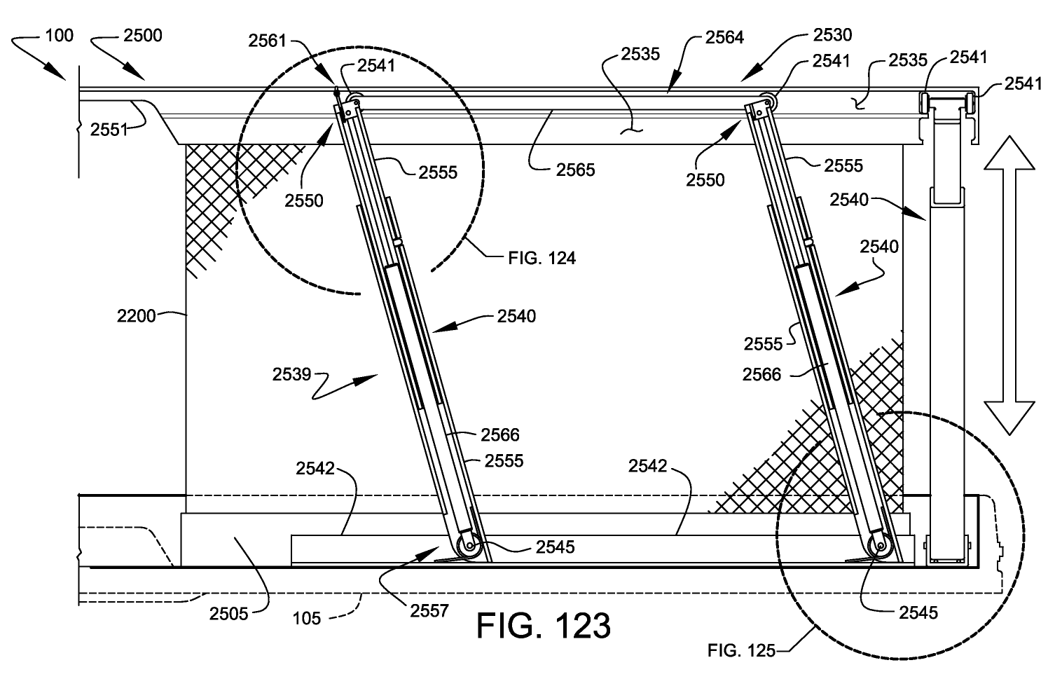

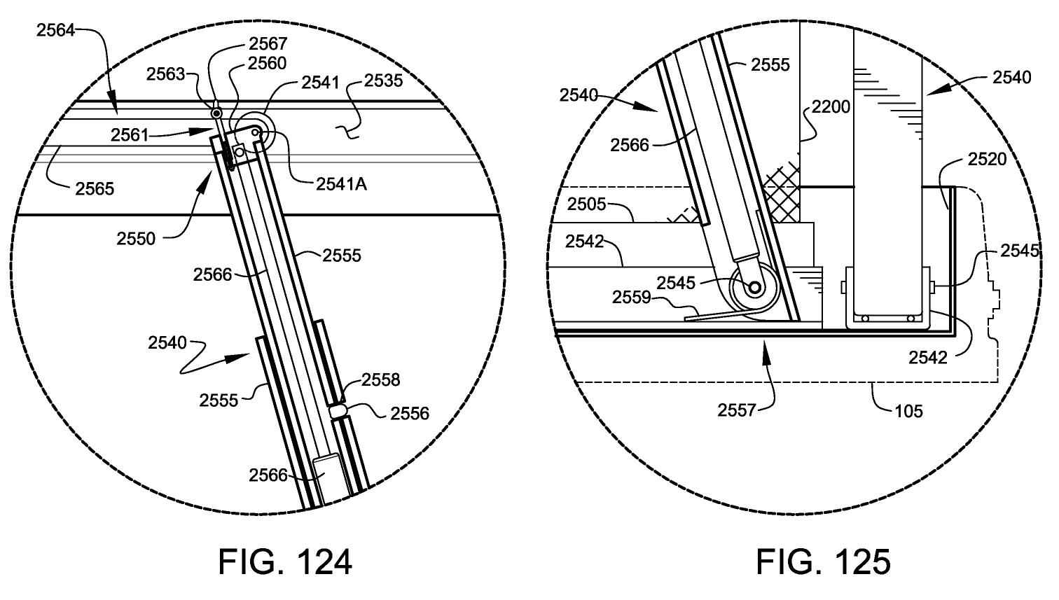

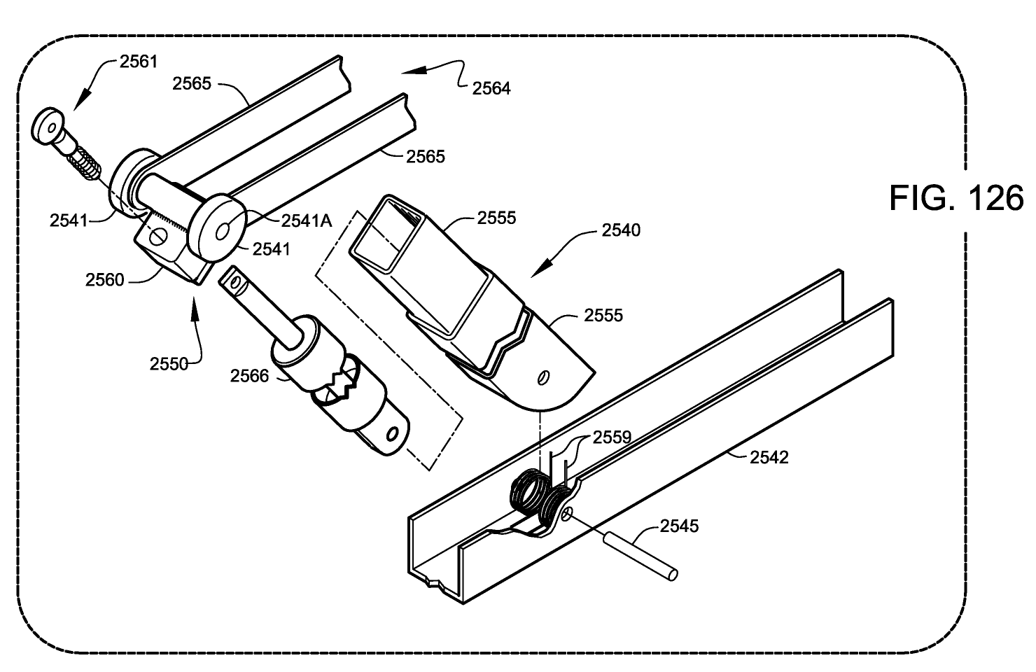

Reference is now made to FIG. 123, FIG. 124, FIG. 125, and FIG. 126 with continued reference to FIG. 119 and FIG. 120. FIG. 123 shows the detailed sectional view 123 of FIG. 121, FIG. 124 shows the detailed sectional view 124 of FIG. 123, FIG. 125 shows the detailed sectional view 125 of FIG. 123, and FIG. 126 shows an exploded detail of operable components of the tailgate extender.

Preferably, each extendable support 2540 is constructed using a pair of telescoping sections 2555, preferably comprising interfitting tubes, preferably square tube members, which permit the length of extendable support 2540 to be slidably adjusted for length, as shown. Preferably, extendable supports 2540 are adjustable to at least one pre-selected length (preferably corresponding to the height of the vehicle bed), as shown. Preferably, when extendable supports 2540 are extended to the preset length, telescoping sections 2555 releasably interlock into a fixed position and remain extended, as shown. During deployment, extendable supports 2540 preferably swings through a near 90-degree arc, as shown. Preferably, in the locked position, extendable supports 2540 are oriented near vertical, relative to open tailgate 105, when fully extended and ready for use, as shown. Preferably, the angular rotation of extendable supports 2540 is limited to less than 90-degrees relative to pivot axis 2549, as shown. This preferred limit of rotation arranges extendable supports 2540 to allow a smooth downward angular rotation of extendable supports 2540 during the lowering and stowing of tailgate extender 2500. Upon reading the teachings of this specification, those with ordinary skill in the art will now understand that, under appropriate circumstances, considering such issues as advances in technology, user preference, etc., other arrangements, such as locking portions in the channel which releasably capture the sliders when the supports are approaching vertical, multiple locking heights, continuously variable locking heights, the supports being independently lockable such that the rail may be held tilted at an angle, the supports locking at an angle during use, powered supports being held at an angle during use, etc., may suffice.

Preferably, the lower (proximal) ends of extendable supports 2540 are pivotally mounted within base channel 2542, as shown. Preferably, each extendable support 2540 is pivotally mounted within base channel 2542 at pivot 2545, as shown. Preferably, pivot 2545 is adapted to rotate extendable support 2540 with a single degree of freedom.

Preferably, each extendable support 2540 comprises at least one rotator 2557 adapted to generate at least one rotational force usable to assist in lifting extendable support 2540 during deployment, as shown. Preferably, rotator 2557 comprises at least one spring 2559, as shown. Spring 2559 is preferably positioned around pivot 2545, as shown. Preferably, spring 2559 is adapted to apply an opposing force to the interior of the adjacent telescoping section 2555 and at least one fixed element, preferably base channel 2542, as shown.

Preferably, barrier bar 2530 comprises at least one internal channel 2535, as shown, in which slider 2550 is movably captured. Preferably, slider 2550 is adapted to horizontally translate within channel 2535 as tailgate extender 2500 is raised or lowered. To assist slider 2550 in freely moving within channel 2535, slider 2550 preferably comprises at least one friction-reducing wheel 2541, most preferably a set of wheels 2541, as shown. Preferably, pairs of wheels 2541 are rotatably mounted to the distal end of extendable supports 2540 by end fixture 2560, as shown. Preferably, such pairs of wheels 2541 are spaced to fit within lower channel 2535 such that slider 2550 may slide along the length of lower channel 2535 without becoming disengaged from internal channel 2535. Upon reading the teachings of this specification, those with ordinary skill in the art will now understand that, under appropriate circumstances, considering such issues as advances in technology, user preference, etc., other arrangements, such as bearings, other sliding arrangements, motorized supports, actuated supports, hydraulic supports, scissors-type collapsible supports, accordion-type collapsible supports, etc., may suffice.

Preferably, at least one end fixture 2560 of slider 2550 comprises slide positioner 2561, as shown. Preferably, slide positioner 2561 is adapted to releasably fix the position of slider 2550 relative to barrier bar 2530, as shown. Preferably, slide positioner 2561 comprises a spring-loaded wheel adapted to roll along the upper interior surface of internal channel 2535. Preferably, lower channel 2535 is adapted to releasably capture slide positioner 2561 at a preset point and position, as shown. More specifically, preferably, lower channel 2535 is adapted to releasably capture slide positioner 2561 within channel recess 2563, as shown. Preferably, channel recess 2563 comprises at least one user accessible release button 2567 adapted to allow the user to release slide positioner 2561 from channel recess 2563.

Preferably, telescoping sections 2555 are interlock by button lock 2556, as shown. Preferably, button lock 2556 engages aperture 2558 when telescoping sections 2555 are fully extended. Upon reading the teachings of this specification, those with ordinary skill in the art will now understand that, under appropriate circumstances, considering such issues as advances in technology, user preference, etc., other locking mechanisms, such as twist-locks, ratchets, clamps, multiple holes permitting multiple heights, etc., may suffice. Furthermore, upon reading the teachings of this specification, those with ordinary skill in the art will now understand that, under appropriate circumstances, considering issues such as designer preference, cost, etc., other locking arrangements, such as, for example, combining the locking of extendable supports with the locking of sliders using a single point of user control, etc., may suffice.

Barrier rails 2530 of extended length (such as rear rail portion 2530C) preferably comprise multiple extendable supports 2540, as shown. It is preferred that adjacent sliders 2550 of extendable supports 2540 be coupled by coordinators 2564 to assist in coordinating the movement of multiple extendable supports 2540 during deployment and stowing, as shown. Preferably, coordinators 2564 comprise at least one coordinator bar 2565, preferably two coordinator bars 2565, rotatably engaged on wheel pivots 2541a of wheels 2541, as shown.

Preferably, each extendable supports 2540 comprises at least one telescopic assister, more preferably, at least one gas-charged spring 2566, as shown. Preferably, gas-charged spring 2566 is adapted to support, at least partially, the weight of the moving assemblies of tailgate extender 2500, thus assisting the user in raising and lowering barrier bar 2530. Preferably, gas-charged spring 2566 is located within telescoping sections 2555, as shown. Preferably, gas-charged spring 2566 is operably coupled to end fixture 2560 and pivot 2545, as shown. Preferred gas-charged spring assemblies suitable for use as gas-charged spring 2566 are available from the SUSPA Corporation (www.suspa-inc.com).

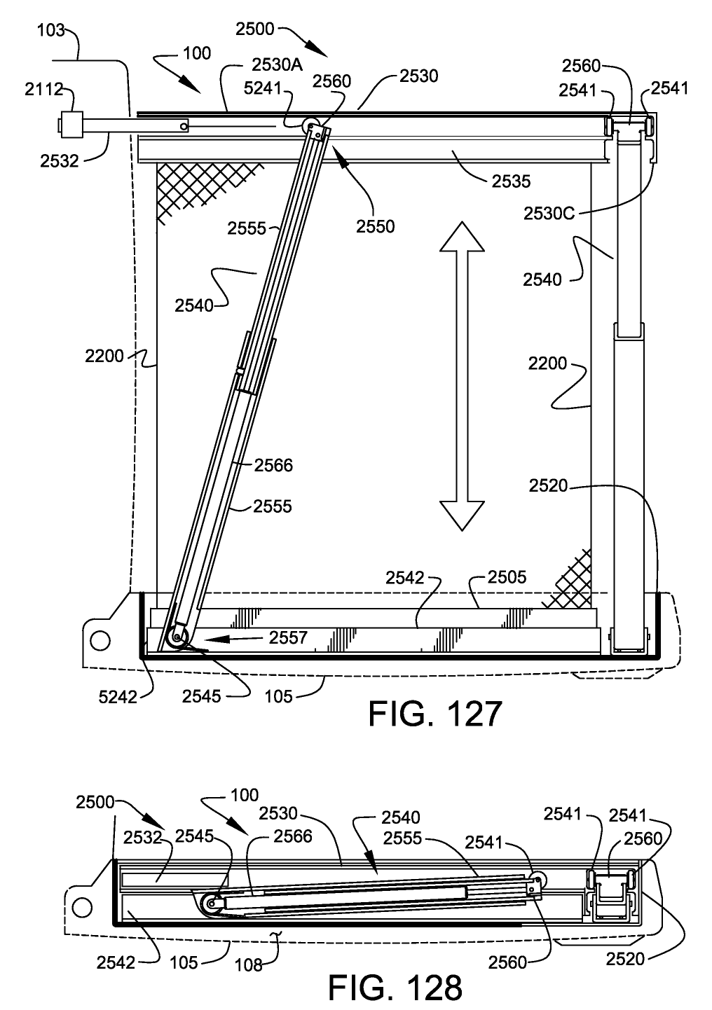

FIG. 127 shows the sectional view 127-127 of FIG. 120, illustrating the tailgate extender in a partially extended position. Typically, first side-rail portion 2530A and second side-rail portion 2530B of barrier bar 2530 are proportionally shorter in length relative to rear rail portion 2530C. Preferably, first side-rail portion 2530A and second side-rail portion 2530B of barrier bar 2530 are supported by a single extendable supports 2540 for this reason. Upon reading the teachings of this specification, those with ordinary skill in the art will now understand that, under appropriate circumstances, considering issues such as vehicle manufacturer, make, model, etc., other support arrangements, such as, for example, utilizing multiple supports, etc., may suffice.

Preferably, barrier bar 2530 comprises rail extenders 2532, as shown. Preferably, rail extenders 2532 moveably extend from barrier bar 2530 to engage at least one fixed element of cargo bed 103, most preferably U-channel 2112 mounted to cargo bed 103, as shown. Preferably, rail extenders 2532 are adapted to releasably support/couple the deployed barrier bar 2530 on cargo bed 103, thus providing additional structural stability to tailgate extender 2500. Upon reading the teachings of this specification, those with ordinary skill in the art will now understand that, under appropriate circumstances, considering such issues as advances in technology, user preference, etc., other arrangements, such as rail extenders that unfold from the rail, rail extenders that attach to the truck, rail extending chains, the use of multiple extenders, etc., may suffice.

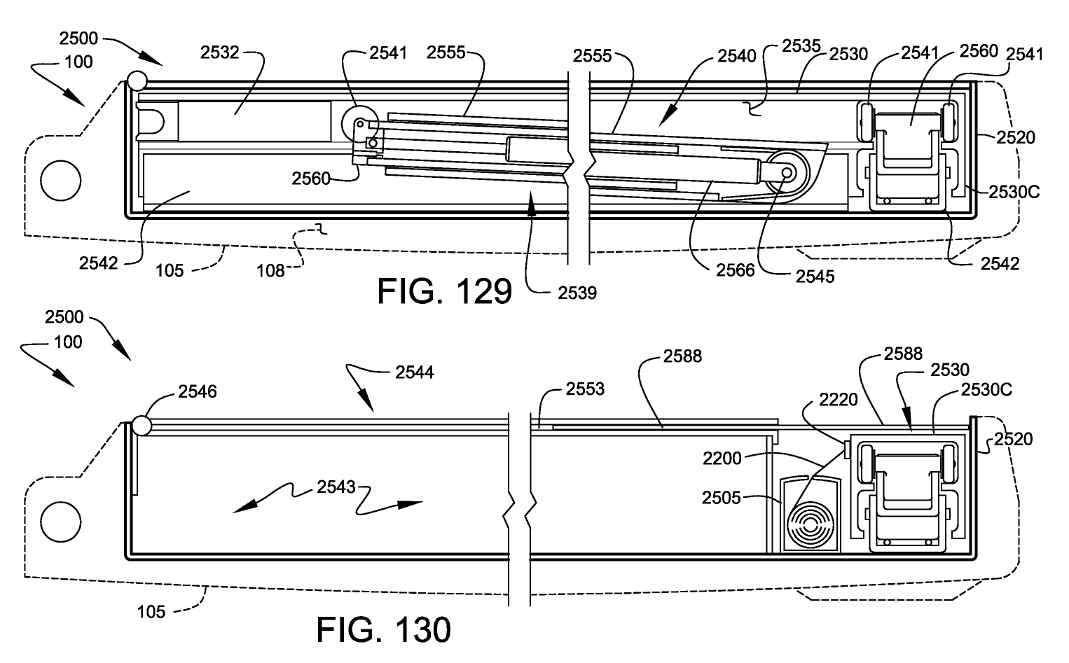

FIG. 128 shows the sectional view 127-127 of FIG. 120 illustrating the tailgate extender in a stowed position. FIG. 129 shows an enlarged sectional view of the sectional view 127-127 of FIG. 120 illustrating the tailgate extender in a stowed position. FIG. 128 and FIG. 129 further illustrate the preferred arrangements of tailgate extender 2500, specifically, that tailgate extender 2500 is adapted to be retractably stored within first storage compartment 2520, and that first storage compartment 2520 is adapted to be mounted substantially within interior cavity 2108 of tailgate 105, as shown. Preferably, lower channel 2535 is adapted to lower to a position substantially covering and encasing support assembly 2539, as shown. Upon reading the teachings of this specification, those with ordinary skill in the art will now understand that, under appropriate circumstances, considering such issues as advances in technology, user preference, etc., other cross-sectional shapes, such as novelty shaped, shaped to match the theme of the truck, thin and flexible cable with no channel (instead threaded through the ends of the supports), etc., may suffice.

FIG. 130 shows the sectional view 130-130 of FIG. 120 illustrating tailgate extender 2500 in a stowed position. Preferably, retractor 2505 is rigidly mounted within first storage compartment 2520, closely adjacent to support assembly 2539, as shown. Preferably, cargo netting 2200 is attached to barrier bar 2530 utilizing attachers 2220, such as, for example, hook and loop fasteners, as shown. Upon reading the teachings of this specification, those with ordinary skill in the art will now understand that, under appropriate circumstances, considering such issues as advances in technology, user preference, etc., other attachers, such as hooks and grommets, snaps, magnets, clips, clamps, permanent attachment, etc., may suffice. Preferably, retractor 2505 is adapted to feed out cargo netting 2200 as barrier bar 2530 is raised, and to internally store cargo netting 2200 as barrier bar 2530 is lowered. Preferably, retractor 2505 is adapted to continuously tension cargo netting 2200 during deployment.

Preferably, cargo netting 2200 and retractor 2505 comprise commercially available components. Retractor assemblies suitable for use as cargo netting 2200 and retractor 2505 is the model JD03OMA line of products available from Carefree of Colorado, Broomfield, Colo., USA.

Preferably, cover 2544 is adapted to protect the interior contents of second storage compartment 2543, as shown. Upon reading the teachings of this specification, those with ordinary skill in the art will now understand that, under appropriate circumstances, considering issues such as the nature of the stored materials, etc., other cover arrangements, such as, for example, including with the cover, weather-proof seals, security locks, secondary access doors, etc., may suffice. Preferably, cover 2544 comprises at least one extendable cover portion 2588 adapted to cover such at least one first storage section, as shown. Preferably, extendable cover portion 2588 comprises a sliding panel situated within slot cavity 553 of cover 2544, as shown. Preferably, cover 2544 comprises both side and rear extendable cover portion 2588 adapted to cover substantially the entire first storage compartment 2520. Upon reading the teachings of this specification, those with ordinary skill in the art will now understand that, under appropriate circumstances, considering issues such as cover thickness, cover material, etc., other extendable cover arrangements, such as, for example, fold-down extensions, tonneau-style flexible covers, etc., may suffice.

Preferably, tailgate barrier system 100 is provided to consumers either as a feature originally installed within truck 104 by the truck manufacturer, or as an aftermarket component mountable to tailgate 105. As an aftermarket component, tailgate barrier system 100 is preferably adapted to be mountable to tailgate 105 without substantial modifications. Upon reading the teachings of this specification, those with ordinary skill in the art will now understand that, under appropriate circumstances, considering issues such as vehicle manufacturer, make, model, etc., other mounting arrangements, such as, for example, providing application specific mounting accessories, such as, additional reinforcing members, filler plates, face panels, gate actuators, etc., may suffice.

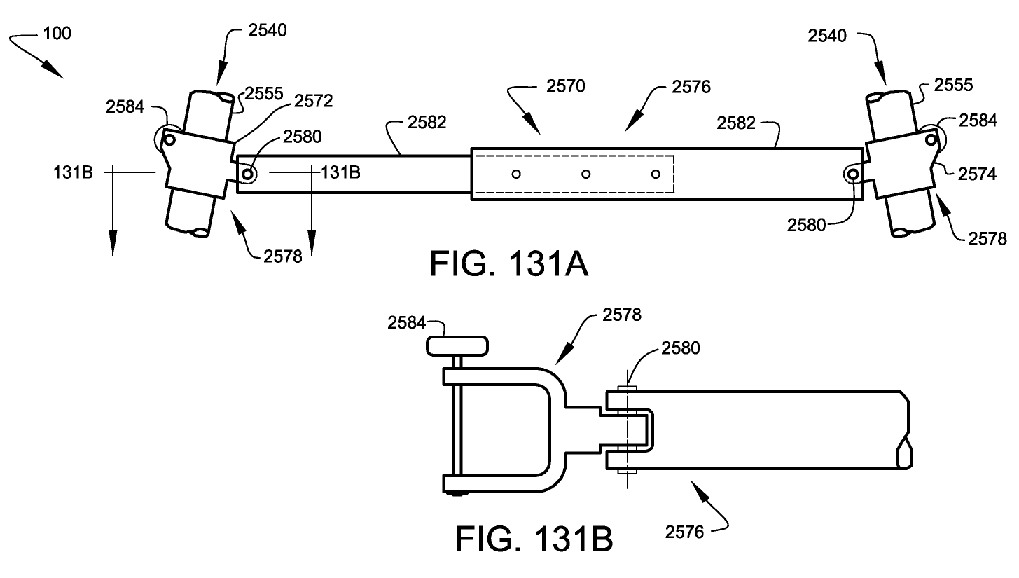

FIG. 131A shows a front view of accessory cross bar 2570, according to the preferred embodiment of FIG. 119. FIG. 131B shows the sectional view 131B-131B of FIG. 131A. Preferably, tailgate extender 2500 further comprises accessory cross bar 2570, as shown. Preferably, accessory cross bar 2570 comprises at least one first bar coupler 2572 adapted to couple accessory cross bar 2570 to a first extendable support 2540, and at least one second bar coupler 2574 adapted to couple accessory cross bar 2570 to at least one second extendable support 2540, as shown (see also FIG. 119). Preferably, first bar coupler 2572 and second bar coupler 2574 comprise at least one link 2576 adapted to link first bar coupler 2572 and second bar coupler 2574, as shown. Thus, accessory cross bar 2570 preferably functions to assist positioning of long cargo 102 during transport. Preferably, accessory cross bar 2570 is especially useful in supporting cargo of extended length such as pipes, stick lumber, etc. Preferably, first bar coupler 2572 and second bar coupler 2574 each comprise a clamping assembly 2578, preferably adapted to adjustably clamp first bar coupler 2572 and second bar coupler 2574 to a respective telescoping section 2555, as shown. Preferably, clamping assembly 2578 comprises a deformable sleeve sized to fit over telescoping sections 2555, as shown. Preferably, a threaded tightener 2584 is used to compress (deform) clamping assembly 2578 about telescoping section 2555, as shown. Preferably, first bar coupler 2572 and second bar coupler 2574 are pivotally mounted to link 2576 at pivots 2580, as shown. Preferably, link 2576 is constructed using a pair of telescoping sections 2582, preferably comprising interfitting tubes, preferably square tube members that allow the length of link 2576 to be slidably adjusted, as shown.

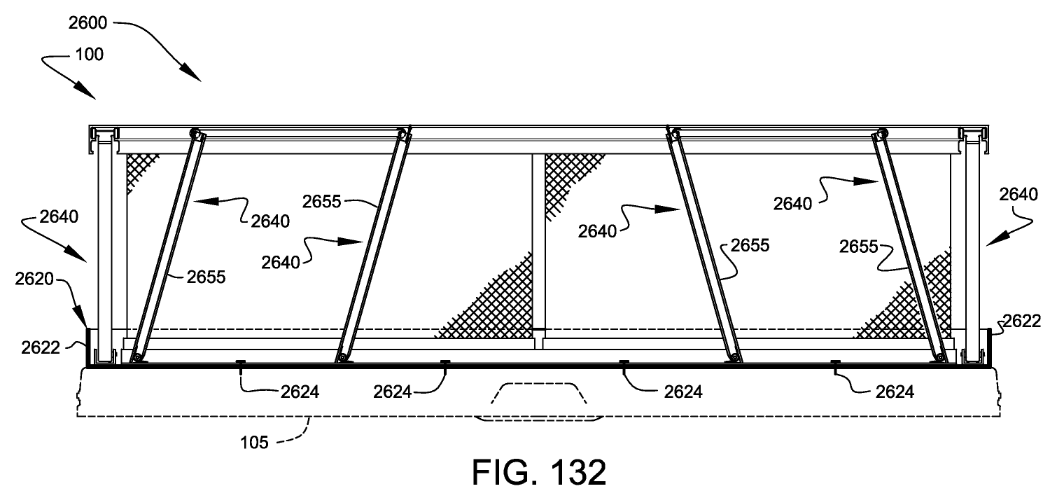

FIG. 132 shows a front sectional view illustrating tailgate extender 2600 of tailgate barrier system 100 according to another preferred embodiment of the present invention. Preferably, tailgate extender 2600 relates generally to embodiments of tailgate barrier system 100 applied in the aftermarket to vehicles as received from an OEM (original equipment manufacturer) source. Preferably, tailgate extender 2600 is substantially similar in structure and arrangement to that of tailgate extender 2500, however; tailgate extender 2600 is modified such that first storage compartment 2620 is mountable to the exterior of tailgate 105, as shown.

Preferably, tailgate extender 2600 requires little or no modification to the vehicle during installation. Preferably, tailgate extender 2600 is surface mounted to tailgate 105 using mechanical fasteners 2624, as shown. Preferably, external sides 2622 of storage compartment 2620 are modified to comprise a suitable finished appearance. Preferably, to reduce the stowed thickness of tailgate extender 2600, each extendable support 2640 comprises a one-piece (non-telescoping) tube 2655, as shown. Upon reading the teachings of this specification, those of ordinary skill in the art will now understand that, under appropriate circumstances, considering such issues as user preference, intended use, etc., other mounting arrangements, such as mounting the system in a semi-recessed manner, etc., may suffice.

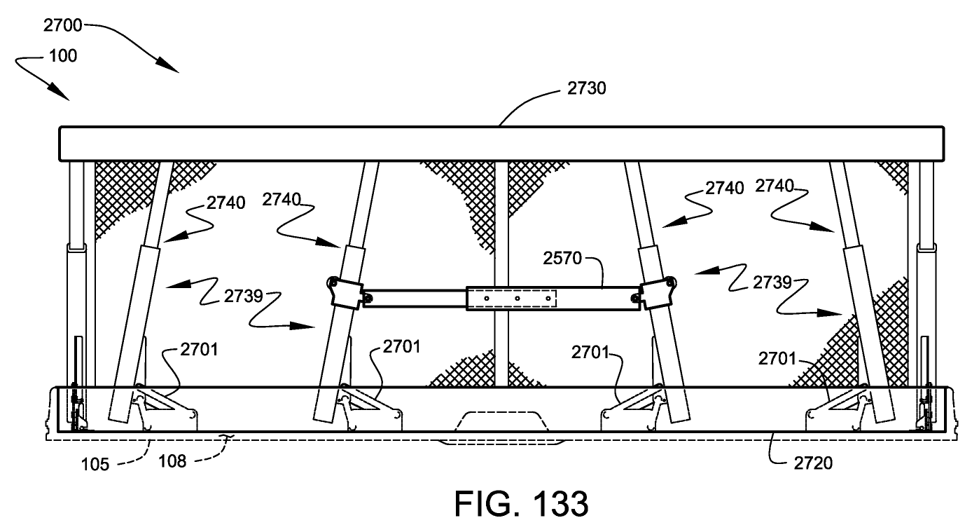

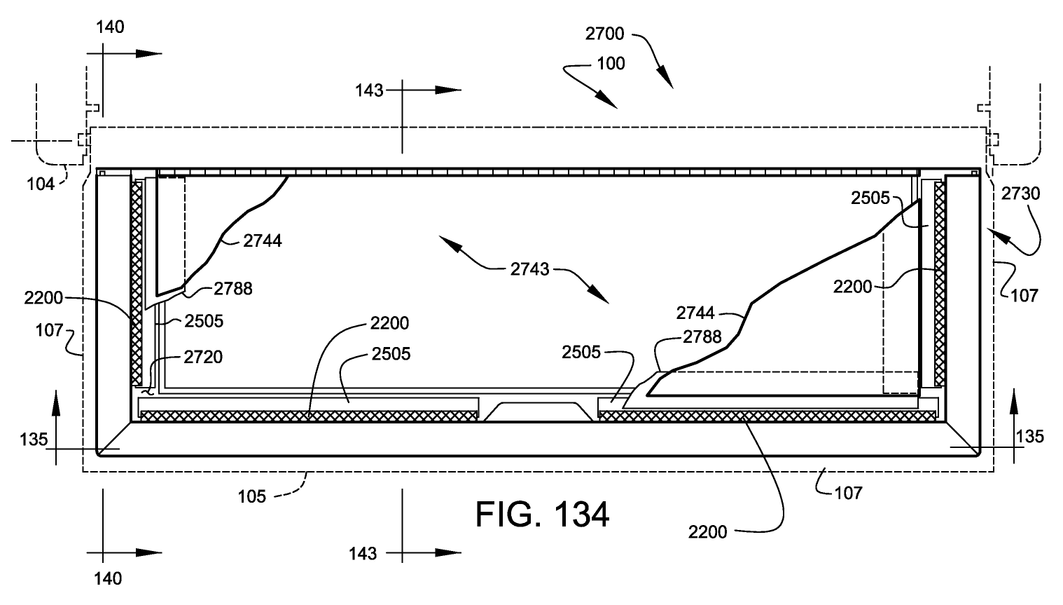

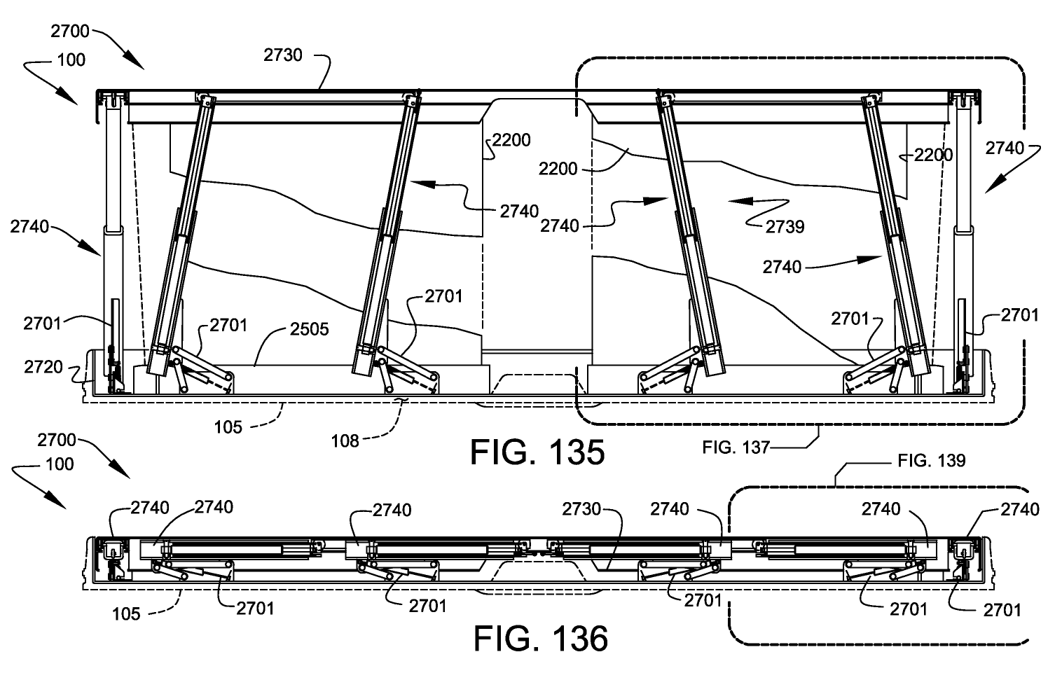

FIG. 133 shows a front view illustrating tailgate extender 2700 of tailgate barrier system 100 according to an alternate preferred embodiment of the present invention. FIG. 134 shows a top view of tailgate extender 2700, according to the preferred embodiment of FIG. 133. FIG. 135 shows the sectional view 135-135 of FIG. 134 illustrating tailgate extender 2700 in a raised (deployed) position. FIG. 136 shows the sectional view 135-135 of FIG. 134 illustrating tailgate extender 2700 in a lowered (stowed) position.

Preferably, tailgate extender 2700 is substantially similar in structure and arrangement to that of tailgate extender 2500, however; tailgate extender 2700 is modified such that the pivot connection of each extendable support 2740 comprises double pivot hinge 2701, as shown. Preferably, tailgate extender 2700 is adapted to be retractably stored within first storage compartment 2720, as shown. Preferably, first storage compartment 2720 is mounted substantially within interior cavity 2108 of tailgate 105.

Preferably, tailgate extender 2700 comprises barrier bar 2730 movably supported by arrangement of telescoping support bars identified herein as extendable support assembly 2739, as shown. Preferably, barrier bar 2730 comprises a substantially rigid, substantially continuous member, adapted to retain cargo 102 within cargo bed 103. Preferably, barrier bar 2730 is of sufficient size and strength to withstand impact from cargo shifting in the cargo bed of truck 104.

Preferably, extendable support assembly 2739 comprises a set of extendable supports 2740, as shown. Preferably, extendable supports 2740 comprise a set of length adjustable bars, adapted to raise and lower barrier bar 2730 along a substantially vertical path. In addition, extendable supports 2740 preferably function to assist in retaining cargo 102 within cargo bed 103.

Preferably, tailgate extender 2700 is adapted to deploy to at least one user-settable height, as shown. Upon reading the teachings of this specification, those with ordinary skill in the art will now understand that, under appropriate circumstances, considering such issues as advances in technology, user preference, etc., other arrangements, such as multi-part rails, the tailgate extender extending above the tailgate internal surface in storage, other heights, multiple adjustable heights, etc., may suffice. Preferably, barrier bar 2730, extendable supports 2740, and first storage compartment 2720 are constructed of at least one, preferably a combination of materials having an application-appropriate level of durability and weather resistance. Preferably, tailgate extender 2700 substantially comprises metal, most preferably steel and/or aluminum. Upon reading the teachings of this specification, those with ordinary skill in the art will now understand that, under appropriate circumstances, considering such issues as advances in technology, user preference, etc., other materials, such as plastic, composite materials, wood, ceramics, combinations of materials, etc., may suffice.

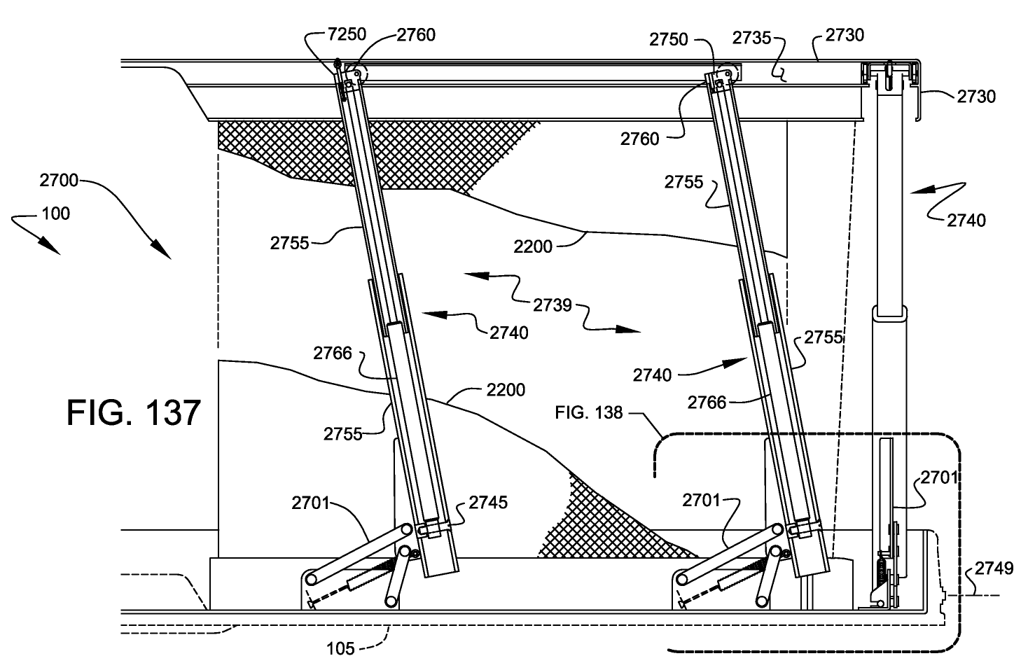

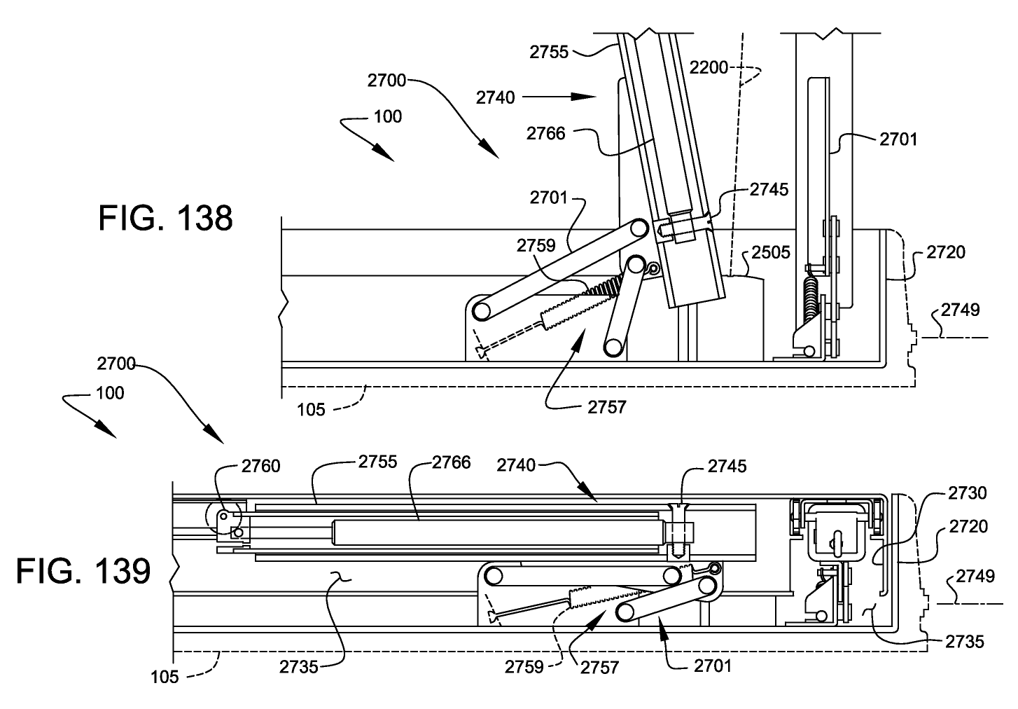

FIG. 137 shows the detailed sectional view 137 of FIG. 135. FIG. 138 shows the detailed sectional view 138 of FIG. 137. FIG. 139 shows the detailed sectional view 139 of FIG. 136. Preferably, each extendable support 2740 is constructed using a pair of telescoping sections 2755, preferably comprising interfitting tubes, preferably square tube members, which permit the length of extendable support 2740 to be slidably adjusted for length, as shown. Preferably, extendable supports 2740 are adjustable to at least one preselected length (preferably corresponding to the height of the vehicle bed), as shown. Preferably, when extendable supports 2740 are extended to the preset length, telescoping sections 2755 releasably interlock into a fixed position and remain extended, as shown. During deployment, extendable supports 2740 preferably swing through a near 90-degree arc, as shown. Preferably, in the locked position, extendable supports 2740 are oriented near vertical, relative to open tailgate 105, when fully extended and ready for use, as shown. Preferably, the angular rotation of extendable supports 2740 is limited to less than 90-degrees relative to pivot axis 749, as shown. This preferred limit of rotation arranges extendable supports 2740 to allow a smooth downward angular rotation of extendable supports 2740 during the lowering and stowing of tailgate extender 2700.

Preferably, the lower (proximal) ends of extendable supports 2740 are pivotally mounted to the base of first storage compartment 2720, as shown. Preferably, each extendable support 2740 is pivotally mounted within first storage compartment 2720 using double pivot hinge 2701, as shown. Preferably, double pivot hinge 2701 is adapted to rotate extendable support 2740 with a single degree of freedom.

Preferably, each double pivot hinge 2701 comprises at least one rotator 2757 adapted to generate at least one rotational force usable to assist in lifting extendable support 2740 during deployment, as shown. Preferably, rotator 2757 comprises at least one spring 2759, as shown. Double pivot hinges preferably suitable for use as double pivot hinge 2701 are available from Hardware Source, Inc. of San Diego, Calif. (www.hardwaresource.com).

Preferably, barrier bar 2730 comprises at least one internal channel 2735, as shown, in which slider 2750 is movably captured. Preferably, slider 2750 is adapted to translate (horizontally) within channel 2735 as tailgate extender 2700 is raised or lowered. The structures and arrangements of barrier bar 2730 and slider 2750 are preferably identical to those described for tailgate extender 2500, above.

Preferably, each extendable supports 2740 comprise at least one telescopic assister, more preferably, at least one gas-charged spring 2766, as shown. Preferably, gas-charged spring 2766 is adapted to support, at least partially, the weight of the moving assemblies of tailgate extender 2700, thus assisting the user in raising and lowering barrier bar 2730. Preferably, gas-charged spring 2766 is situated within telescoping sections 2755, as shown. Preferably, gas-charged spring 2766 is operably coupled to end fixture 2760 and spring mount 2745, as shown. Preferably, spring mount 2745 comprises a threaded pin removably disposed within a telescoping section 2755, as shown. Preferred gas-charged spring assemblies suitable for use as gas-charged spring 2766 are available from the SUSPA Corporation (www.suspa-inc.com).

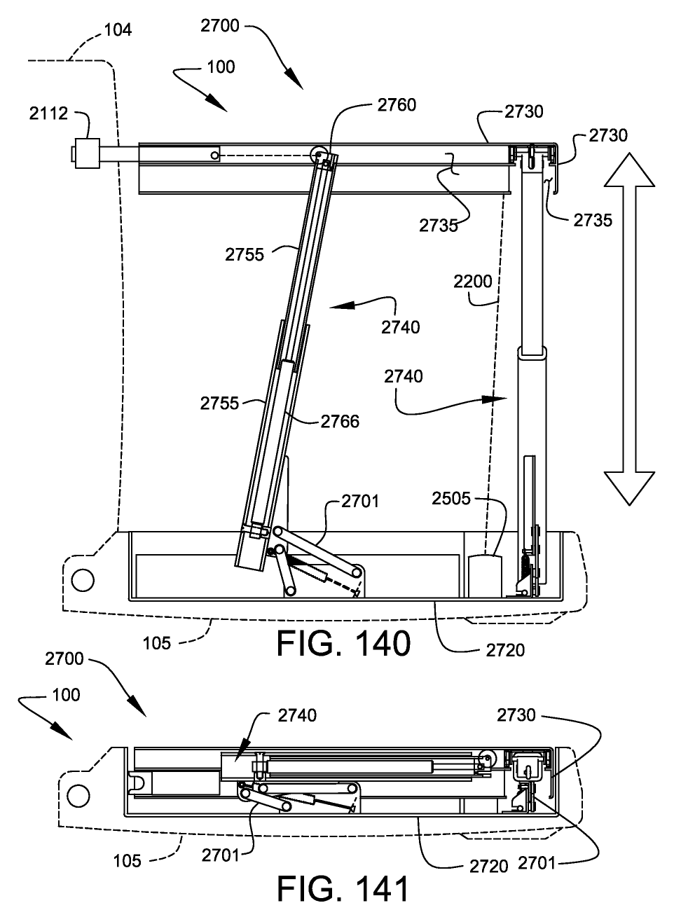

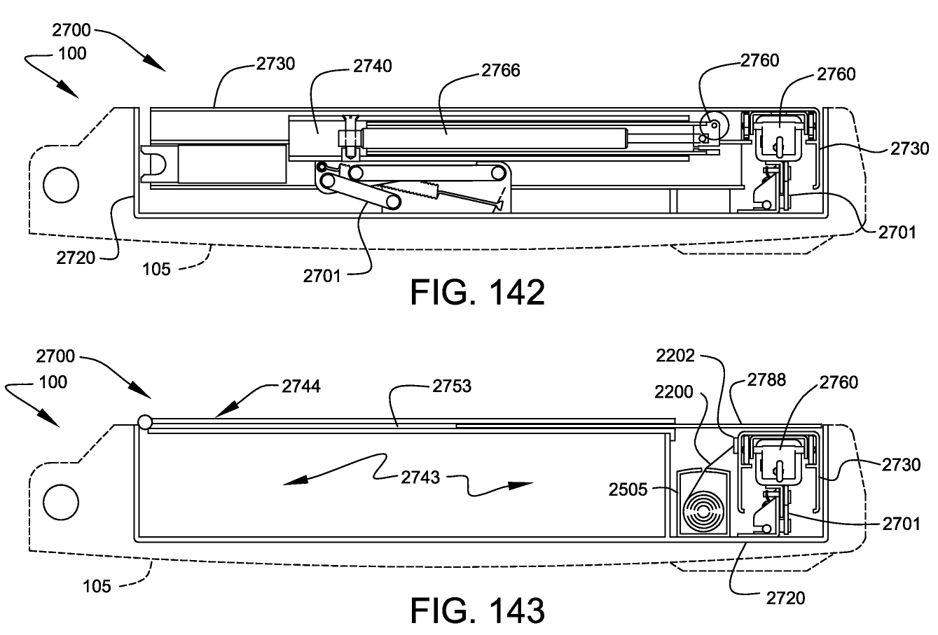

FIG. 140 shows the sectional view 140-140 of FIG. 134, illustrating tailgate extender 2700 in an extended position. FIG. 141 shows the sectional view 141-141 of FIG. 134, illustrating tailgate extender 2700 in a stowed position. FIG. 142 shows an enlarged view of the sectional view 142-142 of FIG. 141, illustrating tailgate extender 2700 in a stowed position. FIG. 140 through FIG. 142 further illustrates preferred structures and arrangements of tailgate extender 2700. As previously noted, with the exception of the use of double pivot hinges 2701 and modified mounting of gas-charged spring 2766, the preferred construction and operation of tailgate extender 2700 is substantially identical to that of tailgate extender 2500, as described above.

FIG. 143 shows an enlarged view of the sectional view 143-143 of FIG. 141, again illustrating tailgate extender 2700 in a stowed position. Preferably, cover 2744 is adapted to protect the interior contents of second storage compartment 2743, as shown. Upon reading the teachings of this specification, those with ordinary skill in the art will now understand that, under appropriate circumstances, considering issues such as the nature of the stored materials, etc., other cover arrangements, such as, for example, including with the cover, weather-proof seals, security locks, secondary access doors, etc., may suffice. Preferably, cover 2744 comprises at least one extendable cover portion 2788 adapted to cover such at least one first storage section, as shown. Preferably, extendable cover portion 2788 comprises a sliding panel situated within slot cavity 753 of cover 2744, as shown. Preferably, cover 2744 comprises both side and rear extendable cover portion 2788 adapted to cover substantially the entire first storage compartment 2720. Upon reading the teachings of this specification, those with ordinary skill in the art will now understand that, under appropriate circumstances, considering issues such as cover thickness, cover material, etc., other extendable cover arrangements, such as, for example, fold-down extensions, tonneau-style flexible covers, etc., may suffice. Preferably, cargo netting 2200 and retractor 2505 again comprise commercially available retractor assemblies such as the JD03OMA line of products available from Carefree of Colorado, Broomfield, Colo., USA. Means of attaching cargo netting 2200 to barrier bar 2730 are preferably equivalent to those described for tailgate extender 2500.

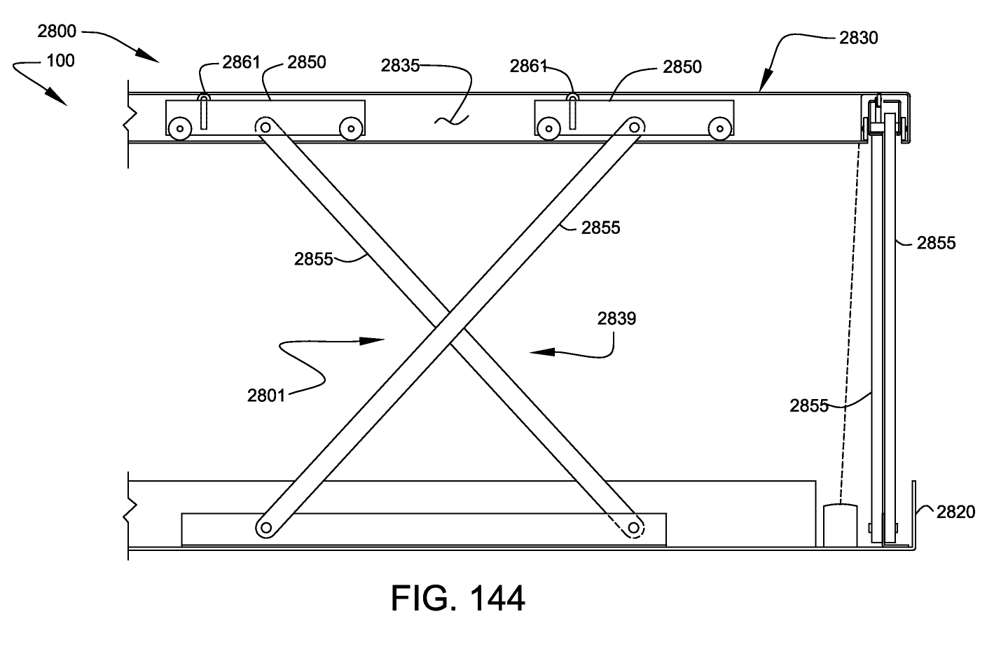

FIG. 144 shows a partial sectional view illustrating tailgate extender 2800 of tailgate barrier system 100 according to another preferred embodiment of the present invention. Preferably, tailgate extender 2800 is substantially similar in structure and arrangement to that of tailgate extender 2500, however; tailgate extender 2800 is modified such that support assembly 2839 comprises scissor support 2801, as shown. Preferably, tailgate extender 2800 is adapted to be retractably stored within first storage compartment 2820, as shown.

Preferably, tailgate extender 2800 comprises barrier bar 2830 movably supported by arrangement of diagonal support bars 2855, as shown. Preferably, diagonal support bars 2855 are adapted to raise and lower barrier bar 2830 along a substantially vertical path.

Preferably, tailgate extender 2800 is adapted to deploy to at least one user-settable height, as shown. Upon reading the teachings of this specification, those with ordinary skill in the art will now understand that, under appropriate circumstances, considering such issues as advances in technology, user preference, etc., other arrangements, such as multi-part rails, the tailgate extender extending above the tailgate internal surface in storage, other heights, multiple adjustable heights, etc., may suffice.

Preferably, the lower ends of diagonal support bars 2855 are pivotally mounted to the base of first storage compartment 2820, as shown. Preferably, the upper ends of diagonal support bars 2855 are coupled to sliders 2850, as shown. Preferably, sliders 2850 translate horizontally along the interior of internal channel 2835 thus allowing the angular rotation of diagonal support bars 2855. Preferably, each slider 2850 comprises a spring loaded slide positioner 2861, as shown. Preferably, slide positioner 2861 is substantially equivalent in structure and function to slide positioner 2561 of tailgate extender 2500.

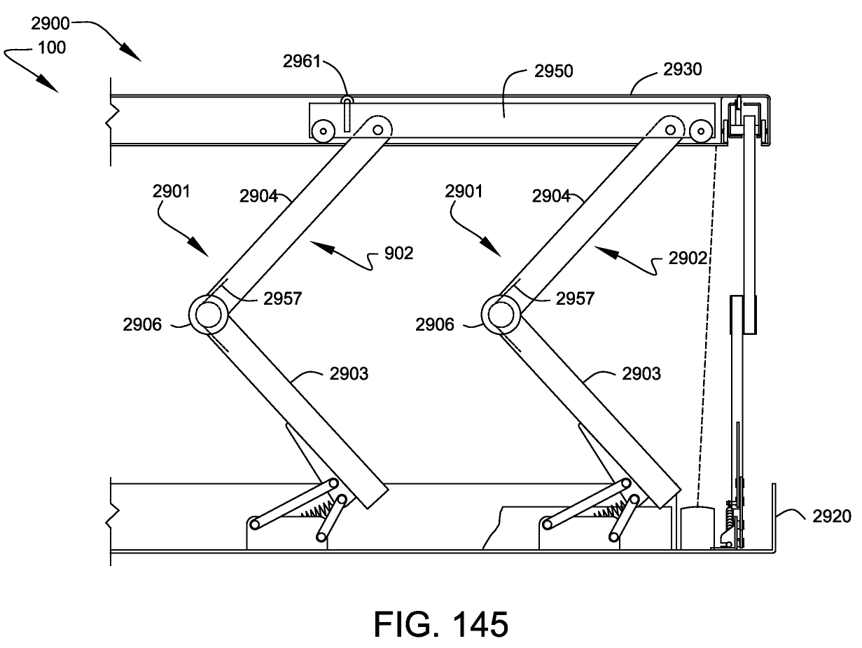

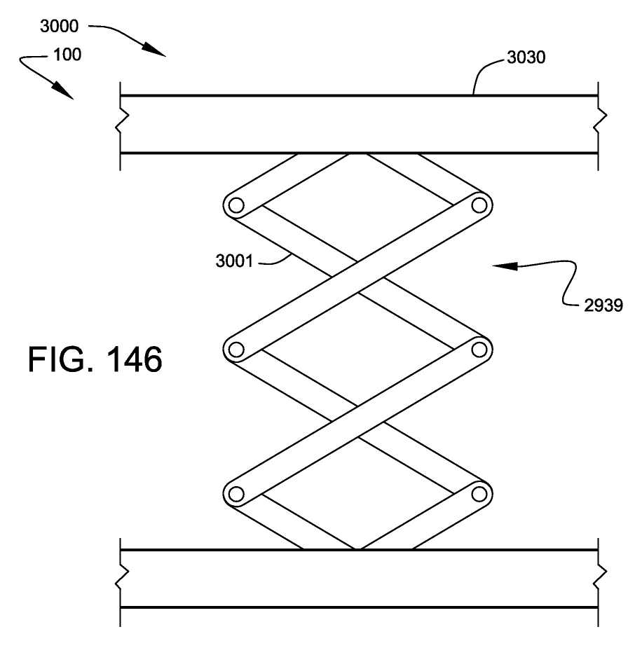

FIG. 145 shows a partial sectional view illustrating tailgate extender 2900 of tailgate barrier system 100 according to another preferred embodiment of the present invention. Preferably, tailgate extender 2900 is substantially similar in structure and arrangement to that of tailgate extender 2700, however; tailgate extender 2900 is modified such that support assembly 2939 comprises articulated support 2901, as shown. Preferably, tailgate extender 2900 is adapted to be retractably stored within first storage compartment 2920, as shown.

Preferably, tailgate extender 2900 comprises barrier bar 2930 movably supported by articulated support system 2901, as shown. Preferably, articulated support system 2901 is adapted to raise and lower barrier bar 2930 along a substantially vertical path.

Preferably, articulated support system 2901 comprises a set of articulated supports 2902, as shown. Preferably, each articulated support 2902 comprises at least one first support arm 2903 pivotally coupled to first storage compartment 2920, and at least one second support arm 2904 pivotally coupled to slider 2950, as shown. Preferably, first support arm 2903 and second support arm 2904 are pivotally coupled at articulated joint 2906, as shown. Preferably, articulated joint 2906 is adapted provide a single degree of movement between first support arm 2903 and second support arm 2904. Preferably, articulated joint 2906 comprises an internal rotator 2957 (preferably a spring) adapted to generate at least one rotational force usable to assist in lifting articulated support system 2901 and barrier bar 2930 during deployment, as shown.

Preferably, tailgate extender 2900 is adapted to deploy to at least one user-settable height, as shown. Preferably, sliders 2950 translate horizontally along the interior of internal channel 2935. Preferably, each slider 2950 comprises a spring loaded slide positioner 2961, as shown. Preferably, slide positioner 2961 is substantially equivalent in structure and function to slide positioner 2561 of tailgate extender 2500.

FIG. 146 shows a partial sectional view illustrating tailgate extender 3000 of the tailgate barrier system 100 according to another preferred embodiment of the present invention. Preferably, tailgate extender 3000 is a hybrid combination similar in structure and arrangement to that of tailgate extender 2800 and tailgate extender 2900, as shown. Preferably, tailgate extender 3000 is modified such that support assembly 3039 comprises a multi-arm scissor-type support 3001, as shown. Preferably, support assembly 3000 is adapted to assist in raising and lowering barrier bar 3030 along a substantially vertical path.

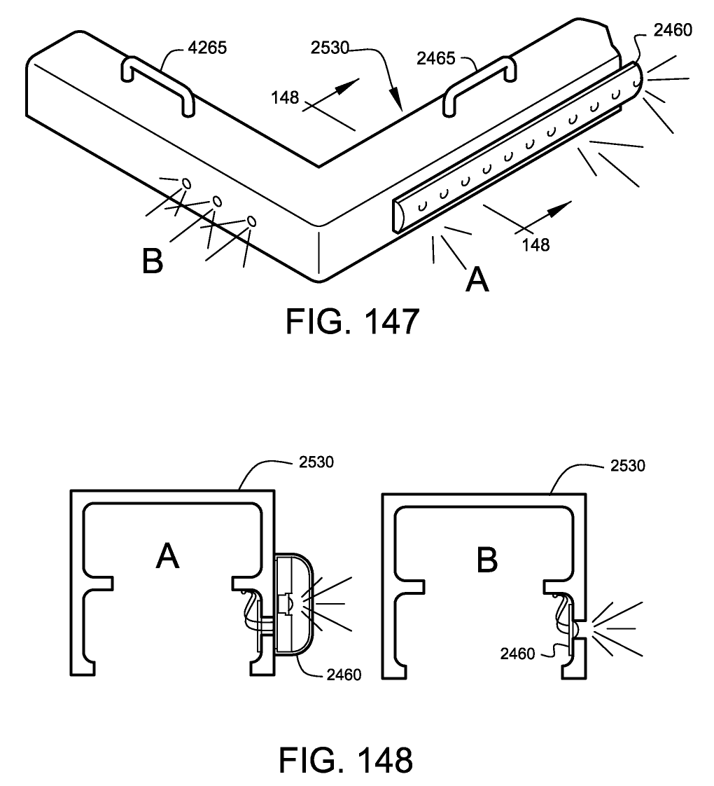

FIG. 147 shows a partial perspective view illustrating illumination and functional components of tailgate barrier system 100 according to additional preferred embodiments of the present invention. FIG. 148 shows an enlarged view of the sectional view 148-148 of FIG. 147. Preferably, each barrier bar embodiment of tailgate barrier system 100 is adaptable to receive indicator light assembly 2460, as shown. For clarity, the depicted barrier bar of FIG. 147 is identified herein as barrier bar 2530. It should be noted that in the present discussion, barrier bar 2530 is representative of each of the above-described barrier rail embodiments of tailgate barrier system 100. Preferably, indicator light assembly 2460 functions as a secondary running light, brake light, turn signal, and/or hazard light (for added safety). Preferably, indicator light assembly 2460 comprises an array of super high-intensity light emitting diodes (LED), as shown. Preferably, the LED array is housed within a one-piece, weather proof, polymer housing, “A” as shown. More preferably, indicator light assembly 2460 comprises an LED strip “B” mounted within barrier bar 2530. Preferably, indicator light assembly 2460 comprises an application appropriate length of between about 36 inches and 72 inches. Preferably, indicator light assembly 2460 is firmly mounted to the rear face of the barrier rail, as shown. Preferably, indicator light assembly 2460 is adapted to electrically couple with the taillight wiring circuit of truck 104. More preferably, indicator light assembly 2460 is adapted to plug directly into the standard four-prong towing harness of truck 104. NHSTA approved indicator light assemblies suitable for use as indicator light assembly 2460 include commercially available products available from RECON Truck Accessories of Boca Raton, Fla. Upon reading the teachings of this specification, those of ordinary skill in the art will now understand that, under appropriate circumstances, considering such issues as user preference, intended use, etc., other lighting arrangements, such as custom lighting installations, multiple lighting devices, devices comprising flashers/motion effects, etc., may suffice.

In addition, preferred embodiments of the barrier rails comprise retractable “U”-bolts 2465, as shown. Preferably, “U”-bolts 2465 are provided as securing points for cargo straps and similar ties. Preferably, “U”-bolts 2465 are retractably mounted within the upper face of barrier bar 2530, as shown.

Upon reading the teachings of this specification, those of ordinary skill in the art will now understand that, under appropriate circumstances, considering such issues as user preference, intended use, etc., other system mountable accessories, such as, for example, cargo restraints, bungee-type cord restraints, etc., may suffice.

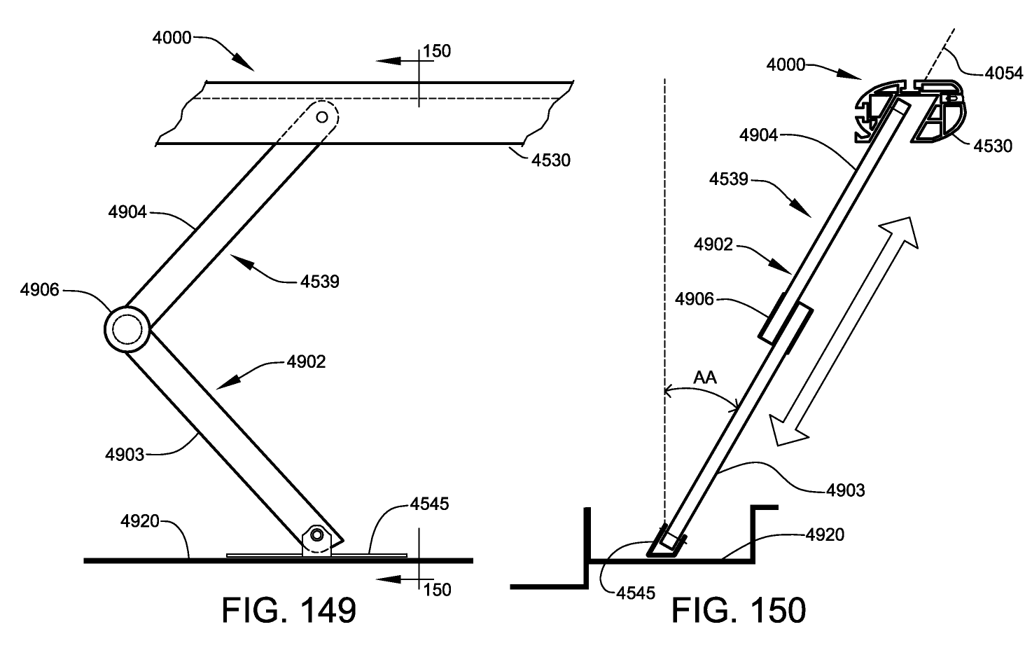

FIG. 149 shows a partial front view of alternate tailgate barrier 4000 of tailgate barrier system 100, in an extended position, according to the preferred embodiment of FIG. 1C. FIG. 150 shows a sectional view through the section 150-150 of FIG. 149 illustrating alternate tailgate barrier 4000 according to the preferred embodiment of FIG. 1C.

Alternate tailgate barrier 4000 preferably comprises extendable support assembly 4539 having a fixed base connector bracket 4545 structured and arranged to allow barrier bar 4530 to move upwardly at an acute angle, as shown. Preferably, support assembly 4539, as shown, movably supports barrier bar 4530. Preferably, both barrier bar 4530 and extendable support assembly 4539 are adapted to be retractably stored adjacent to external surface 110 of tailgate 105 (see the diagrams of FIG. 1C and FIG. 1D).

Preferably, extendable support assembly 4539 comprises a set of articulated supports 4902, as shown. Preferably, each articulated support 4902 comprises at least one first support arm 4903 pivotally coupled to first storage compartment 4920, and at least one second support arm 4904 coupled to barrier bar 4530, as shown. Preferably, second support arm 4904 is coupled to barrier bar 4530 at a fixed pivot point within barrier bar 4530, as shown.

Preferably, first support arm 2903 and second support arm 2904 are pivotally coupled at articulated joint 4906, as shown. Preferably, articulated joint 4906 is adapted provide a single degree of movement between first support arm 4903 and second support arm 4904. Upon reading the teachings of this specification, those of ordinary skill in the art will now understand that, under appropriate circumstances, considering such issues as intended use, cost, etc., other arrangements, such as providing within the articulated support an internal rotator (preferably a spring) adapted to generate at least one rotational force usable to assist in lifting the barrier bar during deployment, etc., may suffice.

The preferred linear upward motion of barrier bar 4530 to the extended position falls substantially along a line 4054 comprising an angle AA of no more than about 30 degrees from vertical (see also fourth plane 56 of FIG. 1D). The preferred dynamics of the deployment comprises a substantially linear movement, as previously described in FIG. 1D. It is noted that such preferred movement does not require pivoting or rotation of the barrier assembly during extension from the stowed position to the extended position. This highly preferred feature is noteworthy in that cargo may be located on or over tailgate 105 (very near barrier bar 4530) without hindering the extension of alternate tailgate barrier 4000.

The side support configuration of alternate tailgate barrier 4000 preferably remains as described for the prior embodiments, but preferably requires the use of longer extendable side supports to accommodate the rearward projection of barrier bar 4530. Upon reading the teachings of this specification, those of ordinary skill in the art will now understand that, under appropriate circumstances, considering such issues as intended use, etc., other arrangements, such as the use of automated lifting mechanisms, spring assist arrangements, motor-assisted side-support arrangement, etc., may suffice.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1) A truck tailgate barrier system comprising:
a) at least one extendable barrier to assist barring movement of cargo from a truck bed having a tailgate, when the tailgate is in lowered position, the tailgate having, when in raised position and connected to the at least one truck bed, a cab-facing external surface;
b) wherein said at least one extendable barrier comprises
i) at least one load-bearing bar structured and arranged to provide, when extended from at least one stowed position to at least one extended position, at least one load-bearing restraint of the cargo, and
ii) at least one conveyor to convey said at least one load-bearing bar from the at least one stowed position to the at least one extended position;
c) wherein said at least one load-bearing bar, when unextended in the at least one stowed position, lies substantially in a first plane along the cab-facing external surface of the tailgate and, when extended in the at least one extended position, lies in a second plane spaced from and substantially parallel to the first plane;
d) wherein the motion of said at least one load-bearing bar to the at least one extended position falls substantially within a third plane no more than about 30 degrees from a fourth plane oriented substantially perpendicular to the first plane.

2) The truck tailgate barrier system according to claim 1 further comprising at least one torsion bar structured and arranged to support a portion of the weight of the tailgate during rotation between the lowered position and the raised position.

3) The truck tailgate barrier system according to 2 further comprising a rotation-rate limiter structured and arranged to limit the rate of rotation of the tailgate during rotation between the raised position and the lowered position.

4) The truck tailgate barrier system according to claim 1 further comprising:
a) at least one flexible barrier to assist in barring the cargo from moving past said at least one load-bearing bar;
b) wherein said at least one flexible barrier comprises at least one retractor to retract said at least one flexible barrier for storage.

5) The truck tailgate barrier system according to claim 1 wherein said at least one load-bearing bar comprises at least one U-shaped member.

6) The truck tailgate barrier system according to claim 5 further comprising
a) at least one first storage section to store said at least one U-shaped member in the at least one stowed position; and
b) at least one second storage section structured and arranged to provide secondary storage
c) wherein said at least one conveyer comprises at least one extendable support to extendably support said at least one U-shaped member between such extension from the at least one stowed position and such at least one extended position; and
d) wherein said at least one extendable support comprises
i) at least one first connector to pivotally connect said at least one extendable support to said at least one first storage section, and
ii) at least one second connector to pivotally connect said at least one extendable support to said at least one U-shaped member.

7) The truck tailgate barrier system according to claim 6 wherein said at least one U-shaped member comprises:
a) at least one extruded rear channel structured and arranged to assist barring cargo from moving in at least one rearward direction relative to the tailgate;
b) at least one extruded side channel structured and arranged to assist barring cargo from crossing at least one side perimeter of at least one tailgate; and
c) at least one channel coupler structured and arranged to rigidly couple said at least one extruded rear channel with said at least one extruded side channel;
d) wherein said at least one channel coupler maintains said at least one extruded side channel at about a 90-degree orientation relative to said at least one extruded rear channel.

8) The truck tailgate barrier system, according to claim 7 wherein said at least one extendable support comprises:
a) at least one support arm structured and arranged to pivotally couple to said at least one first storage section;
b) at least one second support arm structured and arranged to pivotally couple to said at least one U-shaped member; and
c) at least one articulated joint structured and arranged provide at least one degree of movement between said at least one first support arm and said at least one second support arm.

9) The truck tailgate barrier system according to claim 7 wherein:
a) said at least one extendable support comprises
i) at least one telescoping leg to telescopically adjust at least one linear distance between said at least one first connector and said at least one second connector,
ii) at least one telescopic assister to assist telescopic deployment of said at least one telescoping leg; and
b) said at least one telescoping leg comprises at least one releasable lock structured and arranged to releasably lock said at least one telescoping bar in at least one telescopic position.

10) The truck tailgate barrier system according to claim 7 wherein said at least one extendable support comprises:
a) at least one power-assisted actuator structured and arranged to provide power-assisted movement of said at least one U-shaped member during extension from the at least one stowed position; and
b) at least one actuator control to provide user control of said at least one power-assisted actuator;
c) whereby user locating of said at least one U-shaped member, between the at least one stowed position and the at least one extended position, is assisted.

11) The truck tailgate barrier system according to claim 10, wherein said at least one actuator control comprises at least one remote wireless interface.

12) The truck tailgate barrier system according to claim 7, further comprising:
a) at least one bar-stabilization assembly structured and arranged to stabilize said at least one U-shaped member when in such at least one extended position;
b) wherein said at least one bar-stabilization assembly comprises
i) at least one bed-mounted anchor structured and arranged to provide at least one anchor point within the truck bed, and
ii) coupled with said at least one U-shaped member, at least one anchor engager structured and arranged to engage said at least one bed-mounted anchor;
c) wherein said at least one anchor engager comprises at least one rail coupler structured and arranged to couple said at least one anchor engager to said at least one load-bearing bar;
d) wherein when said at least one U-shaped member is in the at least one stowed position, said at least one anchor engager is retracted to a position substantially within said at least one extruded side channel; and
e) wherein said at least one anchor engager is deployed from said at least one extruded side channel by movement of said at least one load-bearing bar between the at least one stowed position and the at least one extended position.

13) The truck tailgate barrier system according to claim 7 wherein said at least one U-shaped member comprises at least one bar aperture to supportively receive at least one aperture-insertable portion of at least one mountable accessory.

14) The truck tailgate barrier system, according to claim 7 further comprising:
a) such at least one mountable accessory comprising such aperture-insertable portion;
b) wherein said at least one mountable accessory comprises at least one stanchion structured and arranged to support said at least one mountable accessory in an operable position.

15) The truck tailgate barrier system, according to claim 14 wherein said at least one mountable accessory comprises at least one member selected from the group consisting essentially of:
a) at least one umbrella structured and arranged to provide environmental protection,
b) at least one foldable canopy structured and arranged to provide foldable weather protection wherein said at least one foldable canopy comprises a fabric panel having at least one peripheral fabric edge.

16) The truck tailgate barrier system according to claim 15 wherein said at least one foldable canopy further comprises:
a) at least one light permeable sleeve positioned along at least one portion of said at least one peripheral fabric edge; and
b) at least one illuminated cable structured and arranged to provide at least one substantially continuous line of illumination;
c) wherein said at least one light permeable sleeve is structured and arranged to internally support said at least one illuminated cable; and
d) wherein said at least one light permeable sleeve comprises a net-like structure.

17) The truck tailgate barrier system according to claim 16 wherein said at least one foldable canopy further comprises:
a) At least one adjustable support post structured and arranged to adjustably support at least one portion of said at least one foldable canopy over a ground surface adjacent the truck bed;
b) wherein said at least one stanchion comprises at least one length adjuster to adjust the overall length of said at least one stanchion; and
c) wherein said at least one stanchion comprises at least three telescoping sections.

18) The truck tailgate barrier system according to claim 7 wherein each said at least one load-bearing bar comprises:
a) at least one longitudinal axis; and
b) at least one T-shaped-cross-section slot portion forming at least one continuous slot opening portion within said at least one load-bearing bar;
c) wherein said at least one T-shaped-cross-section slot portion is oriented substantially parallel to said at least one longitudinal axis.

19) The truck tailgate barrier system according to claim 18 further comprising:
a) at least one interlocking engager structured and arranged to interlockably engage said at least one T-shaped-cross-section slot portion;
b) wherein said at least one interlocking engager comprises at least one first position of engagement within said at least one T-shaped-cross-section slot portion preventing removal of said at least one interlocking engager;
c) wherein said at least one interlocking engager comprises at least one second position of engagement within said at least one T-shaped-cross-section slot portion allowing removal of said at least one interlocking engager.

20) The system according to claim 19 wherein:
a) said at least one interlocking engager comprises at least one lashing anchor to provide at least one lashing anchor to assisting lashing of the cargo supported within the truck bed;
b) each said at least one lashing anchor comprises
i) at least one T-shaped slide structured and arranged to allow engaged sliding of said at least one lashing anchor within said at least one T-shaped-cross-section slot portion of said at least one load-bearing bar, and
ii) at least one slide-resister structured and arranged to resist sliding of said at least one lashing anchor within said at least one T-shaped-cross-section slot portion of said at least one load-bearing bar; and
c) said at least one slide-resister operates substantially by friction.

21) The truck tailgate barrier system according to claim 20 wherein said at least one interlocking engager comprises at least one mountable accessory structured and arranged to be substantially supported from said at least one load-bearing bar by said at least one interlocking engager.

22) The truck tailgate barrier system according to claim 21 wherein said at least one mountable accessory comprises at least one member selected from the group consisting essentially of:
a) at least one cup holder structured and arranged to hold a beverage container,
b) at least one barbecue grilling device structured and arranged to provided open flame preparation of food,
c) at least one table surface structured and arranged to provide surface support;
d) at least one storage compartment,
e) at least one document holder structured to hold one or more set of rolled documents,
f) at least one insulated storage container structured and arranged to store one or more temperature sensitive items, and
g) at least one water-cooler support structured and arranged to support at least one water cooler.

23) The truck tailgate barrier system according to claim 21 wherein:
a) a portion of said at least one mountable accessory is supported directly from the tailgate; and
b) said at least one mountable accessory comprises
i) at least one support leg structured and arranged to be supported directly from a ground surface adjacent the truck bed, and
ii) at least one pivoting coupler to pivotally couple said at least one support leg with said at least one mountable accessory;
c) wherein said at least one support leg comprises at least one leg-length adjuster to adjust the length of said at least one support leg.

24) The truck tailgate barrier system according to claim 7 wherein when in the at least one stowed position, said at least one first storage section is structured and arranged to fully store said at least one U-shaped member and said at least one extendable support.

25) The truck tailgate barrier system according to claim 24 wherein said at least one first storage section and said at least one second storage section are each located substantially within an inner cavity of the tailgate.

26) The truck tailgate barrier system according to claim 24 wherein said at least one first storage section and said at least one second storage section are each located substantially external of an inner cavity of the tailgate.

27) The truck tailgate barrier system according to claim 24 wherein:
a) said at least one second storage section comprises at least one deployable accessory;
b) wherein said at least one deployable accessory is deployed from at least one stowed position within said at least one second storage section to at least one deployed position; and
c) wherein said at least one deployable accessory comprises at least one substantially permanent connection to said at least one second storage section.

28) The truck tailgate barrier system according to claim 27 wherein said at least one deployable accessory comprises at least one member selected from the group consisting essentially of:
i) at least one foldable ladder structured and arranged to assist user access to the truck bed,
ii) at least one foldable ramp structured and arranged to assist user access to the truck bed,
iii) at least one extendable electrical light, and
iv) at least one video display screen.

29) The truck tailgate barrier system according to claim 24 wherein:
a) said at least one second storage section comprises at least one non-deployable accessory;
b) said non-deployable accessory comprises at least one member selected from the group consisting essentially of:
i) at least one electrical light coupled to at electrical circuit of the truck bed,
ii) at least one electrical coupler coupled to at electrical circuit of the truck bed;
iii) at least one audio coupler coupled to at audio circuit of the truck bed;
iv) at least one video coupler coupled to at least one video circuit of the truck bed; and
v) at least one data coupler coupled to at least one data circuit of the truck bed.

30) The truck tailgate barrier system according to claim 29 wherein said at least one electrical coupler comprises at least one proprietary adapter structured and arranged to adapt said at least one electrical coupler to at least one first proprietary coupler.

31) The truck tailgate barrier system according to claim 29 wherein said at least one second storage section comprises at least one controller structured and arranged to remotely control the functioning of at least one of said at least one audio coupler, said at least one video coupler, and said at least one data coupler.

32) The truck tailgate barrier system according to claim 24 further comprising:
a) at least one cover to substantially cover said at least one second storage section;
b) wherein said at least one cover comprises at least one extendable cover portion to cover at least one portion of said first storage section; and
c) wherein said at least one extendable cover portion is extendably positionable relative to said at least one cover.

33) The truck tailgate barrier system according to claim 30 further comprising:
a) at least one jumper cable structured and arranged to assist the jump-starting of a vehicle;
b) wherein said at least one jumper cable comprises such at least one first proprietary coupler structured and arranged to connect said at least one jumper cable to said at least one proprietary adapter.

34) The truck tailgate barrier system according to claim 13 further comprising:
a) at least one ladder rack structured and arranged to provide elevated support of the cargo;
b) wherein said at least one ladder rack comprises
i) at least one first stanchion structured and arranged to engage said at least one bar aperture, and
ii) at least one second stanchion structured and arranged to be mountable to the truck bed;
c) wherein at least one portion of said at least one ladder rack is substantially foldable adjacent at least one other portion of said at least one ladder rack for compact storage.

35) The truck tailgate barrier system according to claim 6 wherein said at least one second storage section comprises at least two divided compartments each enclosed by at least one hinged cover.

36) A system related to providing electrical power within a tailgate of a truck bed comprising at least one electrical circuit, said system comprising:
a) at least one electrical coupler structured and arranged to supply electrical power from the at least one electrical circuit of the at least one truck bed;
b) at least one jumper cable structured and arranged to transfer the electrical power from said at least one electrical coupler to assist jump-starting operations;
c) wherein said at least one electrical coupler is located substantially within the tailgate
d) wherein said at least one jumper cable comprises at least one proprietary connector structured and arranged to connect said at least one jumper cable to said at least one electrical coupler.

37) A system related to providing electrical connections within a tailgate of a truck bed, said system comprising:
a) at least one audio coupler coupled to at least one audio circuit of the at least one truck bed;
b) at least one video coupler coupled to at least one video circuit of the at least one truck bed;
c) at least one data coupler coupled to at least one data circuit of the at least one truck bed; and
d) at least one electrical coupler coupled to at least one electrical circuit of the at least one truck bed;
e) wherein each one of said at least one audio coupler, said at least one video coupler, at least one data coupler, and said at least one electrical coupler are located substantially within the tailgate.
